(19) United States
(12) Patent Application Publication
(10) Pub. No.: US 2015/0127340 A1
(43) Pub. Date: May 7, 2015

(54) CAPTURE

(71) Applicants: Alexander Epshteyn, New York, NY (US); Geoffrey Gelman, Brooklyn, NY (US); Jonathan Eva, Brooklyn, NY (US); Joshua Casner, Brooklyn, NY (US)

(72) Inventors: Alexander Epshteyn, New York, NY (US); Geoffrey Gelman, Brooklyn, NY (US); Jonathan Eva, Brooklyn, NY (US); Joshua Casner, Brooklyn, NY (US)

(21) Appl. No.: 14/074,688

(22) Filed: Nov. 7, 2013

(51) Int. Cl. G10L 15/26

(52) U.S. Cl. CPC G10L 15/26
USPC 704/235

(57) ABSTRACT

According to some embodiments, a capture device records presentations. According to some embodiments, the recorded presentations are made available for online review and comment by audience members. According to some embodiments, the recorded presentations parsed.

### CROSS-REFERENCE TO RELATED CORRESPONDING APPLICATIONS

This application is a continuation-in-part of commonly owned, co-pending U.S. patent application Ser. No. 12/615,465 entitled “Signage” filed Nov. 10, 2009, and this application claims the benefit of priority to the aforementioned application Ser. No. 12/615,465, and also this application claims the benefit of priority to U.S. provisional patent application Ser. No. 61/723,442, entitled “Capture” filed Nov. 7, 2012.

Each of the above-referenced applications is incorporated by reference herein in its entirety for all purposes.

### BACKGROUND

Lectures, speeches, presentations, and the like are known methods of information transfer. It may be useful in some cases to create a record of the aforementioned. It may be useful in some cases to facilitate discussion of the aforementioned.

### BRIEF DESCRIPTION OF THE DRAWINGS

FIG. 1 shows a system according to some embodiments.

FIG. 2 shows a server according to some embodiments.

FIG. 3 shows a media player according to some embodiments.

FIG. 4 shows a computer according to some embodiments.

FIG. 5 shows a display according to some embodiments.

FIG. 6 shows a content database according to some embodiments.

FIG. 7 shows a display database according to some embodiments.

FIG. 8 shows a media player database according to some embodiments.

FIG. 9 shows an entry in a scheduling database according to some embodiments.

FIG. 10 shows a reconciliation database according to some embodiments.

FIG. 11 shows a portion of a user interface for content management according to some embodiments.

FIG. 12 shows a playlist database according to some embodiments.

FIG. 13 shows a portion of a user interface for content management according to some embodiments.

FIG. 14 shows a layout database according to some embodiments.

FIG. 15 shows a display according to some embodiments.

FIG. 16 shows a reconciliation report according to some embodiments.

FIG. 17 shows a process for handling content according to some embodiments.

FIG. 18 shows sensor network according to some embodiments.

FIG. 19 shows rules database according to some embodiments.

FIG. 20 shows a display according to some embodiments.

FIG. 21 shows a system for capturing lectures according to some embodiments.

FIG. 22 shows a server according to some embodiments.

FIG. 23 shows a capture device according to some embodiments.

FIG. 24 shows a computer according to some embodiments.

FIG. 25 shows a captured lecture database according to some embodiments.

FIG. 26 shows a capture device database according to some embodiments.

FIG. 27 shows an AV equipment database according to some embodiments.

FIG. 28 shows a scheduling database according to some embodiments.

FIG. 29 shows a user account database according to some embodiments.

FIG. 30 shows a participation database according to some embodiments.

FIG. 31 shows a process for recording from the point of view of a server, according to some embodiments.

FIG. 32 shows a process for recording from the point of view of a capture device, according to some embodiments.

FIG. 33 shows a process by which students can collaborate according to some embodiments.

FIG. 34 shows an interface via which students can view lectures, according to some embodiments.

FIG. 35 shows an exemplary depiction of student participation, according to some embodiments.

### DETAILED DESCRIPTION

The following sections I-IX provide a guide to interpreting the present application.

### I. TERMS

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

### II. DETERMINING

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. INDICATION

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. FORMS OF SENTENCES

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. DISCLOSED EXAMPLES AND TERMINOLOGY ARE NOT LIMITING

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .sctn. 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g., weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. COMPUTING

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VII. CONTINUING APPLICATIONS

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

### VIII. 35 U.S.C. .SCTN. 112, PARAGRAPH 6

In a claim, a limitation of the claim which includes the phrase “means for” or the phrase “step for” means that 35 U.S.C. .sctn. 112, paragraph 6, applies to that limitation.

In a claim, a limitation of the claim which does not include the phrase “means for” or the phrase “step for” means that 35 U.S.C. .sctn. 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. .sctn. 112, paragraph 6, applies to that step(s).

With respect to a means or a step for performing a specified function in accordance with 35 U.S.C. .sctn. 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. .sctn. 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

### IX. PROSECUTION HISTORY

In interpreting the present application (which includes the claims), one of ordinary skill in the art shall refer to the prosecution history of the present application, but not to the prosecution history of any other patent or patent application, regardless of whether there are other patent applications that are considered related to the present application.

### X. EMBODIMENTS

### Terminology

A server may include a computer, device, and/or a software application for performing services for connected clients in a client-server architecture. In various embodiments, a server may be dedicated or designated for running specific applications. For example, a server may be dedicated to performing functions related to the Web (a Web server), functions related to electronic mail (e-mail server), or functions related to files (a file server). Exemplary servers include the IBM BladeCenter QS22 blade server, the Sun Fire x64 server, the SPARC Enterprise server, the HP ProLiant DL Server, the Dell PowerEdge 2650 2U Rack Mountable Server, Microsoft's Windows Server 2003, and Microsoft's Exchange Server.

As used herein, the terms “media player”, “digital media player”, and the like may include a device and/or software that converts a first set of data into a second set of data suitable for use by a display. A media player may receive various data streams, including video, audio, text, still images, animations, interactive content, and three-dimensional content. The data streams may be in various formats, including JPEG (Joint Photographic Experts Group), GIF (Graphics Interchange Format), AVI (Audio Video Interleave), RAM (Real Audio Meta-Files), MPEG (Motion Picture Experts Group), QuickTime, MP3 (MPEG Audio Layer III), WMA (Windows Media Audio), AIFF (Audio Interchange File Format), AU (Sun Audio), WAV (Waveform Sound Format), RA (Real Audio), and so on. The media player may convert any one or more of these data streams into one or more signals for use by a display. For example, the media player may convert the data streams into a video and audio signal. A media player may incorporate data from multiple streams into a single video signal. For example, a media player may receive video data depicting a gazelle running on a savannah, as well as data about current stock prices. The media player may create a single video signal which incorporates both the video of the gazelle running and a scrolling ticker showing the stock prices.

A media player may perform decompression, decoding, decrypting or other functions on data. For example, a media player may include a codec for Quicktime, which may allow it to decompress received video that is in Quicktime format. A media player may alter the pixel layout of incoming data. For example, the media player may receive a video signal representing X by Y pixels, and convert the video signal into a video signal representing W by Z pixels.

A media player may change the frame rate of a signal. For example, a media player may convert a 30 frame-per-second signal into a 24 frame-per-second signal. A media player may change the sample rate of a signal. For example, a media player may receive an audio signal sampled at 96,000 Hertz, and convert it to an audio signal sampled at 32,000 Hertz.

A media player may include logic indicative of which content should be played on a corresponding display. The media player may further include logic indicative of when content should be played on the corresponding display. Thus, a media player may receive a number of data stream and only cause a subset of such data stream to be featured on a corresponding display.

A media player may further include logic indicative of the manner in which content should be played on a corresponding display. Such logic may indicate where on a screen that content should be placed (e.g., upper right-hand corner), the shape of the region where the content is to be placed, what types of visual effects to add to the content (e.g., borders; e.g., fade-ins and fade-outs), and any other information about the manner in which the content is to be played.

Exemplary media players include the Digital Signage Player NDSP-500 from ICP Advanced Digital Signage, the Cisco Digital Media Player 4305G, the NEOCAST Media Player appliance, View Sonic's NMP530, the 1-2-1VIEW Ninja N106, and Scala's InfoChannel Player.

A media player may include a computer running software. The computer may be a general purpose computer, such as a personal computer. The computer may have a specially designed shape or form factor. A special form factor may allow the computer to be situated into small, oddly shaped, and/or inaccessible locations, for example.

A media player may include a dedicated computer, such as a set-top box. The media player may include specially optimized hardware for performing the functions of a media player.

A media player may be integrated into a display, speaker, or other output device. For example, a display may include a motherboard, a processor, and memory, wherein the processor may execute a program to perform one or more functions of a media player.

A media player may be operable to recognize and process data in various formats such as Quicktime, Flash, and Windows Media.

A media player may include software, hardware, and/or a combination of hardware and software.

As used herein, the term “content manager” may include hardware and/or software for scheduling the delivery and playback of content at one or more output devices (e.g., at one or more displays). A content manager may monitor when and where content has been played, and may provide reports on when and where content has been played. A content manager may provide functionality for allowing different people to provide and schedule content. For example, in a large network of digital signs, a first person (e.g., a corporate manager) may have the authority to schedule content on all of the digital signs, while a second person (e.g., a local store manager) may have the authority to schedule content on a subset of signs within the network. An example of a content manager is Scala's InfoChannel Content Manager.

As used herein, the term “OpenGL”, or “Open Graphics Library” may include a standard specification that defines a cross-language and cross-platform applications programming interface for creating applications that generate two and three dimensional computer graphics.

In various embodiments, communication among devices on a network may be accomplished via various communications mediums, including via category 5 cable (CAT5 cable), fiber optic cable, and Ethernet. Communications may be accomplished using various other mediums, as will be appreciated, including wired and wireless mediums.

A networked-attached storage (NAS) device may include a self-contained computer connected to a network, and may serve the purpose of supplying file-based data storage services to other devices on the network. An operating system and other software on the NAS device may provide such functionality as data storage, file systems, and access to files, and the management of these functionalities. An NAS device may lack a keyboard or display, and may be controlled and configured over the network, such as through the connection of a browser program to its network address.

In some embodiments, other devices may assume or carry out the function of an NAS. In some embodiments, a computer may be used as a file server. A file server may include a computer with a keyboard, display, and operating system, in which the operating system may be optimized for providing storage services.

Exemplary NAS devices include the Netgear ReadyNAS Duo, the Netgear ReadyNAS NV+, the Iomega StorCenter Network Hard Drive, the Synology Disk Station D5207+, and the Maxtor Shared Storage II.

A storage area network (SAN) may include a network that connects data storage devices (e.g., disk arrays, tape libraries, optical jukeboxes) to one or more data servers. The architecture of the SAN may be such that, from the viewpoint of the operating systems of the server(s), the storage devices appear as locally attached. The SAN may be dedicated to only input-output traffic between servers and storage devices. An SAN may incorporate various communication technologies, including for example, optical fiber, Enterprise Systems Connection (ESCON), or Fibre Channel.

A blade server may include a hardware server that is specially designed to be densely packed with other blade servers. Multiple blade servers may be arranged together within a chassis, and may share components such as power supplies and cooling systems. In this way, a large number of servers may be packed into a small volume.

A Universal Serial Bus (USB) drive may include a memory storage device integrated with a universal serial bus (USB) connector. The memory used by the USB drive may be flash memory.

Radio-frequency identification (RFID) may include a method of identifying objects via data emitted by and/or received from special tags or transponders. Such tags may be called RFID tags. RFID tags may be small devices capable of emitting or retransmitting electro-magnetic radiation where such radiation encodes data. RFID tags may be incorporated into products, animals, or people and imbued with unique or distinctive data that allows the identification of such products, animals or people.

Near field communication (NFC) may include technologies that allow two or more devices to communicate wirelessly with one another. Such communication may occur at short distances, such as over distances of a several centimeters. Such communication may occur between a mobile device (e.g., a smart phone), and a fixed device (e.g., a point of sale terminal). NFC technologies may include technologies invented by NXP Semiconductors and Sony. NFC chips or NFC tags may include circuitry, semiconductors, or other objects capable of sending and/or receiving NFC communications.

Display technologies may include cathode-ray tubes (CRT), liquid crystal displays (LCDs), thin film transistor (TFT) LCDs, plasma screen displays, light-emitting diode (LED) displays, organic light-emitting diode (OLED) displays, projection displays, digital light processing (DLP) projectors, holographic displays, displays made from spinning arrays of LEDs (e.g., displays by DynaScan 360), electronic paper or electronic ink (E-ink) displays, laser projection systems, and so on.

A graphics processing unit (GPU) may include a device that is specially dedicated to rendering graphics for a personal computer, game console, workstation, or for another other device. Exemplary GPUs include the NVIDIA GeForce 8800 Ultra, the NVIDIA GeForce 8800 GTX, the ATI Radeon HD 3870×2, and the ATI Radeon HD 3870.

As used herein, the terms “central processing unit”, “CPU”, and “processor” may include a device that executes computer programs. The CPU may include a semiconductor device incorporating transistors and logic elements, for example. Exemplary processors may include the Intel Core 2 Extreme Processor, Intel Pentium Processor, Intel Celeron Processor, Intel Xeon Processor, AMD Phenom Processor, AMD Athlon Processor, AMD Turion Processor, and AMD Opteron. A processor may include a processor with a reduced instruction set computer (RISC) architecture. A processor may include a processor with an Advanced RISC Machine (ARM) architecture.

As used herein the terms “RSS”, “Really Simple Syndication”, “Rich Site Summary”, “RDF Site Summary”, and the like may include one or more Web feed formats used to publish frequently updated works, e.g., blog entries, news headlines, stock quotes, audio, and video. An RSS document may include full or summarized text and meta-data such as the authors and dates of publishing.

### Digital Signage System

According to various embodiments, a digital signage system may allow for visual, audio, or other content to be broadcast through one or more displays or other output devices. The displays or other output devices may be digital signs, digital billboards, projection displays, speakers, printers, product vending machines, hand dryers, kiosks, or any other output device. A digital signage system may include one or more output devices connected to a network. In various embodiments, a digital signage system may be centrally controlled and managed. For example, a server may store content that is to be played on the displays and other output devices within a network. The server may periodically transmit or broadcast the content to the output devices within the network. The server may also store scheduling information as to when and where content is to be played. The server may further perform monitoring and reconciliation functions. The server may monitor when parts of the network are not functioning properly. The server may track what content has been played, when it has been played, how effective it has been, and any other metrics.

In various embodiments, a digital signage system may be managed via distributed locations, devices, and or human managers. For example, a digital signage system spread amongst a retail chain may allow a manager in corporate headquarters to determine content that will be played on all displays throughout the system. At the same time, a manager of a single retail store may determine content that will be played on the displays within his retail store.

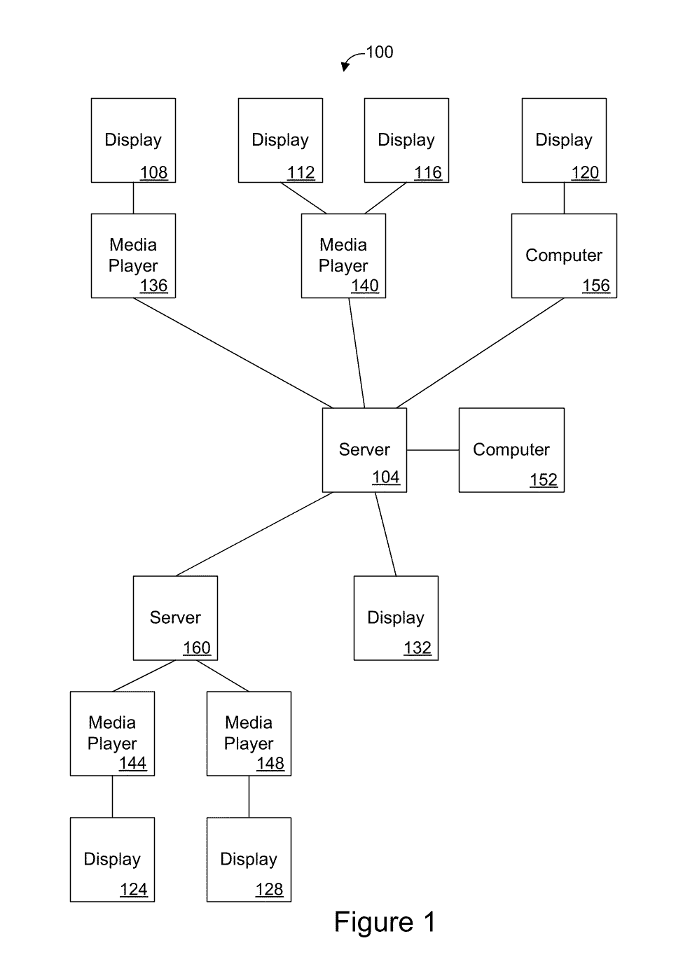

FIG. 1 shows a system 100 according to some embodiments. System 100 is illustrative of one or more possible system architectures, but it should be understood that various embodiments may include alternate architectures. Server 104 may be linked with various other devices and/or programs. In various embodiments, server 104 is linked to media players 136 and 140, to computers 152 and 156, to server 160, and to display 132. It will be appreciated that, in various embodiments, server 104 may be linked to any number of devices and/or programs, including various media players, computers, servers, displays, and/or other programs or devices.

As described herein, a link or links may occur via one or more communications channels, including Ethernet, coaxial cable, CAT5 cable, optical fibers, copper wires, wireless links, infrared links, satellite links, or via any other mode of communication. The link or links may occur through one or more networks, including the Internet, telecommunications networks, cable networks, satellite networks, local area networks (LANs), wide area networks (WANs), virtual private networks (VPNs), or via any other networks. Links may be continuous, periodic, intermittent or any other duration or frequency. In some embodiments, a link may include a “sneaker net”, whereby data is shuttled between devices via humans carrying data (e.g., by humans carrying flash memory drives or other computer media).

Media players, such as media players 136, 140, 144, and 148, may each be linked to one or more displays. For instance, in various embodiments, media player 136 is linked to display 108, media player 140 is linked to displays 112 and 116, media player 144 is linked to display 124, and media player 148 is linked to display 128. As will be appreciated, in various embodiments, a given media player may be linked to any number of displays.

System 100 illustrates “displays”. Various embodiments may include output devices that do not strictly output visual information. For example, output devices may include devices which output audio, vibrations, aromas, heat, water, air, paper, products, and/or any other type of output. For example, an output device may include a speaker that outputs music. An output device may include a spray nozzle that outputs cold spray on a hot day. An output device may include a fan that provides air currents on a hot day. An output device may include a printer that provides coupons. An output device may include a vending machine that outputs candies. In various embodiments, an output device may output a combination of stimuli, including visual and audio stimuli, for example. It will be appreciated that various embodiments may utilize architectures illustrated in system 100 with output devices that do not strictly provide visual information. For example, a media player may be linked to a speaker that outputs audio stimuli.

Computer 156 may include a computer that functions as a media player. The computer may also include additional functionality. The computer may allow for direct human interaction. For example, the computer may include a monitor, keyboard, and mouse for interacting with a person. A person may use the computer, for example, to load or manage content to be output on display 120. The computer may run media player software and may thereby function as a media player.

Computer 152 may include a general purpose computer, such as a personal computer, a workstation, or any other type of computer. Computer 152 may provide a human with a way to interact with server 104. For example, a human may provide instructions for the server via computer 152. A human may use computer 152 for a variety of functions, including loading content that will be stored on the server 104 and broadcast to one or more displays; scheduling content to be broadcast to one or more displays; scheduling content to be played on one or more displays; monitoring when content has been played on one or more displays; monitoring displays or other network components that are not functioning; and/or performing any other function. Although the illustrated system 100 includes one computer that may be used for interacting with server 104, various embodiments contemplate the use of zero, one, or more than one computer that may be used for interacting with server 104. For example, three different people may share the responsibility of managing a digital signage system. Each may access server 104 using a different computer.

Server 104 may perform various functions. In various embodiments, server 104 may store content such as video files, still images, financial data, weather data, text data, other data, audio files, and any other content. Server 104 may broadcast such content to one or more other devices and/or programs, including to media players, computers, displays, and to other servers (e.g., to server 160). Server 104 may further receive information from one or more other devices and/or programs. Server 104 may receive information such as what content was played, when content was played, and how many people viewed content that was played. Server 104 may further receive status information regarding the digital signage system. For example, server 104 may receive a signal indicating that a media player has lost a network connection (e.g., and the media player is therefore not able to communication with the server). As another example, server 104 may receive a signal indicating that a display is not showing any images.

In various embodiments, one or more media players and/or displays may be linked to a server other than to server 104. For example, media player 136 may be linked to a server other than server 104. The other server may be external to the digital signage network 100, in some embodiments. The other server may, in some embodiments, provide content for the one or more media players and/or displays. For example, media player 104 may be configured to receive an RSS feed directly from an external server. A media player and/or display may, in various embodiments, receive content, instructions, or any other data directly from a source external to the digital signage system. In some embodiments, while a media player and/or display may receive content from an external source, server 104 may provide the media player and/or display with instructions as to when to play such content.

Server 104 may be linked to server 160. In various embodiments, server 104 may be linked to zero, to one, or to more than one additional server. In various embodiments, server 104 may be linked to any number of other servers. Server 160 may perform one or more similar functions to those performed by server 104. For example, server 160 may store content. Server 160 may transmit or broadcast content to one or more media players, displays, and/or other devices. Server 160 may schedule the playing of content on one or more displays. Server 160 may also monitor the status of a network or portion of a network.

In various embodiments, server 160 may have dedicated or specialized functionality. Server 160 may store content. Server 160 may store large content files, such as video files. Server 160 may be located more proximate to media players 144 and 146 than is server 104, for example. Thus, if content files are stored at server 160, network lags inherent in the transmission of content to media players 144 and 148 may be reduced.

Display 132 may be linked directly to server 104. Display 132 may include an integrated media player. For example, display 132 may include a processor and may operate software with the functionality of a media player.

Though various embodiments illustrate or depict discrete components, it will be appreciated that components may be comprised of one or more separate devices. It will be appreciated that components may be comprised of one or more distributed components. For example, server 104 may comprise multiple discrete servers that are networked together and which function as a single server. It will be further appreciated that components illustrated as discrete may be combined. For example, media player 136 and display 108 may be combined into a single device. As another example, computer 152 and server 104 may be a combined into single device.

### Server

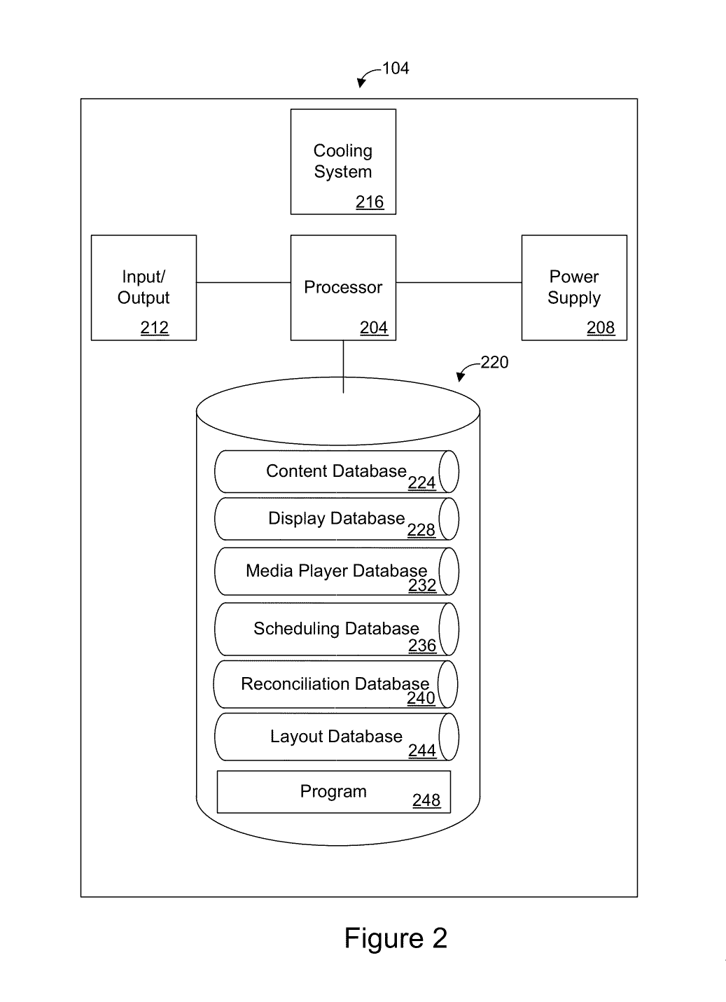

FIG. 2 shows server 104 according to some embodiments. Server 104 may include a processor 204. The processor may execute programs or other sets of instructions so as to operate in accordance with one or more embodiments. Server 104 may, in various embodiments, include multiple processors.

Server 104 may include input and output communication abilities 212. Such capabilities may include ports, communication ports, data ports, antenna(e), wireless transmitters, laser transmitters, infrared transmitters, cables, and any other mechanisms for transmitting or receiving data. Server 104 may include one or more monitors, keyboards, computer mice, or other devices that allow for communication and interaction with a human.

Server 104 may include a power supply 208. The power supply may convert power received from an electrical grid into power suitable for use by other server components. For example, the power supply may convert power from alternating current to direct current and may change the voltage. In various embodiments, the power supply may comprise one or more batteries, one or more generators, one or more fuel cells, one or more engines, or any other suitable source of power.

Server 104 may include a cooling system 216. The cooling system may use air currents, liquid, heat syncs, and/or any other mechanism for cooling one more components of server 104.

Server 104 may include memory 220. Memory 220 may store various data. In various embodiments, the data may be stored within databases, such as databases 224, 228, 232, 236, 240, and 244. However, it should be understood that data may be stored in other manners, formats, arrangements, etc. Memory 220 may store one or more programs, such as program 248. The programs may include instructions for directing processor 204 (or any other processor) in accordance with various embodiments. Memory 220 may store any instructions for directing the processor or any other component of server 104.

Content database 224 may include various data, such as data to be utilized by one or more media players (e.g., by media player 136), and/or to be used by one or more displays (e.g., by displays 108 and 132). Data stored in the content database may include video data, image data, audio data, speech data, text data, data representing symbols, data representing animations, and/or any other type of data. Data stored in the content database 224 may, in various embodiments, be transmitted (e.g., transmitted via input/output mechanisms 212) to one or more media players, displays, servers, or to any other devices. Content database 224 may store “meta-data” pertaining to any content stored. For example, content database 224 may store text labels of images, data indicating the length of a video, data indicating the number of pixels in an image, data indicating the bit rate of an audio file, and any other data related to content. In some embodiments, content database 224 may store a pointer or other reference to content data that is not stored in the content database. For example, the content database may store an internet protocol (IP) address of a remote server where actual content data may be found.

Display database 228 may include data related to one or more displays in digital signage system 100, or in any other system. For example, the display database may include information about the location or hardware specifications of one or more displays.

Media player database 232 may include data related to one or more media players in digital signage system 100, or in any other system. For example, the media player database may include information about which displays are linked to a given media player.

Scheduling database 236 may include data related to the presentation of content within digital signage system 100, or within any other system. Scheduling database may include, for example, information about what content will be played on a given display, and when such content will be played.

Reconciliation database 240 may include data related to when and where content has been played. Reconciliation database 240 may, for example, aid in billing advertisers for the successful presentation of content over digital signage system 100.

Layout database 244 may include data related to different screen layouts. For example, a user of digital signage system 100 may wish to create and/or select from among different layouts. A layout may represent the way a screen is divided into different regions, such that each region can play a separate, independent item of content. In some embodiments, a layout may also include characteristics that are applied to different regions, such as transparency levels or border thicknesses.

It should be understood that the databases depicted in FIG. 2 represent some embodiments. More or fewer databases may also be used, in various embodiments. Further, the depicted databases may store data in various ways, in various arrangements, and in various relationships, according to various embodiments. Further, the depicted databases may store more or less data, according to some embodiments.

It will be appreciated that although FIG. 2 depicts an exemplary architecture for server 104 according to some embodiments, the architecture may also describe one or more other servers in digital signage system 100. Further, server 104 may itself comprise other architectures, in various embodiments.

### Media Player

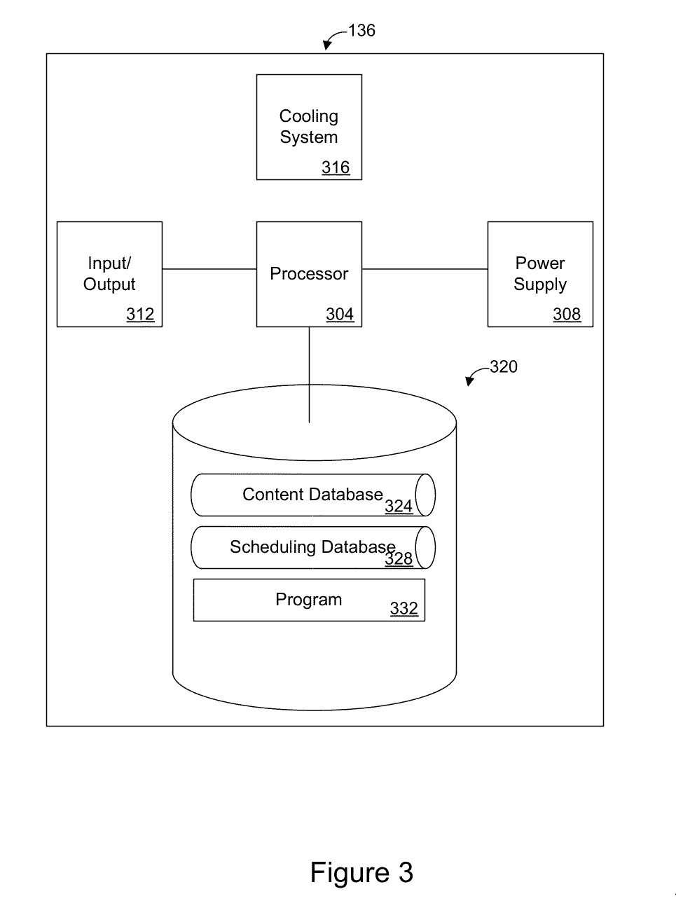

FIG. 3 depicts a media player 136, according to some embodiments. The media player may include a processor 304 for executing programs and carrying out instructions to operate in accordance with various embodiments. The media player may include more than one processor, in various embodiments. For example, the media player may include a GPU as well as a CPU. The media player may include an input and/or output mechanisms 312. The input and/or output mechanisms may include ports for cables, Ethernet, fiber optics, or other modes of transmission and communication. The input and/or output mechanisms may include means for wireless communications, including antenna, infrared transmitters and/or receivers, lasers, and/or any other mechanisms for wireless communications. The input and/or output mechanisms may include a monitor or display screen and/or a microphone, both of which may be used to present information to humans. The media player may include an attached mouse, keyboard, joystick, or other mechanism for human interaction.

The media player 136 may include a power supply 308, such as a battery or power adapter. The media player may include a cooling system 316. The cooling system may help to dissipate heat from the processor, from other electronics, from sunlight, from a nearby display, or from any other source. The media player may include a memory 320, such as a semiconductor memory, hard disk, flash memory, holographic memory, or any other type of memory. Stored in memory may be various information, including, in some embodiments, a content database 324, a scheduling database 328, and a program 332. Content database 324 may, in some embodiments, bear similarities to content database 224 stored in server 104. Scheduling database 328 may, in some embodiments, bear similarities to scheduling database 236 stored in server 104. In some embodiments, only one of server 104 or a media player stores a content database. In some embodiments, only one of server 104 or a media player stores a scheduling database. It will appreciated that various data may be stored in various places, including in redundant places. For example, both the server 104 and a media player may store a schedule for when content is to be played on a display associated with the media player.

Media player 136 may include one or more programs, e.g., program 332. The program may include instructions for operating the media player in accordance with various embodiments.

It will be appreciated that although FIG. 3 depicts an exemplary architecture for media player 136 according to some embodiments, the architecture may also describe one or more other media players in digital signage system 100.

### Personal Computer

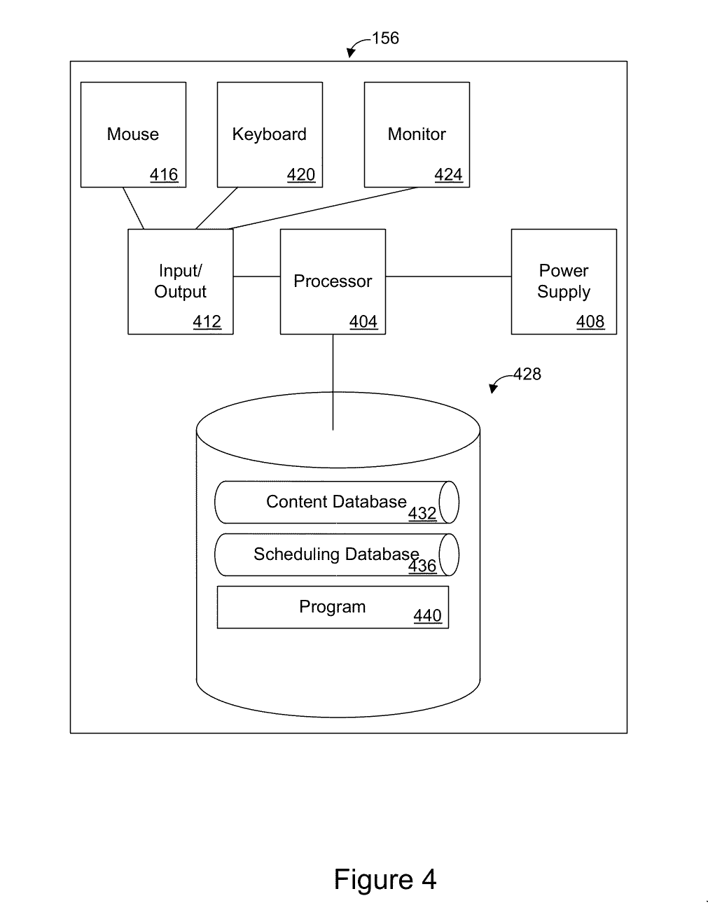

FIG. 4 depicts personal computer 156, according to some embodiments. The personal computer may include a processor 404. The processor may be operable to execute programs or to carry out other instructions in accordance with various embodiments. The personal computer may include more than one processor, in various embodiments. In various embodiments, personal computer may include a power supply 408, such as a battery or a power adapter. In various embodiments, the personal computer may include mechanisms for inputs and outputs 412. For example, the personal computer may include ports for cables, Ethernet, fiber optics, and other communication and transmission means. The personal computer may include mechanisms for wireless input and outputs. The personal computer may feature Bluetooth, Wi-Fi, or other wireless protocols. The personal computer may include one or more antennae for wireless reception and transmission. In various embodiments, the personal computer may include transmitters and/or receivers for infrared signals and/or for lasers. In various embodiments, the personal computer may include a mouse 416, keyboard 420, and monitor 424. These may allow for interaction with a human. The computer may include one or more other features or peripherals for interaction with humans as well. In some embodiments, the personal computer may include a microphone, camera, or other input or output mechanism.

The personal computer may include a memory 428, such as a semiconductor memory, hard disk, flash memory, holographic memory, or any other type of memory. Stored in memory may be various information, including, in some embodiments, a content database 432, a scheduling database 436, and a program 440. Content database 432 may, in some embodiments, bear similarities to content database 224 stored in server 104. Scheduling database 436 may, in some embodiments, bear similarities to scheduling database 236 stored in server 104. In some embodiments, only one of server 104 or a personal computer stores a content database. In some embodiments, only one of server 104 or a personal computer stores a scheduling database. It will appreciated that various data may be stored in various places, including in redundant places. For example, both the server 104 and a personal computer may store a schedule for when content is to be played on a display associated with the personal computer.

Personal computer 156 may include one or more programs, e.g., program 440. The program may include instructions for operating the personal computer in accordance with various embodiments.

In various embodiments, personal computer 156 may execute media player software. For example, personal computer 156 may receive signals from the server 104, where such signals encode content. The computer may decode the signals and transmit the decoded signals to the display for presentation. The computer may also combine different content signals into a single composite (e.g., into a single composite image), and transmit the composite to the display. For example, the computer may transmit a signal to the display for presentation, where the presentation shows two separate video clips simultaneously.

It will be appreciated that although FIG. 4 depicts an exemplary architecture for personal computer 156 according to some embodiments, the architecture may also describe one or more other personal computers in digital signage system 100.

### Display

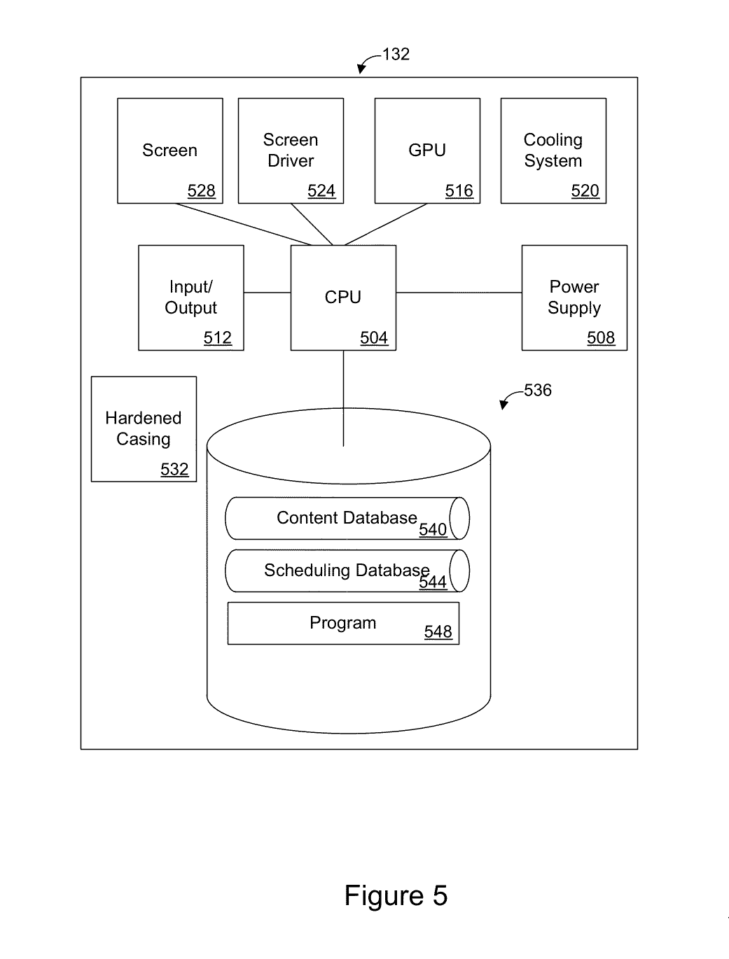

FIG. 5 depicts display 132, according to some embodiments. The display may include a central processing unit (CPU) 504. The CPU may be a processor. The CPU may be a general purpose computer processor. The CPU may be operable to execute programs or to carry out other instructions in accordance with various embodiments. The display may include more than one processor, in various embodiments. In various embodiments, the display may include a power supply 508, such as a battery or a power adapter.

In various embodiments, the display may include mechanisms for inputs and outputs 512. For example, the display may include ports for cables, Ethernet, fiber optics, and other communication and transmission means. The display may include mechanisms for wireless input and outputs. The display may feature Bluetooth, Wi-Fi, or other wireless protocols. The display may include one or more antennae for wireless reception and transmission. In various embodiments, the display may include transmitters and/or receivers for infrared signals and/or for lasers.

In various embodiments, the display 132 may include mechanisms for receiving human inputs. In some embodiments, the display may include touch sensors and/or a touch screen for receiving tactile input. In various embodiments, the display 132 may include a camera for detecting images (e.g., images of humans). In various embodiments, the display may include a microphone or other acoustic sensor.

In various embodiments, the display 132 may include output devices, such as output devices capable of communicating with humans. Output device may include speakers, acoustic transmitters, directional sound transmitters, chemical or odor releasers, nozzles for water or air, or any other output devices.

In various embodiments, the display 132 may include a GPU. The GPU may assume some of the processing work by performing common and frequently used calculations, such as calculations related to graphics.

In various embodiments, the display 132 may include a cooling system 520. The cooling system may include one or more fans, one or more heat syncs, one or more pipes for circulating liquid and/or gas, and/or one or more other components. The cooling system 520 may allow the display 132 to expend large quantities of energy, to operate under warm ambient conditions, to operate in tight spaces, or to otherwise operate without overheating.

In various embodiments, the display 132 may include a screen driver 524. The screen driver may provide a go-between or middleware, that allows e.g., the CPU to issue commands to the screen of the display.

In various embodiments, the display 132 may include a screen. The screen may include glass, filters, liquid crystals, a light source, transistors, phosphorous, light emitting diodes, organic light emitting diodes, and/or other components. The screen may transmit and/or reflect light. The screen may display particular images or patterns, and may do so in response to commands from the CPU, GPU, screen driver, or other source.

In various embodiments, the display 132 may include a hardened casing 532. The hardened casing may include mechanically resistant glass, plastic, metal, or other materials that are used to cover and/or protect the other parts of display 132. In some embodiments, the display may include decorative coverings or casings, such as a gold bezel.

In various embodiments, the display may include a memory 536, such as a semiconductor memory, hard disk, flash memory, holographic memory, or any other type of memory. Stored in memory may be various information, including, in some embodiments, a content database 540, a scheduling database 544, and a program 548. Content database 540 may, in some embodiments, bear similarities to content database 224 stored in server 104. Scheduling database 544 may, in some embodiments, bear similarities to scheduling database 236 stored in server 104. In some embodiments, only one of server 104 or a display stores a content database. It will appreciated that various data may be stored in various places, including in redundant places. For example, both the server 104 and a display (e.g., display 132) may store a schedule for when content is to be played on the display.

Display 132 may include one or more programs, e.g., program 548. The program may include instructions for operating the display in accordance with various embodiments.

In various embodiments, display 132 may execute media player software. For example, display 132 may receive signals from the server 104, where such signals encode content.

It will be appreciated that although FIG. 5 depicts an exemplary architecture for a display 132 according to some embodiments, the architecture may also describe one or more other displays in digital signage system 100.

### Databases

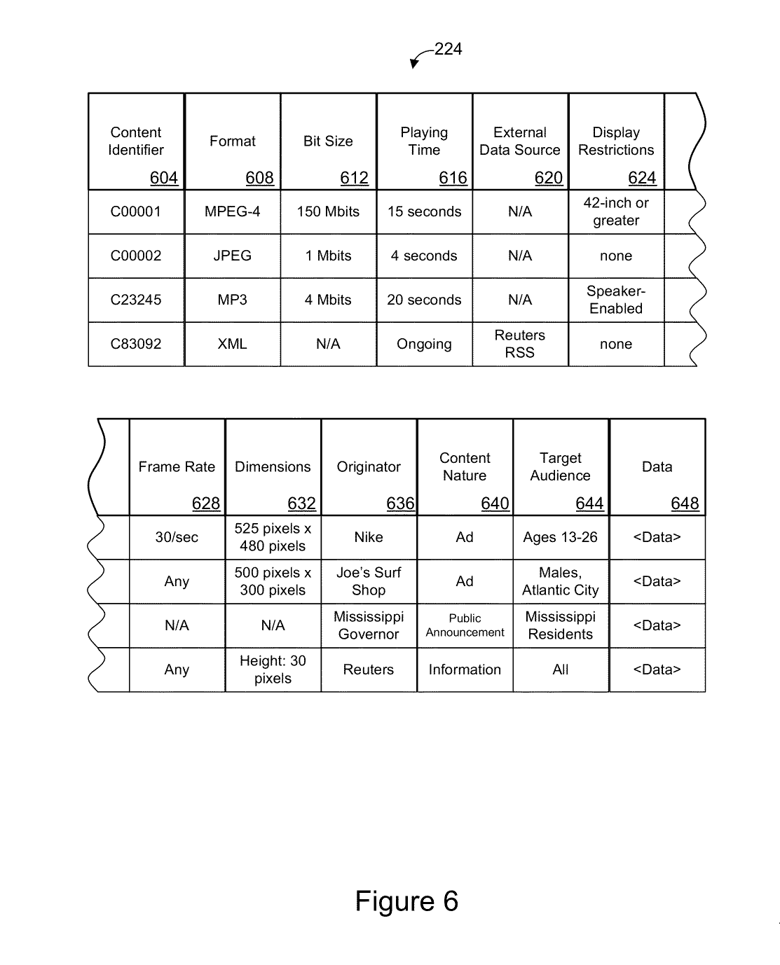

FIG. 6 depicts a representation of content database 224 according to some embodiments. Each row in content database 224 may represent a single item of content, such as a single image or a single 15-second video spot. Field 604 may include identifiers (e.g., C00001, C23245) which may be used to specify or reference particular items of content. Field 608 may include indications of the format of content (e.g., MPEG-4; e.g., JPEG). Field 212 may include indications of the size items of content. The size may be indicated in bits, bytes or in any other suitable unit of measurement. In various embodiments, content may have no definite size. For example, a particular item of content may be an RSS feed that is periodically or continuously updated and which therefore has no definite end. For content without a definite end, size may be measured per unit time (e.g., bits per second), in some embodiments.

Field 616 may include indications of the playing time of content (e.g., 4 seconds). In some embodiments, content may represent a live or continuous feed, or may otherwise have an indefinite length. For such content, an indication of “ongoing” may be used, in some embodiments. The playing time indicated for a particular item of content may represent a permissible or preferred playing time, in some embodiments. For example, a particular item of content may be a single still image. The indicated playing time may represent the amount of time the image is to be shown on a display according to the preferences of the content provider (e.g., according to the preferences of an advertiser). However, in various embodiments, the playing time of content may be changed. For example, a still image may have a preferred playing time of three seconds. However, this playing time may be reduced to two seconds or increased to five seconds. A playing time may be altered, for example, if an operator of digital signage system 100 wishes to fill extra time or to open up extra slots for additional content. In various embodiments, content database 224 may include a field indicating a minimum permissible playing time and/or a field indicating a maximum permissible playing time.

In some embodiments, an item of content may be played in two or more different versions. For example, for a movie trailer, there may be a 30-second version and a 15-second version. The 15-second version may be the first half of the 30-second version. In some embodiments, content database 224 may include one or more fields indicating a point at which an item of content may be truncated or abbreviated in order to yield a shorter version of that content. In some embodiments, two or more possible versions of a content item may be stored as separate content items, e.g., as separate rows in content database 224.

Field 620 may indicate an external data source from which content is to be received, obtained, or otherwise derived. For example, in some embodiments, server 104 does not store all content that is to be played on displays in system 100. Rather, in some embodiments, server 104 may stream content from another source and relay that content on to one or more displays in system 100. In some embodiments, server 104 may never receive certain content. Rather, such content may be transmitted directly from an external source to one or more media players and/or displays in digital signage system 100. In some embodiments, content may be stored within digital signage system 100, but not within server 104. For example, content may be stored in a dedicated content server, in network attached storage (NAS), in a server area network (SAN), or on any other device or in any other location within digital signage system 100.

Field 624 may indicate one or more restrictions that should or must be met by a display in order for content to be played on that display. Such restrictions may represent technical restrictions (e.g., an item of content may be unplayable on certain displays), restrictions of the content provider (e.g., an advertiser may prefer that his ad play only on displays of a certain size), or any other restrictions. In various embodiments, restrictions may also be stored for a media player. For example, certain content may be undecipherable by a certain media player. Restrictions may also be stored for a network connection (e.g., a network connection may be too intermittent for particular content to be streamed live to a particular media player). In various embodiments, any restrictions which may prevent, hinder, or impede the playing of content may be stored. In various embodiments, any restrictions which indicate situations where the playing of content would be unwanted or undesirable may be stored.

Field 628 may indicate a frame rate. The frame rate may represent a preferred or required frame rate at which content should or must be played. For example, certain content may appear smooth at a first frame rate, but may appear jerky at a second frame rate. Thus, it may be preferable to play the content at the first frame rate. In some embodiments, there may be a preferred bit rate or sample rate at which to play audio content. Such a preferred rate may be stored in a database such as content database 224.

Field 632 may indicate dimensions for an item of content. In various embodiments, a given item of content need not be displayed on the entire area of a display. For example, an item of content may be displayed in a quadrant of a display screen, thereby allowing for three other similarly sized items of content to also be displayed at the same time. A given item of content may occupy a square or rectangular portion of a display screen, in some embodiments. In some embodiments, a given item of content may occupy a band stretching the length or the width of a display screen. For example, an item of content may be displayed as a ticker stretching across the width of a displays screen. In some embodiments, an item of content may occupy a region of a display screen that is round, hexagonal, or that has any other regular or irregular shape. In some embodiments, the area of a display that an item of content occupies may vary over time. For example, the content may start as a small point and grow to occupy half of the screen.

The dimensions of an item of content may be indicated in various ways, according to various embodiments. Content dimensions may be indicated in terms of pixels, inches, centimeters, other units of measurement, dots, scan lines, or in terms of any other units. In various embodiments, stored content dimensions may represent required dimensions. For example, content must be presented where it occupies a portion of a screen five inches wide and three inches tall. In some embodiments, stored content dimensions may represent preferred dimensions. In some embodiments, stored content dimensions may represent maximum or minimum constraints on dimensions. For example, a field in content database 224 may indicate minimum dimensions at which content must be displayed. However, it may be permissible to display content at larger dimensions.

In some embodiments, the dimensions of content may be indicated in terms of a proportion. The proportion may indicate, for example, the ratio of the length of the content to the width of the content. It may then be permissible to display the content at any absolute size so long as the ratio of its length to width falls in line with the desired proportions.

Field 636 may indicate the originator of content. The originator may be a company, government entity, place of worship, club, non-governmental organization, charity, person, or any other entity. The originator may or may not be the owner of digital signage system 100. The originator may or may not be the operator of digital signage system 100. The originator of the content may be an advertiser wishing to promote certain products or services using digital signage system 100. The originator may be a government organization wishing to make a public announcement using digital signage system 100. The originator may have a variety of purposes for having the corresponding content displayed on, stored on, and/or available to digital signage system 100. The originator may have paid money to have the content played and/or available for play on the digital signage system 100.

Field 640 may include an indication of the nature of a given item of content. For example, field 640 may indicate that the content is an advertisement, a public announcement, an informational piece, an item of general entertainment (e.g., a situation comedy), or any other type of content.

Field 644 may include an indication of the target audience for a given item of content. The target audience may have been specified by the originator of the content, for example. The target audience may represent preferred or desirable viewers for the content. An indication of a target audience may include an indication of a: (a) gender; (b) age; (c) occupation; (d) marital status; (e) income level; (f) geographic location; (g) number of children that an audience member would have; (h) religion; (i) race; (j) nation of origin; (k) language spoken; (l) height; (m) weight; (n) medical status; (o) hobby (e.g., a target audience member would enjoy mountain biking); (p) criminal status; (q) home ownership status; (r) car ownership status; (s) citizenship; (t) citizenship status (e.g., naturalized; e.g., permanent resident; e.g., non-citizen); (u) educational status; (v) political affiliation; (w) product ownership status (e.g., a target audience member would own a cell phone); and/or any other demographic or other characteristic.

Field 648 may include actual data that makes up the content. For example, field 648 may include data in compressed or uncompressed format that can be used to create (or recreate) an image, video, audio, or other presentation. In some embodiments, field 648 may include a pointer to a computer memory address (e.g., to a computer memory address of the server; e.g., to a computer memory address in a separate device). In some embodiments, field 648 may include a pointer to an external device or location. For example, content need not be stored directly on or at server 104. Rather content may be stored on an external server, computer, hard drive, or other memory device. Field 648 may provide an indication of where and/or how to retrieve such content.

Though not indicated explicitly, it should be understood that in various embodiments, content database 224 may include various other types of data or information. In some embodiments, content database 224 may include information related to layering or transparency. In some embodiments, it may be possible or permissible to display one item of content on top of another. The topmost content may be semi-transparent, so that both items of content are visible. Thus, in various embodiments, content database 224 may indicate that a certain item of content may be displayed while layered above or beneath another item of content.

In various embodiments, content database 224 may indicate a position on a display screen where content is to be displayed. For example, the content may indicate that a ticker is to be displayed at the bottom of a display.

In some embodiments, content database 224 may indicate other preferred, desirable, or required display characteristics for content that is shown on a particular display. For example, content database 224 may indicate that a particular item of content is only to be displayed on a display from a certain manufacturer. In some embodiments, content database 224 may indicate that content is to be displayed only on displays that are at a certain height (e.g., eye level). In various embodiments, content database 224 may specify any other restrictions as to which displays are to be used for displaying content.

Content database 224 may be used in various embodiments. Content database 224 may provide information useful for scheduling when and where content should be played. For example, the target audience field 644 may be used to schedule a particular item of content only on displays which serve the relevant target audience. As another example, dimensions field 632 may show that a given item of content can be played at the same time on the same display as another item of content because they will both fit on the screen at the same time. The playing time field 616 may be used to schedule several items of content to play consecutively on a given display so as to completely fill a 10-minute content loop. The originator field 636 may allow the digital signage system to fulfill quotas, for example. For instance, the digital signage system may be contractually obligated to play content from a particular originator at least one thousand times during a given month. The originator field 636 may also allow digital signage system 100 to avoid playing consecutive content items from competing originators. For example, the digital signage system may avoid playing, on the same display, consecutive or concurrent ads from both Coke and Pepsi.

The content nature field 640 may allow for an appealing mix of content to be scheduled. For example, it may be determined (e.g., through survey or observation) that viewers pay more attention to signs that alternate informational and advertising content than to signs that play only advertising content.

The frame rate field 628 may ensure that content is played at the proper rate. The frame rate field 628 may further ensure that content is played only on displays that are capable of the required rate. The display restrictions field 624 may ensure that content is only scheduled to be played on displays that meet the indicated restrictions.

The external data source field 620 may provide a reference location, address, or other source from which to obtain content that may not be directly available from server 104.

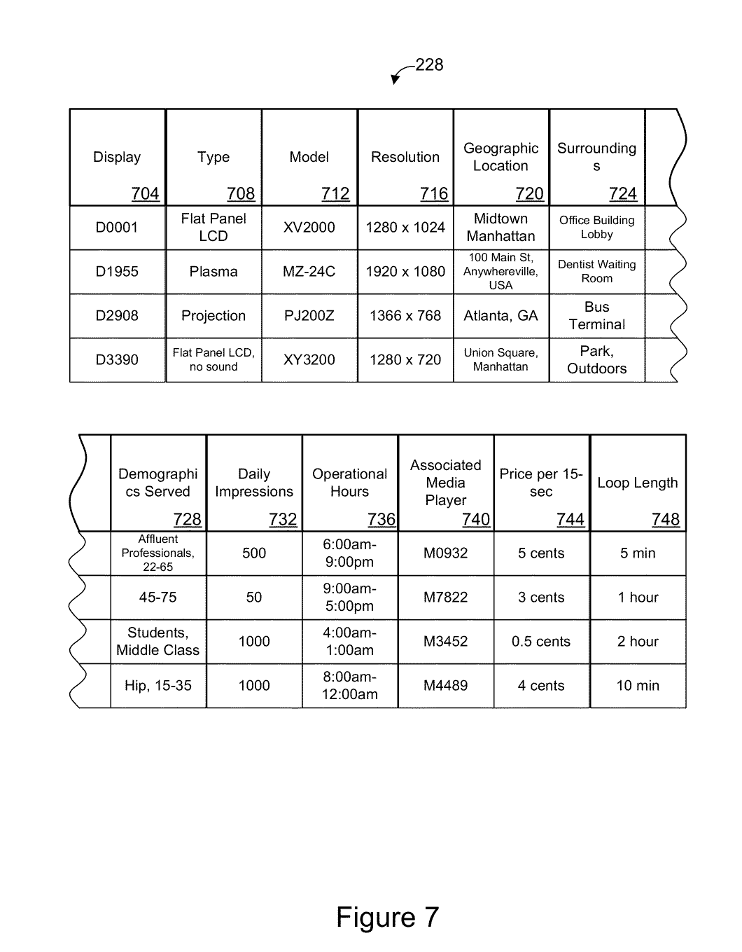

FIG. 7 depicts a representation of display database 228 according to some embodiments. Display database 228 may include various information about one or more displays in digital signage system 100. In various embodiments, the information stored in database 228 may aid in the scheduling of content to be played on one or more displays in digital signage system 100.

Field 704 may include an identifier (e.g., D0001; e.g., D2908) that may serve to identify and/or refer to a particular display. Field 704 may include information about the type of display (e.g., flat panel; e.g., projection). Field 712 may include information about the model of the display. Field 716 may include information about the resolution of the display. For example, field 716 may include information about a number of scan lines, a number of pixels, pixel dimensions, or about anything else pertinent to the resolution of a display.

Field 720 may include information about the geographic location of a display. Such information may include a country, city, state, county, town, village, neighborhood, a landmark reference (e.g., an airport; e.g., a park), a distance from a landmark, a block, a street address, a floor in a building, latitudinal and longitudinal coordinates, GPS (global positioning system) coordinates, an elevation, or any other indication of geographical location, or any other indication of location.

Field 724 may include information about the surroundings in which a display is situated. Such information may describe whether the display is indoors or outdoors, whether the display is in strong or weak ambient light, what type of business the display is in, how noisy the surroundings are, or any other information about the surroundings.

Field 728 may include information related to the type of audience served by a given display. Field 728 may include information about the age, race, income, nationality, marital status, and any other information, including any demographic information, or any other information. Field 728 may include information about some segment or portion of an audience that may view a display. For example, if most of the audience for a display falls within a certain age range (even though the entire audience does not), then that age range may be listed in field 728. In various embodiments, field 728 may store information about several audience segments for one display. For example, a display may serve an area where there are a number of teenagers and a number of professional adults as well. Information about both these groups may be stored in field 728. In some embodiments, where there are multiple audience segments served, the relative numbers or proportions of people in these different segments may be noted (e.g., 40% teenagers and 60% professional adults).

Field 732 may include information related to the number of times that a given display is viewed per day. It will be appreciated that, in various embodiments, the information may be couched in terms of some other unit of time, such as per hour or per week. In some embodiments, display database 228 may include an indication of how many people pay actual attention to a display per unit of time. People may be deemed to pay attention, for example, if they fix their gaze on the display for more than a predetermined period of time (e.g., for more than 1 second), if they can later recall something they saw on their display, if they turned their head because of the display, or if some other criterion (or criteria) is satisfied. The information stored in field 228 may be determined in various ways. In some embodiments, an observer may observe and count directly the number of people to view a display. In some embodiments, indirect measurements may be used. For example, the number of viewers for a display located in a bus terminal may be estimated based on the number of passengers known to be arriving and departing from the bus terminal each day (e.g., based on ticket sales).

Field 736 may include information related to the operational hours of a display. Field 736 may include a schedule of daily operational hours, a schedule of weekly operational hours, a monthly schedule of operational hours, or any other schedule. Operational hours may represent, for example, times when a display is on, times when there are any audience members to view a display, times when advertising slots are being sold on the display, or any other situation. For example, a display located in a retail store may be operational during the business hours of the retail store, but may be turned off otherwise.

Field 740 may include information about an associated media player. An associated media player may be a media player that provides the signals to be used on a given display. In some embodiments, a display may have more than one associated media player. For instance, the display may be operable to use signals from either media player. In some embodiments, a display may have no associated media player. For example, the display may include an integrated media player.

Field 744 may include pricing information related to the use of a particular display. Pricing information may represent the amount of money an advertiser would be charged for having its ad shown on the display for a given period of time (e.g., for 15 seconds). Pricing may also apply to other content providers. In some embodiments, there may be different pricing for different types of content providers. For example, advertisers may be charged a first rate, charitable organizations may be charged a second rate, and governmental entities may be charged a third rate.

In some embodiments, the price to show content may depend on various factors. The price may depend on the amount of screen space used. For example, content that takes up a quarter of the screen may be priced lower than content that takes up half of a screen. However, in various embodiments, pricing need not be directly proportional to the screen space occupied (e.g., there may be a bulk discount). The price of content may be based on a number of other factors, including time of day, weather, foot traffic (i.e., number of people passing the sign per unit time), season, demographic characteristics of passersby, and/or based on any other factors.

Field 748 may include information about a loop length. A loop length may represent a period of time, after which content played on a display will be repeated. For example with a loop length of five minutes, content played on a display may be repeated every five minutes.

Information stored in display database 228 may have various uses. For example, an advertiser may wish for its content to be displayed in particular geographic locations (e.g., if the advertisers is a local business), in particular surroundings (e.g., to provide a particular ambience for the advertisement), and to particular demographics (e.g., to the demographics that the advertiser believes will most likely purchase the advertiser's product). In various embodiments, an advertiser may wish for its ad to be viewed a certain minimum number of times per day. Ad advertisers may also have preferences for how frequently its ad is repeated. For example, an advertiser may prefer a display with a loop length of thirty minutes versus a display with a loop length of five minutes. In various embodiments, an advertiser may have a particular budget and may thereby be concerned with the price it will have to pay for displaying ads. Information stored in display database 228 may also be used to determine whether a display is capable or suitable of playing particular content (e.g., whether a display is capable of playing content that requires a certain resolution). Information stored in display database 228 may aid in the diagnosis and correction of problems. For example, with reference to the model number of a display, an appropriate technician may be consulted in the event of a malfunction with the display.

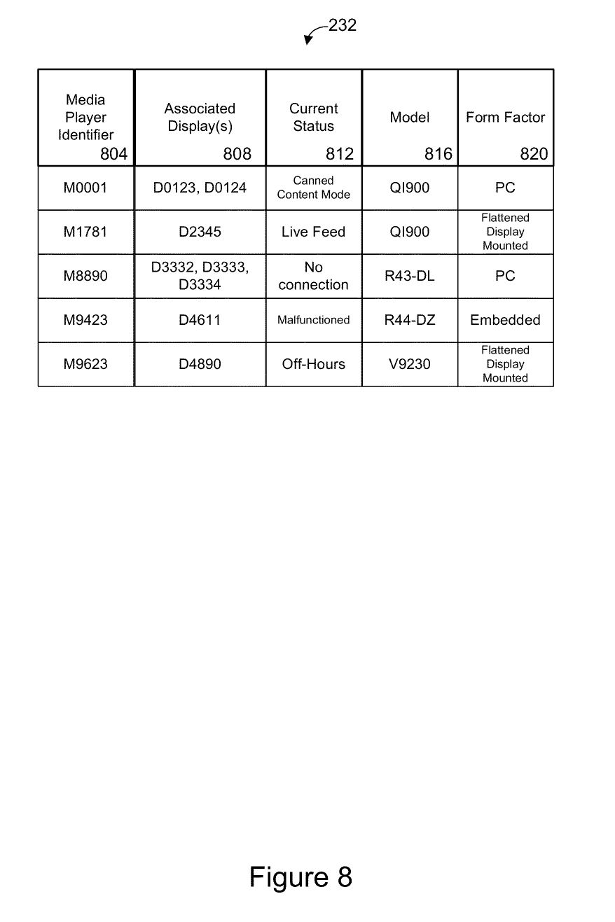

FIG. 8 depicts a representation of media player database 232 according to some embodiments. Media player database 232 may include various information about one or more media players in digital signage system 100. Field 804 may include identifiers for media players. An identifier may be used to identify and reference a particular media player.

Field 808 may include information about associated displays. A given media player may provide signals (e.g., video signals; e.g., audio signals) for one or more (e.g., for all) of the associated displays. Field 812 may include information about the current status of a media player. For example, a media player in “canned content mode” may cause an associated display to repeatedly play the same loop of content stored locally on or near the media player. The media player may lack a current connection to the Internet, for example, and may thereby be looping only locally stored material. A media player with a status of “Live Feed” may currently be playing and/or receiving data via a network. Thus, the media player may continually be playing new content, such as new news headlines or live television programming. Field 816 may include an indication of a model, which may be used, for example, to determine the capabilities of a given media player, or to track down the source of a potential malfunction. Field 820 may include an indication of a form factor. For example, a media player that is implemented as a separate hardware device may take various forms. In some embodiments, the media player may be a standard personal computer (PC). In some embodiments, the media player may be made with a special shape. The shape may be complementary to the shape of a display, so that the media player may fit flush against the display. For example, the media player may be flattened to fit against the back of the display, so that together both are still relatively thin. In some embodiments, a media player may be attachable or mountable directly on a display. For example, a display may include hooks or latches where a media player can attach.

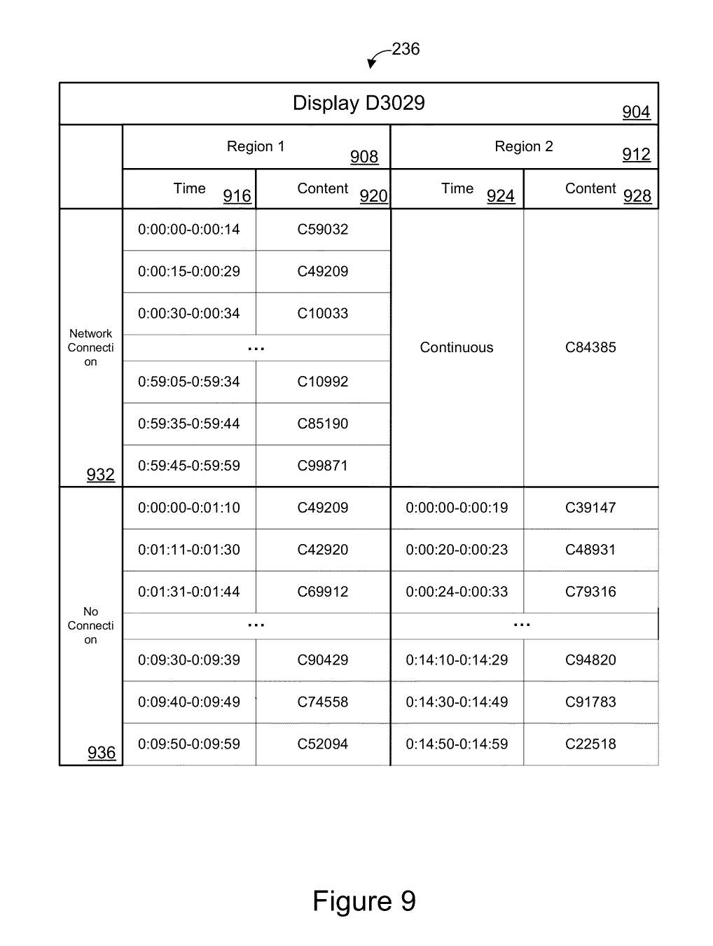

FIG. 9 depicts a representation of an entry in a scheduling database 236 according to some embodiments. In various embodiments, a scheduling database may include an entry for each of one or more display in digital signage system 100. The scheduling database may store an indication of what content is to be played on a given display. The scheduling database may store an indication of when a given item of content will be displayed on a given display. The scheduling database may store an indication of where a given item will be stored on a display (e.g., on what region of the display).

Field 904 may include an indication of a display (e.g., display D3029). Other scheduling information stored in the database entry 226 may apply to the display indicated in field 904. Fields 908 and 912 correspond to different regions on the display. For example, a display may include one, two, three, or more regions. Within each region separate items of content may be shown, so that if there are multiple regions, items of content may be shown simultaneously. Thus, for example, the left half of a display may show a live video broadcast, while the right half of the display may show still-image advertisements. Although FIG. 9 depicts a database entry in which there are two region fields, it will be appreciated that, in various embodiments, an entry may include more or fewer region fields.

In various embodiments, corresponding to a given region field, there may be a time field and a content field. In FIG. 9, time field 916 may correspond to region 1 field 908. Similarly, content field 920 may correspond to region 1 field 908. Entries stored under time field 916 and content field 920 may indicate a particular period of time (e.g., 0:00:00-0:00:14) and a particular item of content (e.g., C59032) that will play during that period of time. Thus, for example, content item C59032 may be scheduled to play in region 1 of display D3029 during the time period 0:00:00-0:00:14. The time period indicated may be relative to a reference time. For example, the time period 0:00:00-0:00:14 may indicate the first 15 seconds of operation for the day, or the first 15 seconds of a loop.

Database entry 236 may also include a Network Connection field 932, and a No Connection field 936. According to various embodiments, a display may play a first set of content when there is a network connection (e.g., a connection to server 104), and may play a second set of content when there is no connection. With a network connection, a display (or its corresponding media player) may periodically receive new content, or may receive a continuous stream of new content. Thus, the display may play new content when there is a network connection, in various embodiments. When the display does not have a network connection, the display may play content that is stored locally (e.g., in a computer memory associated with the display or its associated media player). The display may continue to play such content (e.g., continually repeat the content), until it connects to the network again. It will be appreciated that, in various embodiments, a display may receive new content even without a network connection. For example, a human being may connect a portable storage device containing new content to the display or to its associated media player.

As depicted in FIG. 9, for each region (e.g., region 1 908 and region 2 912), there is a first schedule for content if there is a network connection (e.g., there is a first schedule corresponding to Network Connection field 932), and there is a second schedule for content if there is no network connection (e.g., there is a second schedule corresponding to No Connection field 936).

In embodiments depicted in FIG. 9, various content is scheduled to play for an hour in region 1 of the display when there is a network connection. At the end of the hour, the loop may start over and content may be played from time 0:00:00 again (e.g., content item C59032 may be played again). In some embodiments, at the conclusion of the hour, new content may be downloaded to the display (or to its associated media player, or to a local memory, or to some other device). The new content may then be played. In some embodiments, one or more schedules stored in conjunction with a display may represent content that will be played going forward. As each item of content is played, the schedule may be updated. For example, the second item of content may become the first item, the third may become the second, etc., and a new item of content may be added at the end of the schedule.

In embodiments depicted in FIG. 9, one hour's worth of content is scheduled on region 1 if there is a network connection. However, if there is no network connection, then ten minutes of content is scheduled on region 1. In some embodiments, if a network connection goes down while content from the Network Connection schedule is being played, then the display may switch over to the content on the No Connection schedule.

In embodiments depicted in FIG. 9 region 2 may have scheduled continuously running content. For example, such content may include a live television broadcast. However, if the network connection goes down, then region 2 may play a 15-minute loop of content.

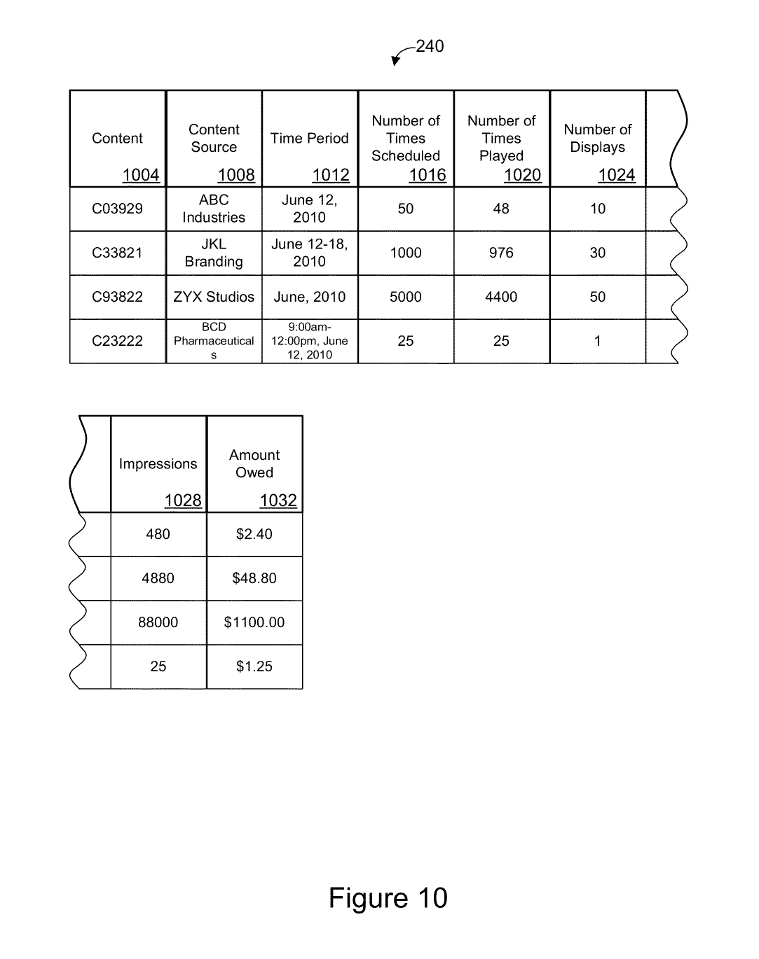

FIG. 10 depicts a reconciliation database 240 according to some embodiments. In various embodiments, reconciliation database 240 may reconcile the number of times content was scheduled to be played on digital signage system 100 with the number of times the content was actually played. In various embodiments, reconciliation database 240 may track how much money is owed to the owner or operator of digital signage system 100 based on how often content was played, based on a number of impressions, or based on any other factor.

Field 1004 may store a content identifier. Field 1008 may store an indication of the source of the content. The source of the content may be an advertiser who is paying to have the content shown on digital signage system 100. The source may also be a government agency or any other source.

Field 1012 may store a time period. The time period may represent a time period during which the playing of content has been, is being, or will be tracked. Field 1016 may store a number of times that a particular item of content has been scheduled for play (e.g., across the entire digital signage network 100; e.g., across some subset of displays in digital signage network 100). Field 1020 may store a number of times that a particular item of content has been played (e.g., across the entire digital signage network 100; e.g., across some subset of displays in digital signage network 100). Field 1024 may store a number of displays on which a given item of content has been played (e.g., during the time period listed in field 1012). Field 1028 may store a number of impressions that a given item of content has made. Field 1032 may store an amount owed to the owner or operator of digital signage network 100, e.g., by virtue of the number of times an item of content has been played.

It will be appreciated that reconciliation database 240 may store other data, in various embodiments. In some embodiments, reconciliation database 240 may break down the number of times an item has been played by display, by type of venue, by hour of the day, or according to any other factor. For example, reconciliation database 240 may indicate how many times an item of content has been played during rush hour, and how many times the item of content has been played during other times. The breakdown of the number of times an item of content has been played may factor into the price charged to a provider of the content (e.g., a provider may be charged more when content has been played during rush hour than when content has been played during slower hours).

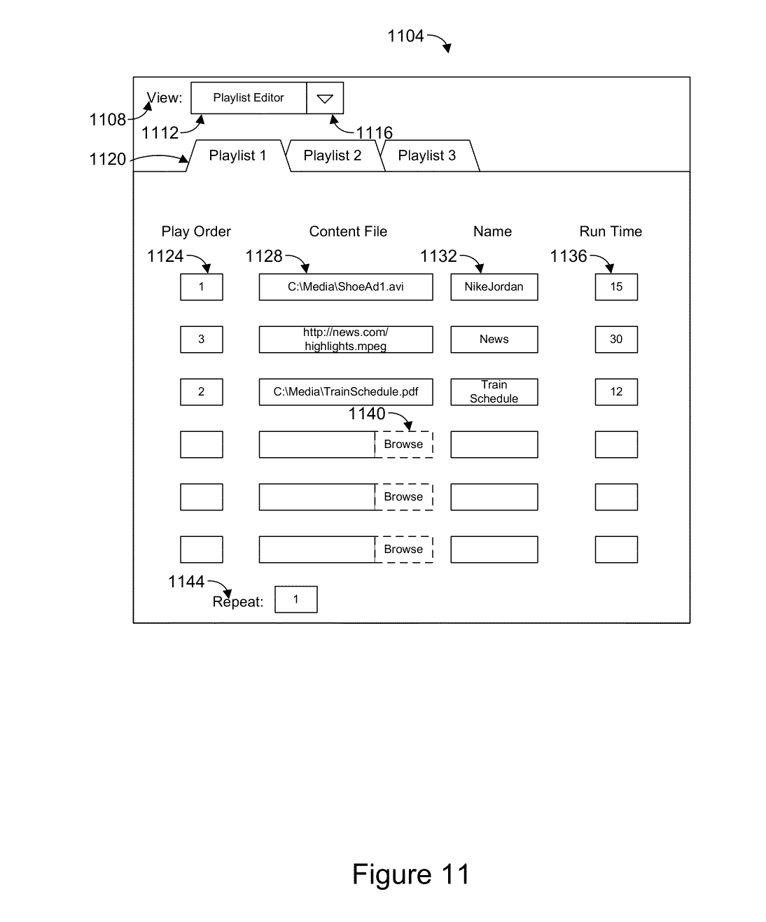

FIG. 11 shows a portion of a user interface, according to some embodiments. The portion of the user interface shown 1104 may allow a user to load various items of content. For example, the user may load images, text files, animations, video, or any other item of content. The user may load such content from any suitable location. For example, the user may load files from a computer he is using (e.g., from computer 152), from another computer on a network, from a remote computer or server on the Internet, from a storage medium (e.g., from a compact disc; e.g., from a USB drive), or from any other location. In loading content, a user may cause such content to be stored in a particular location, such as on a server (e.g., server 104), on a computer (e.g., on computer 156), on a media player (e.g., on media player 136), on a display (e.g., on display 132), or in any other location.

To load content, a user may enter into the user interface location information for the content and/or an identifier for the content. For example, the user may enter a folder on his computer where the content may be found, and may also enter the file name of the content. In another example, a user may enter the Web address where the content may be found, and may further enter the file name of the content. Field 1128, and similar fields, allow the user to enter location information. In some embodiments, a user may press a “browse” button (e.g., button 1140), which may bring up a window for examining files and folders on the user's computer and which may allow the user to conveniently designate folders for finding the content, as well as the content file itself.

In various embodiments, once an item of content has been loaded, a user may enter additional information about the content. For example, the user may enter a convenient name by which to identify the content (e.g., in field 1132). A user may enter the originator of the content or the target audience for the content. In various embodiments, additional information about the content may be determined automatically, e.g., from the content file itself. For example, a playing time for the content, or a file type for the content may be determined automatically. The determination may be made, for example, from the content file's name (e.g., from a file extension designating the content type), or from header information within the content file.

In some embodiments, actual content need not be loaded. Rather, the actual content may be stored at some other location. In some embodiments, an indicator or address of content may be designated. In the future, when the actual content is required (e.g., when actual images are required for playing on a display), the actual content may be downloaded or otherwise obtained from the address. Providing a location or indicator of content rather than actual content may be appropriate for content that is to be real-time, such as stock quotes or news headlines.

For an item of content loaded or designated, a database record or entry may be made. The record or entry may be stored in content database 224, for example.

With content loaded or designated, a user may then arrange various items of content into sequences. These sequences or lists of content may be referred to as “channels”, “playlists”, or by some other terminology. A playlist may comprise one or more items of content together with some designated order for the items of content. For example, a playlist may comprise content items A, B, C, and D in the following order: C, B, A, D. A playlist may, in various embodiments, include a single item of content that is repeated multiple times in the order. For example, a playlist may comprise content items A, B, C, and D in the following order: A, B, C, A, D, B, C, A, D. In various embodiments, a user may enter a playing order for content within a playlist by entering a number in field 1124. For example, by entering the number 1 in field 1124, a user may indicate that the corresponding content is to be played first within a playlist.

In various embodiments, a first playlist may contain a second playlist. For example, playlist A may contain playlists B and C. In this example, playlist A may thereby contain all items of content in playlist B and all items of content in playlist C. In various embodiments, a playlist may be formed from one or more other playlists together with one or more other items of content. For example, playlist A may contain playlist B and content item X. As will be appreciated, in various embodiments, playlists can be nested within one another to arbitrary depth. For example, playlist A may contain playlist B, which may contain playlist C, which may contain playlist D, and so on. By forming a first playlist from a second playlist, a user may more quickly form playlists and/or may form playlists using more manageable “blocks” of content, rather than working with numerous individual items of content.

In various embodiments, program logic may prevent the creation of infinitely nested playlists. For example, suppose playlist A contains content item X and playlist A. Thus, actually playing playlist A would cause content item X to be played repeatedly, without end. Thus, in various embodiments, program logic may prevent a playlist from containing itself. In various embodiments, program logic may prevent a first playlist from containing any other playlist which contains the first playlist. In various embodiments, program logic may prevent a first playlist from containing any playlist which contains the first playlist, either directly or indirectly (e.g., through a chain of one or more other playlists).

A playlist may further comprise playing times for various items of content. For example, one item of content in a playlist may be a static image. In some embodiments, when a user creates a playlist, the user may designate how long the image is to be displayed before the next item of content is displayed. In some embodiments, the playing time of an item of content is already designated or determined as part of the content item itself (e.g., a particular static image is always played for five seconds, and such playing time is indicated in content database 224). In some embodiments, the designation of a playing time may be useful for content of a real-time nature. For instance, real-time weather information may play for 10 seconds before some other content is played. In some embodiments, a playing time for content may be entered, either by the user or automatically, in field 1136.

In various embodiments, a playlist may comprise contingency features, control features, and/or any other features or commands. For example, a playlist may comprise a repeat feature. With a repeat feature, once all content in a playlist has played, the content may repeat, starting from the first item of content in the playlist. In some embodiments, a playlist may repeat content a certain number of times (e.g., five times), before the content will no longer be played. In some embodiments, the playing of a playlist may be contingent on some event. For example, a playlist may be played only if a particular team wins the Super Bowl. In some embodiments, a user may input or select control features for a playlist when creating the playlist. For example, a user may enter a number of times to repeat in field 1144. In some embodiments, a user may input or select control features at a later time (e.g., when the user is designating a playlist to be played on one or more displays).

In various embodiments, there may be multiple playlists. For example, a user may create multiple playlists. Each playlist may comprise different items of content, or the same content in different orders, or the same content but with different playing times, or any other variations. A user may work with different playlists in the portion of the user interface 1104 by navigating through different tabs. Tab 1120 brings up “Playlist 1”. However, the user may work with other playlists by selecting different tabs.

In addition, in various embodiments, the user may wish to work on other portions of the user interface. The view 1108 shown in FIG. 11 may represent the playlist editor, as indicated by menu item 1112. However, in various embodiments, a user may manipulate arrow 1116 to select other menu items, and therefore other portions of the user interface.

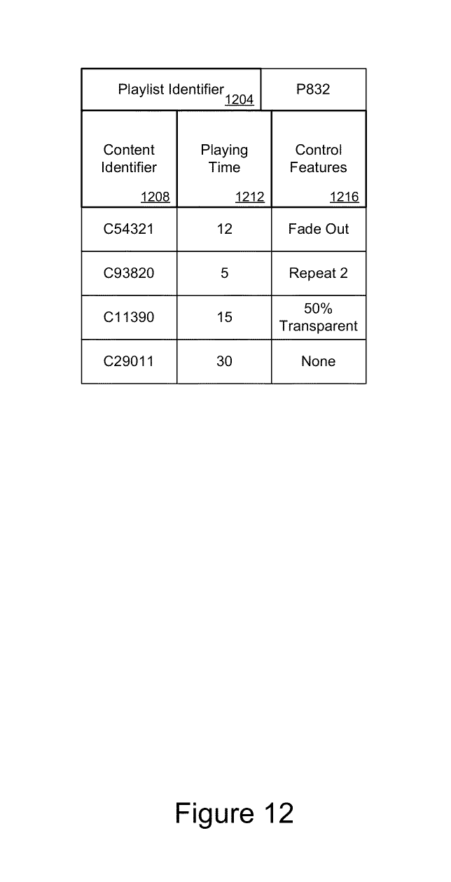

As a user creates a playlist and determines the items of content to be in the playlist, information about the playlist may be stored in a playlist database. FIG. 12 shows an entry 1200 in a playlist database, according to some embodiments. Field 1204 may store a playlist identifier which may be used to uniquely identify a playlist, in some embodiments. Field 1208 may store content identifiers. Each content identifier may indicate an item of content that makes up the playlist. In some embodiments, the order in which the content identifiers are stored indicates the order in which the corresponding content will be played. Field 1212 may be used to store playing times. For example, static images may be given a particular length of time to be displayed before the next item of content in a playlist is displayed. Field 1216 may be used to store control features, according to some embodiments. Control features may indicate the manner in which content is to appear and disappear (e.g., the content may fade in or fade out), the number of times an item of content is to be repeated (e.g., an item of content may be played twice within a playlist), the visual effects applied to content (e.g., the content may be made transparent; e.g., the content may be tinged red; e.g., the content may be shown with increased contrast), or any other manner in which content is to be played, or any other manner in which content is to be handled.

In various embodiments, playlists may be part of a schedule, possibly together with individual items of content. For example, the entry 236 in the scheduling database entry 236 of FIG. 9 may list playlists in addition to, or in lieu of individual items of content.

In various embodiments, a user may designate the locations on a display where certain content and/or where certain playlists are to be displayed. For example, a user may cause the content of a particular playlist to be displayed in the upper left quadrant of a rectangular display screen.

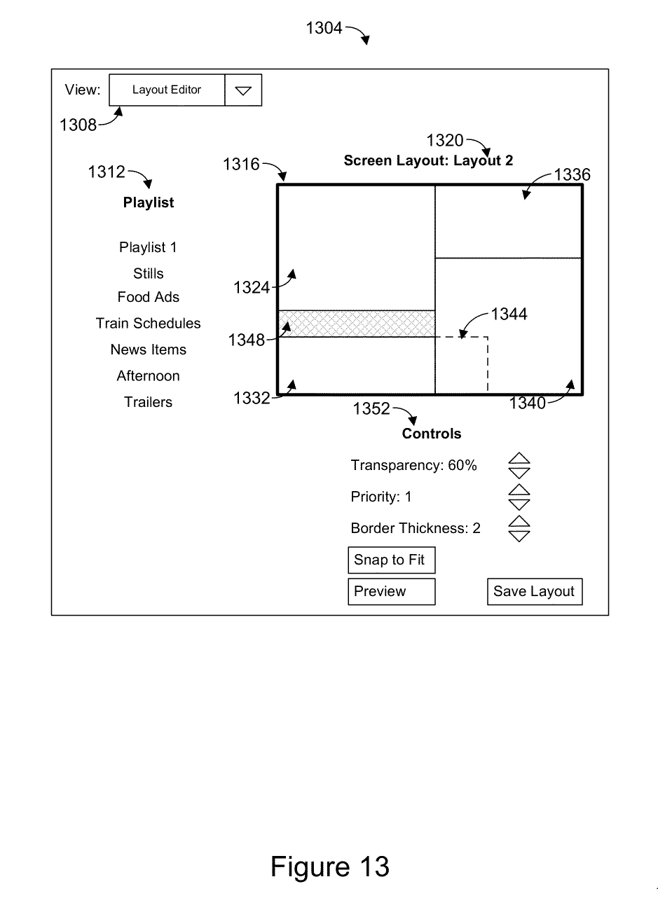

FIG. 13 shows a portion of a user interface which may be used to designate the locations on a display where content and/or playlists are to be displayed. In some embodiments, a rectangular region 1316 represents an actual display. The user may create smaller rectangles (e.g., rectangles 1324, 1332, 1336, 1340) or other shapes within region 1316 to indicate and delineate where certain content and playlists will be played.

The user may designate rectangular regions within region 1316 in various ways. For example, the user may move a mouse pointer to one location within region 1316, click the mouse, and then drag the mouse to another location within region 1316. The starting and ending points of the mouse pointer may correspond to diagonally opposite corners of a newly formed rectangular region (e.g., region 1324). A rectangular region that has already been formed may be resized by clicking on and dragging one of the corners or one of the edges, for example. In some embodiments, a rectangular region (e.g., region 1324) may be moved within region 1316 by clicking on the region (e.g., region 1324) and moving it within region 1316.

As will be appreciated, there may be many other ways to form, resize, or move regions such as region 1324. Further, in various embodiments, a user may create regions of shapes other than rectangular shapes. For example, a user may create a region shaped like a circle, a triangle, a guitar, or any other shape. In some embodiments, the region representing the whole display (i.e., region 1316) need not be shaped like a rectangle. For example, the display being represented may be built in the shape of a circle. Thus, region 1316 may be shaped like a circle.

### Snap to Fit

In various embodiments, a user may create rectangular regions (e.g., region 1324) within the larger region 1316. Depending on the user's efforts or hand dexterity, for example, the regions that a user creates will not necessarily occupy the entirety of region 1316. In other words there may be some empty space in the region representing the whole screen (e.g., region 1316) that is not occupied by user-created regions for displaying content. For example, the space indicated by reference numeral 1348, although surrounded by regions 1324, 1332, and 1340, is not occupied by any user-created region. In some embodiments, when there are empty spaces, the user-created regions may automatically expand and/or resize in such a manner as to fill one or more empty spaces. For example, suppose that the user starts with region 1316 completely empty, and then the user creates a first region that fills the entire left third of region 1316, and a second region that fills the entire right third of region 1316. If the user creates no other regions, then the middle third of region 1316 may be left empty. Thus, in some embodiments, the first region may be automatically expanded to fill the left half of region 1316, and the second region may be automatically expanded to fill the right half of region 1316, thus eliminating the empty space in the middle of region 1316. It will be appreciated that, in some embodiments, more complicated resizings may be necessary for filling in empty spaces. For example, in some embodiments, a given user-created region may be shrunk along one dimension, but expanded along another dimension.

In some embodiments, a user may affirmatively issue a command for the user-created regions to fill in empty spaces (e.g., in region 1316). For example, the user may click on one of the controls 1352 marked “Snap to Fit” or similarly marked controls, in order to cause a particular region to change shape so as to fill in empty spaces (or eliminate overlap) within region 1316. In some embodiments, the user-created regions may fill in the empty spaces even without a user command. For example, when a user clicks a button marked “done” or otherwise finishes creating regions, those that have been created may automatically be resized to fill in empty spaces within region 1316.

In some embodiments, other characteristics of a region may be designated or determined. For example, a user may designate characteristics of a region. In some embodiments, one or more regions may overlap. In some embodiments, a first region may be created entirely on top of a second region. Thus, in some embodiments, a characteristic of a region may be its priority for display in the event that it overlaps with one or more other regions. For example, regions may be given numerical priorities, and in the event of an overlap between two regions, the region with the highest numerical priority may have its full content displayed. In some embodiments, numerical priorities may be indicated visually with colors, grayscale levels, patterns, or other visual indicators. For example, a region of higher priority may be shown visually as darker gray than a region of lower priority.

The content in the region with the lower numerical priority may be cut off by the content from overlapping region with the higher numerical priority. In some embodiments, when two or more regions overlap, the content in one or more of the regions may be resized (e.g., shrunk) so that one item of content does not overlap with another item of content. The content that is resized may correspond to content in a region with lower priority. In some embodiments, when two or more regions overlap, one or more regions (e.g., one or more of the overlapping regions; e.g., one or more of any user-created region, even if it does not overlap) may be moved or resized in order to reduce or eliminate the overlapping portion between the two or more regions. For example, suppose the user creates a first region that occupies the leftmost two thirds of the full display region (e.g., region 1316) and a second region that occupies the rightmost two thirds of the full display region. The first and the second region will thus overlap in the middle third of the full display region. According to some embodiments, the first region may be resized to occupy only the leftmost half of the full display region, and the second region may be resized to occupy only the rightmost half of the full display region. As will be appreciated, which of two or more regions is resized may depend on the relative priorities of the regions. For example, a lower priority region that overlaps with a higher priority region may be resized, while the higher priority region may remain the same size. In some embodiments, a user may designate the priority of a region using controls 1352. For example, a “Priority” control may allow a user to adjust the priority of a region, e.g., by manipulating arrows to increase or decrease the priority.

In some embodiments, one or more regions may be moved so that the overlap between them is reduced or eliminated. For example, the user may create a second region that is completely surrounded by and contained within a first region. The second region may thereupon be automatically moved so that it is no longer contained within the first region.

In some embodiments, two or more regions may overlap, and the overlap may be allowed to persist. However, while using the user interface, a user may wish to see the full extent of each user-created region. If a first region were to overlap with a second region, the user might not be able to tell how far the second region extends, as the extent of the second region might be obscured by the first region. In some embodiments, the boundaries of user-created regions might be ordinarily indicated by solid lines. However, when there is overlap between two user-created regions, the portion of a first region that overlaps with another may be indicated with a dashed line. For example, in FIG. 13, region 1332 overlaps with region 1340. The portion of region 1332 that overlaps with region 1340 is indicated by the dashed line 1344. In general, in various embodiments, the boundary of a region that overlaps with another may be indicated differently for the overlapping portion. This might occur for each of two or more overlapping regions, or just for one or more regions that is deemed to lay under/behind/in the background of another region. In some embodiments, when two regions overlap, one of the regions may be made transparent or semitransparent. In this way, a viewer may see that a first region continues under a second region, rather than ending at the boundary of the second region.

In some embodiments, when two or more regions overlap, a user may indicate or command that content displayed in a first of the overlapping regions should be somewhat transparent. In this way, while content in the first region may be visible when playing, content in a second, overlapping region may also be visible. To see two sets of content overlaid on top of one another may create an interesting or pleasing visual effect. In some embodiments, a user may indicate or designate that a certain region should show content that is somewhat transparent, even if the region does not overlap with another region. In this way, content may be given a ghost-like effect, for example. In some embodiments, a user may use a control 1352 labeled “Transparency”, or similarly labeled, in order to adjust the transparency of a region (e.g., of content shown within the region).

In various embodiments, a user may provide that content in a region have various levels of transparency. For example, a user may indicate that content should have 50% transparency. In another example, a user may indicate that content should have 80% transparency.

In some embodiments, a user may assign or create other characteristics for a region. For example, a user may assign a fading characteristic for region borders. With a particular fading characteristic, content, at its borders, may become more and more transparent, so that at the very edge of the region the content becomes almost fully transparent. A user may, for example, assign a characteristic to a region which says how far within the region the fading effect will begin. Note that a different and distinct “fading” effect may describe the way content appears and disappears. Thus, for example, “fading” may alternately refer either to the way content changes over time, or to the way content changes as a function of position (e.g., as a function of distance to the border of a region).

In some embodiments, a user may assign certain borders to a region. For example, a user may indicate that a region is to have a white border of a particular thickness. Thus, any content to be displayed within that region may have to be displayed not only within the region, but also within the border. In some embodiments, a user may employ a control 1352, such as a “Border Thickness” or similarly labeled control to set the thickness of a border to a region.

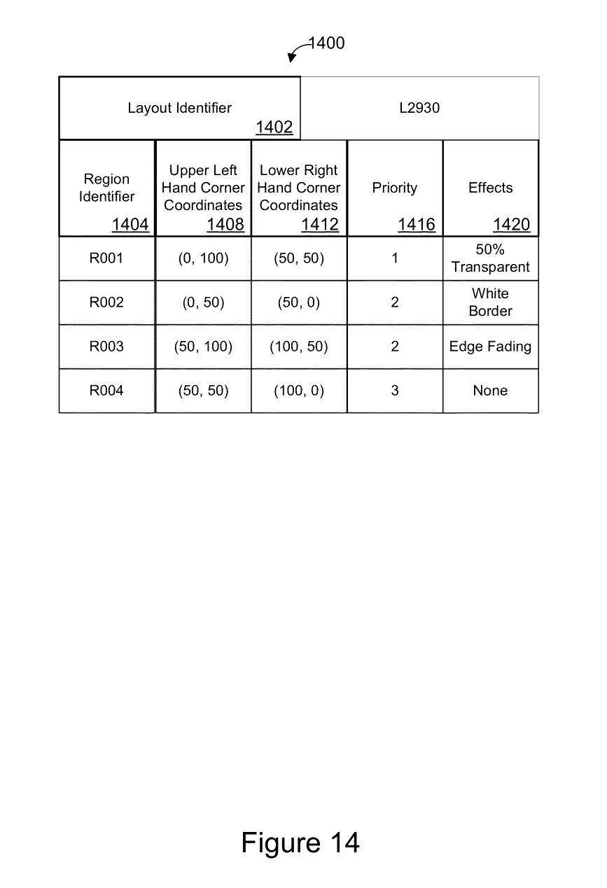

As will be appreciated, many other effects or characteristics may be assigned to a given user-created region. Characteristics assigned to a region may be stored in a database, such as a layout database, an entry 1400 of which is shown in FIG. 14. A user may press a “Save Layout” or similarly labeled button in order to save a particular layout (e.g., a particular arrangement of regions; e.g., a particular arrangement of regions with corresponding characteristics for the regions).

FIG. 14 shows an entry 1400 in layout database 244, according to some embodiments. The entry may represent information about one particular layout (e.g., about the layout corresponding to field 1402). The entry in the layout database may store information about user-created regions in which content is to be displayed on a larger display. Entry 1400 may store such information as the location of user-created regions and various characteristics that have been assigned to the regions. Field 1404 may indicate a region identifier. The region identifier may be used, for example, to uniquely identify a particular region. Field 1408 may indicate x-y coordinates of the upper left hand corner of the user-created region within the overall display region (e.g., within region 1316). Field 1412 may indicate the lower right hand x-y coordinates of the user-created region. Field 1416 may indicate the priority. The priority may, for example, aid in the determination of whether the instant region should be in view or should be hidden in the event of an overlap with another region. Field 1420 may indicate one or more effects that should be applied to the region.

In some embodiments, effects or characteristics are not permanently tied to a particular user-created region. In some embodiments, the effects applied to the content in a region vary based on the content itself. For example, when a first item of content is played in a region, the content may be played with no effects. However, when a second item of content is played in the same region, the second item of content may be played with 50% transparency. Thus, in various embodiments, effects may be tied to items of content rather than to regions. In some embodiments, an effect depends on both content and region. For example, a given item of content will have a certain effect only when it is played in a certain region.

In various embodiments, a user need not create regions from scratch. In some embodiments, there may be templates where various regions have already been created and arranged within the larger display region. A user may pick a template that suits his needs. In some embodiments, a user may pick a template and then further refine it. For example, a user may choose a template with regions already delineated, but may then attach customized characteristics to each region (e.g., custom border effects).

In some embodiments, a user may save a particular layout of regions and then use it later.

In some embodiments, a first user may use a layout that has been saved by another user.

Dragging Playlists into Regions

In various embodiments, once one or more content regions have been defined, a user may indicate what content is to play in these regions. There may be various ways of matching content with regions, in various embodiments.

In some embodiments, the user interface may display a list of playlists 1312. The playlists may be listed by name or identifier. In some embodiments, an icon is used to represent a playlist. The user may, for example, drag and drop the names of playlists (e.g., playlists from the list 1312), or icons representing the playlists, into one or more regions (e.g., into regions 1324, 1332, 1336, and/or 1340). The names of the playlists (or other indicators of the playlists, such as icons) may then appear within the regions. It will be appreciated that, in various embodiments, there may be many other ways of matching a playlist to a content region. In some embodiments, a user may match two or more playlists with a given content region. In this case, for example, the playlists may play sequentially within the content region.

In some embodiments, a user may preview how a display might look with content actually playing. For example, after a user has created one or more regions (e.g., region 1324), and after the user has designated content (e.g., playlists) for one or more of the regions, a user may employ a control 1352 labeled “Preview” or similarly labeled control. Thereupon, region 1316 may show all the designated playlists playing in all the designated regions. For example, the user may get to see four items of content playing at the same time, one in each of four regions within the larger region 1316.

### Icons

In some embodiments, for the purposes of a user interface, a playlist may be represented by an icon. The icon may be a small image. The image in the icon may be an image taken from an item of content in the playlist. Thus, in various embodiments, when a playlist is created, a program module scans through the content in the playlist and captures a frame or image from the content. The program may then shrink the frame or image down to the size of an icon. The shrinking may be accomplished using various image processing algorithms. In various embodiments, a program module may create two or more candidate icons and ask the user to select from among them. In various embodiments, a user may create his own icon, e.g., using a drawing program.

In some embodiments, there may be various size requirements for content. For example, a particular item of content may require that it be displayed in a region at least a quarter of the size of a display screen. In various embodiments, if a user matches a playlist to a content region that is not of the appropriate size for the content within the playlist, then various things might occur. In some embodiments, the content region may automatically resize in order to fit the dimensions required by the content. A user who had not been expecting the resizing might then have the opportunity to press an “undo” button or otherwise reverse the matching and have the content region revert to its previous dimensions. In various embodiments, if a user attempts to match a playlist to an inappropriately sized content region, the user may be prevented from doing so. Instead, an error or warning message may appear. The message may tell the user that the content region is the wrong size for the content within the playlist. In some embodiments, the user may be given the opportunity to change the content within the playlist (e.g., to eliminate the content item that had the stringent dimensions requirements). In some embodiments, the user may be informed what item of content is creating the conflict. As will be appreciated, many other actions may be taken in the even that a user attempts to match a particular playlist with an inappropriately sized content region. In various embodiments, other aspects of a content region may not be appropriate for certain content. For example, the border effects or the fading effects of a particular content region may be inappropriate for a particular item of content. In such cases, error messages may be displayed, the user may be given the chance to change the items of content in a playlist, or other actions may be taken.

### Display

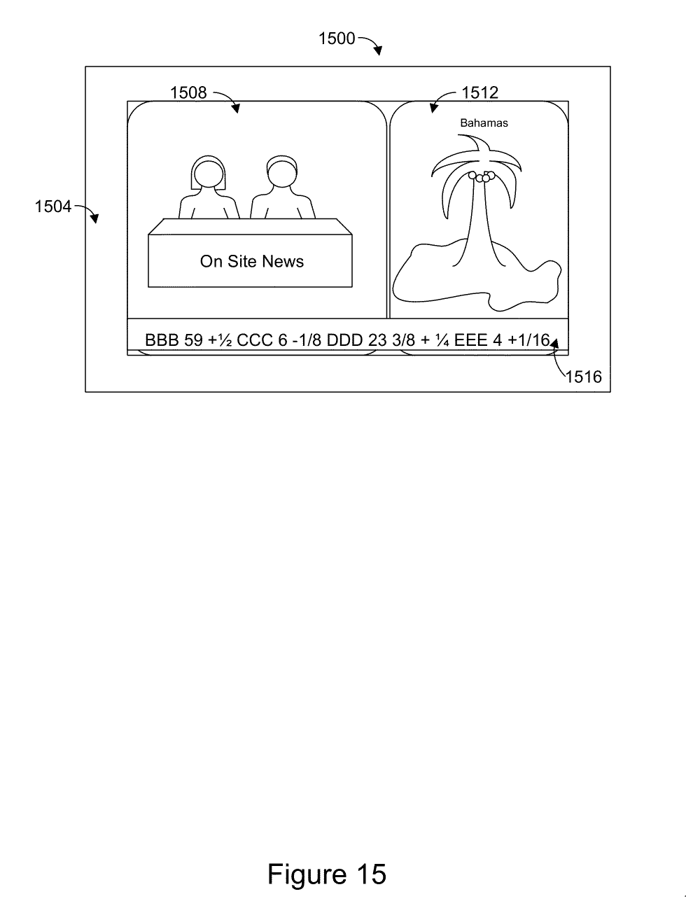

FIG. 15 shows a display 1500 according to some embodiments. A display may be a liquid crystal display (LCD), a cathode ray tube (CRT) display, a light-emitting diode (LED) display, an organic light-emitting diode (OLED) display, a projection display, a rear-projection display, a front projection display, a laser display, or any other display. The display may include a bezel 1504 surrounding a viewing area. In FIG. 15, three different content regions are visible. Region 1508 is currently playing news. Region 1512 is currently playing an advertisement for the Bahamas. Region 1516 is currently showing stock price information. Note that region 1516 overlaps with regions 1508 and 1512. Thus, the content shown in region 1516 may be shown somewhat transparently to create a visually pleasing or interesting effect. Note that the number of regions shown in FIG. 15 represents but one of many possible numbers of regions, in various embodiments. Note that the layout featured in FIG. 15 represents but one of many possible layouts, in various embodiments.

### Reconciliation Report

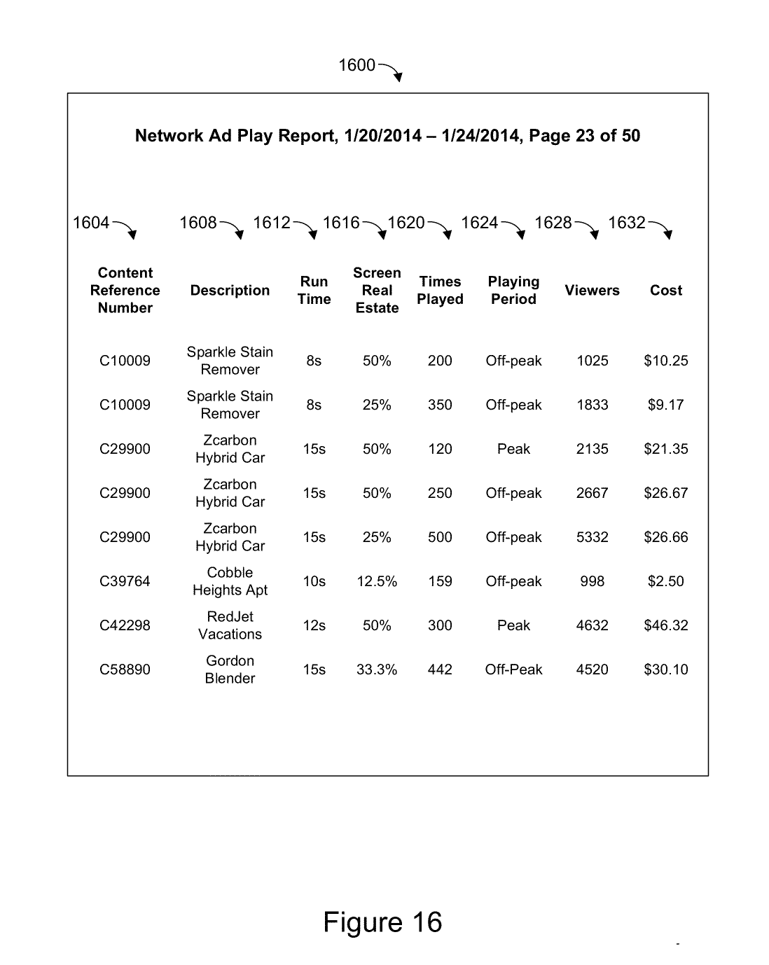

FIG. 16 shows a portion of a reconciliation report 1600 according to some embodiments. A reconciliation report may be a report that is provided to marketers who advertise on digital signage system 100. A reconciliation report may indicate various statistics about how an ad or series of ads has been shown. In various embodiments, a reconciliation report may be provided to others, including providers of content other than advertisements, including owners or part owners of system 100, including managers or operators of system 100, or including any other party. In various embodiments, a reconciliation report may serve as an invoice. For example, a reconciliation report may show an advertiser how many times their ad has played on a digital signage network and, accordingly how much the advertiser owes for having its ad played. In various embodiments, a reconciliation report may show statistics about the playing of content other than ads. In various embodiments, a reconciliation report may show any statistics related to the use of digital signage system 100 or any statistics related to digital signage system 100.

In FIG. 16, the reconciliation report is entitled “Network Ad Play Report”, though it will be appreciated that the report could have any title, or no title at all. The report 1600 also covers a particular date range, though it will be appreciated that a reconciliation report could cover any applicable or conceivable date range. The date range may represent the dates during which content covered in the report was played. Column 1604 may include reference numbers or identifiers by which to uniquely identify a particular ad or particular item of content. These reference numbers may correspond to content identifiers (e.g., from FIG. 6). Note that the same reference number may be listed multiple times. Each line for which the same reference number is listed may represent the same item of content, but a different circumstance under which the content was played. For example, a given ad may be played during peak times and during off-peak times. The advertiser may be charged different fees for peak versus off-peak airing of the ad. Thus, it may be appropriate to break out peak plays versus off-peak plays into two separate line items. Similarly, there may be different fees for playing ads on different sizes of screen real estate. For example, the fee for an ad that plays on half a screen may be more than the fee for an ad that plays on a quarter of a screen. As will be appreciated, various other circumstances under which an ad or other item of content is played may vary. In some embodiments, the fee for an ad may vary based on the length.

Column 1608 may include a description of the ad or other item of content. The description may be created by the advertiser or other party who submitted the content. The description may be created by the digital signage system owner or operator, or by any other party. Column 1612 may include a run time for the ad or other content. In various embodiments, the same ad may be played with different run times. For example, a given ad consisting of a still image may be played for five seconds in some circumstances and for ten seconds in other circumstances. Column 1616 may include a percentage or other measure of screen real estate that is to be occupied by an item of content. For example, an entry of 50% may indicate that an item of content is to occupy 50% of the screen or display area on the display on which it is played. As will be appreciated, area on which an item of content is played may be measured in terms of square centimeters, pixels, or in terms of any other metric.

Column 1620 may include an indication of the number of times a given item of content was played. This number of times may indicate the number of times the item of content was played across the whole digital signage system. Thus, for example, an item of content that has played two hundred times in total may have played ten times on each of twenty displays within the digital signage system.

Column 1624 may include a playing period. Note that, in various embodiments, different time periods during the day, during the week, during the month, or during any other cycle may be inherently more or less valuable to an advertiser or other content provider. For example, a time period during lunch hour in a restaurant may be relatively more valuable to an advertiser because the advertiser's ad may receive more views than it would at other times of the day. An advertiser or other content provider may, in various embodiments, pay different amounts to show an ad depending on the time period during which the ad is shown. Column 1624 labels playing periods as either “Peak” or “Off-peak”. These may correspond, respectively, to times of relatively high viewer traffic and times of relatively low viewer traffic. As will be appreciated, playing periods could have other labels and/or other meanings Playing periods may labeled according to a time of day (e.g., “morning”, “evening”, “lunch”), according to day of the week (e.g., “Sunday”, “Monday”), according to the occurrence of particular events (e.g., “parade time”, “plane arrival time”, “ship docking time”), or according to any other circumstance or happening. Note, for example, that a digital sign may receive varying numbers of viewers depending on the occurrence of an event. For example, a sign at a particular location in an airport may receive relatively more viewers right after a plane has just arrived at a nearby gate. Therefore, in some embodiments, an advertiser or other content provider may pay more or less depending on the events that occur proximate in time to the playing of its content.

Column 1628 may indicate a number of viewers. The number of viewers may represent the total number of viewers who have viewed a particular ad or other item of content played under particular circumstances (e.g., during particular time periods and on a given size of screen real estate). In various embodiments, the number of viewers may be determined using models or other estimates. For example, if an advertisement is played on a digital sign inside one car in a six-car train, it may be assumed that one-sixth of the total passengers on the train viewed the advertisement. The total number of passengers on the train may, in turn, be estimated from the number of people entering and exiting turn styles at the train stations that the train has passed. In some embodiments, direct measurements of number of viewers may be used. For example, a digital sign may include a camera. The camera may pick up images from people viewing the digital sign. Image processing algorithms may then be used to determine whether people within the images are gazing in the direction of the digital sign. A person who fixes his gaze at the digital sign for more than a predetermined period of time (e.g., for more than 1 second) during the period of time when an ad is playing may be considered a viewer of the ad.

In some embodiments, algorithms may be used to determine not only whether or not a person is gazing at a digital sign, but also at what portion of the screen the person is gazing. In this way, if there are two or more items of content playing at once on a screen, it may be determined which of the two or more items of content the person is gazing at.

In some embodiments, infrared sensors near a digital sign may track passersby. In some embodiments, pressure sensors within the floor or ground may detect passersby. As will be appreciated, there may be various other ways of estimating and/or determining the number of viewers of an ad or of other content.

Column 1632 may include a cost or price. The cost may represent an amount of money being charged to a marketer or other party for using the digital signage system 100. The cost may be computed in various ways. The cost may be based on the number of times an item of content was shown, based on a time period during which the ad or other content was played, based on the amount of screen real estate occupied by the ad or other content when it was played, or based on any other criteria. In some embodiments, a cost for the playing of ads is negotiated in advance (e.g., between a marketer and an operator of the digital signage system).

As will be appreciated, the reconciliation report may be presented in various other ways. The reconciliation report may show other data, including more data, or less data. In some embodiments, a reconciliation report may be tailored for a particular marketer or for a particular other party. For example, a reconciliation report may show only the ads that correspond to a particular marketer. In some embodiments, a reconciliation report may be tailored to specifically analyze subsets of digital signage system 100. For example, a reconciliation report may be created that shows only the content that has played on displays in one particular location.

### Handling Content

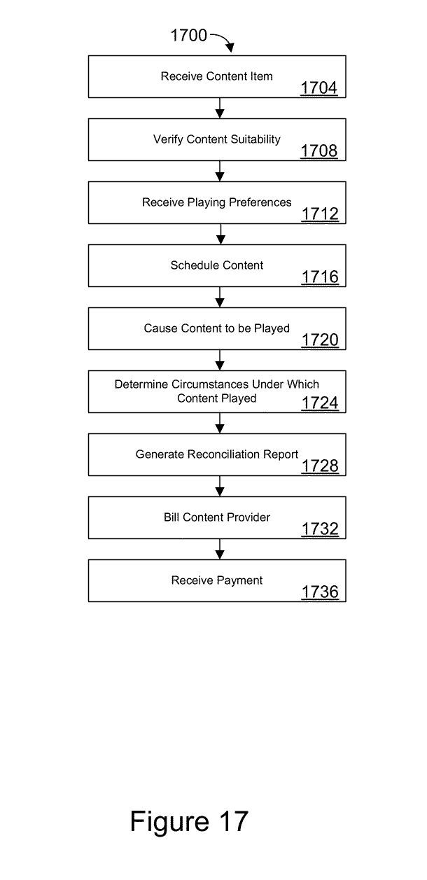

FIG. 17 shows a method for handling content, according to some embodiments. The method may be used, in various embodiments, by an operator of digital signage system 100 to receive content from an advertiser (or other party), to play the content, and to collect payment for the playing of the content.

At step 1704, a content item may be received. The content item may be an electronic file in various formats. The content item may be received over a network (e.g., via email), on a storage medium (e.g., on a compact disc; e.g., on a USB drive). The content item may be received through a Web site. For example, an advertiser may upload an advertisement using a Web site of the digital signage system. In some embodiments, a pointer or address to a content item may be received (e.g., an address for a Website containing the content may be received). The item of content may later be retrieved from the location or address.

At step 1708, the suitability of the content item may be determined. In various embodiments, a content item may be checked to ensure there is not offensive, racy, or otherwise inappropriate content. In some embodiments, a content item may be checked to ensure it is relevant to a particular audience. For example, content may be checked to ensure that it is in the language of likely viewers (e.g., Spanish versus English). In some embodiments, a content item may be checked to ensure it does not advertise a product or send a message that is contrary to the desires of a host for a digital sign (or to the desires of some other interested party). For example, if a content item is to be played within a Nike shoe store, it may be verified that the content item does not promote Reebok, a competitor to Nike. In various embodiments, the suitability of a content item may be determined automatically. For example, the text of ads may be scanned for obscene language. In various embodiments, the suitability of content may be determined via human inspection (e.g., a human may view or otherwise observe an item of content and determine its suitability). In various embodiments, a combination of human and computer or automatic verification may be used.

At step 1712, playing preferences may be received. Playing preferences may include indications of preferred times, locations, and playing frequencies for content. Playing preferences may include indications of the amount of screen real estate that an item of content should occupy (e.g., 50% of the screen; e.g., 100% of the screen). In various embodiments, playing preferences may include an indication of other content that the present item of content should not be played with. For example, a first advertiser may not wish for his ad to be played on the same screen at the same time as an ad from another advertiser. Playing preferences may include an indication of preferred viewer demographics. For example, an advertiser may indicate a preference that its ad be played only for audiences of a certain age. As will be appreciated, playing preferences may indicate various other information, such as information pertaining to the circumstances under which an ad or other item of content is to be played. In various embodiments, playing preferences may be received via a Web site. In various embodiments, playing preferences may be received over the phone, orally in person, or in any other manner.

At step 1716, content may be scheduled. Content may be scheduled so as to satisfy playing preferences received at step 1712. For example, if a marketer has requested that its advertisement be played once an hour during weekday afternoons on displays inside malls, then the advertisement may be scheduled to play following these guidelines.

At step 1720, content may be caused to play. For example, server 104 may transmit the content and/or instructions to play the content to one or more displays in digital signage system 100. The server may also transmit playing schedules for the content (and for any other content) to one or more displays in system 100.

At step 1724, the circumstances under which content played may be determined. Note that, in various embodiments, content may not have played when it was scheduled to be played. For example, an equipment failure, an electrical failure, or a network failure may have prevented content from being played according to its original schedule. Thus, in various embodiments, an indication may be received, where the indication is of whether or not content played, whether content played on schedule, or other circumstances under which content was played. Indications may be received by server 104, for example. Indications may be provided, for example, by one or more displays, one or more media players, one or more computers, or one of more other devices (e.g., one or more other devices within digital signage system 100).

In various embodiments, circumstances under which content was played may include the viewers that were available to perceive the content. In various embodiments, an indication of the number of people who viewed an item of content may be received. In various embodiments, an indication of average length of time people gazed at an item of content may be received. In various embodiments, an indication of a demographic of a viewer may be received. For example, the server 104 may receive an indication that a man in his twenties was watching a particular item of content while it was playing. In various embodiments, various other information about viewers may be received.

In some embodiments, a viewer may have the opportunity to interact with content. For example, a viewer may answer a survey question that was asked. Thus, an indication of a viewer's answer to a survey or of any other action taken by a viewer may be received.

In some embodiments, information about other circumstances present when content was played may be received. Such circumstances may include weather conditions, the ambient temperature, ambient noise levels, smog levels, the existence of nearby events (e.g., the existence of nearby sporting events), or any other circumstances. In various embodiments, information about circumstances may allow an operator of the signage system or a marketer or another party to better analyze the effectiveness of content. For example, if an advertisement for ice cream is played with no apparent effect on sales, the outcome may be explainable by the fact that it was below freezing outside at the time the ad was played.

At step 1728, a reconciliation report may be generated. The report may be similar to report 1600, according to some embodiments. The report may show how often and under what circumstances content was played. The report may show how much a marketer, content provider, or other user of digital signage system 100 owes.

In some embodiments, money may be owed to a content provider or other party. For example, the operator of digital signage system 100 may pay content providers for interesting content that will draw the attention of viewer. Thus, in various embodiments, a reconciliation report may show amounts owed to a content provider or to another party.

At step 1732, a content provider may be billed. The content provider may be an advertiser, for example. In some embodiments, the reconciliation report may serve as a bill or invoice. The reconciliation report may be sent to the content provider. As will be appreciated, the content provider may be billed in other ways. The content provider may be notified about an amount owed via email, phone, or via any other means.

At step 1736, payment may be received from the content provider. In various embodiments, the content provider may be charged automatically (e.g., a credit card number of the content provider may be kept on file and billed automatically when advertisements of the content provider have been played).

It will be appreciated that the steps 1700 illustrated in FIG. 17 represent some embodiments. In various embodiments, additional steps may be added, or some steps may be omitted. In various embodiments, steps may be performed in a different order.

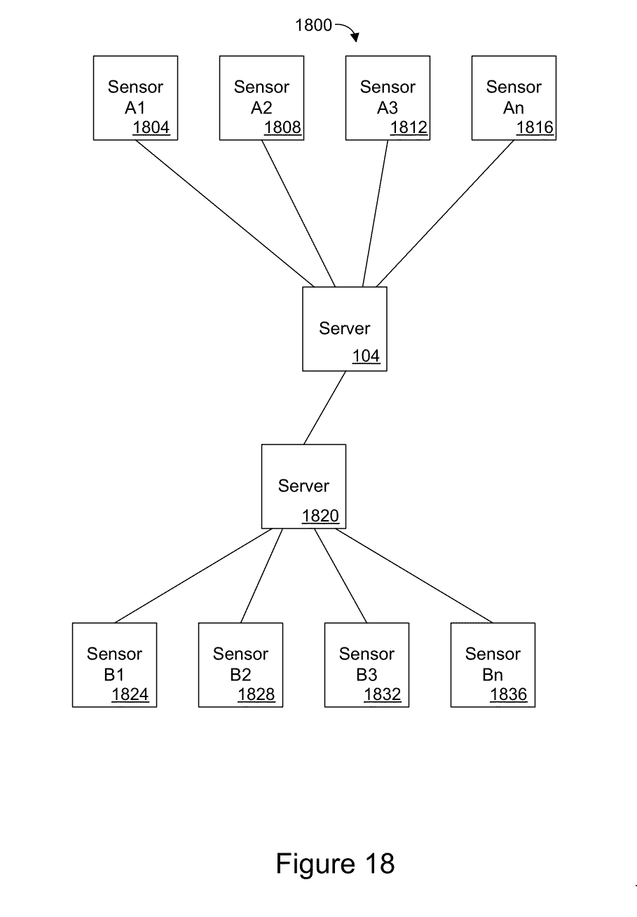

FIG. 18 shows a network of sensors, according to some embodiments. Sensors may include cameras, microphones, infrared sensors, pressure sensors (e.g., sensors in sidewalks), touch sensors, RFID sensors, antenna, vibrations sensors, radar detectors, smell or chemical sensors, or any other sensors.

In various embodiments, sensors may serve various functions or uses for or within digital signage system 100. In various embodiments, sensors may measure human traffic. Sensors may thus allow advertisers or other content providers to measure the size of the potential audience for their ads. In various embodiments, sensors may measure gaze or other indicators of human attention. This may also allow advertisers to gauge the impact their ad has made. For example, ads that have attracted longer gazes may be considered to have had greater impact. In some embodiments, sensors may allow a targeting of ads or other content. For example, in some embodiments, a digital sign may physically pivot or rotate to face a person. In some embodiments, sensors may be used (e.g., in combination with computer algorithms) to determine demographic or other characteristics of people. Such characteristics may be used to target ads or other content. In some embodiments, sensors may be used for interactivity. For example, a display within system 100 may function as a touch screen that may allow people to answer questions, provide feedback, ask questions, or otherwise interact.

In various embodiments, sensors may be built into displays of the digital signage system 100. In some embodiments, sensors may be physically connected to displays. In some embodiments, sensors may be in electronic communication with displays. In some embodiments, a sensor may be completely separate from any display. For example, a sensor may be located ten feet away from a display. The sensor may detect the presence of a person and thereby cause the display to power on or to otherwise seek to get the attention of the person.

As shown in the network 1800, one or more sensors (e.g., sensors 1804, 1808, 1812, 1816) may be in communication with server 104. Sensors may report various information to the server 104. The server may then use such information to issue commands to displays, to generate reconciliation reports, or to perform any other function. In some embodiments, one or more sensors (e.g., sensors 1824, 1828, 1832, 1836) may be in communication with another server 1820. Server 1820 may, in turn, be in communication with server 104. It will be appreciated that various other network architectures are possible. In some embodiments, sensors may be in communication with displays, media players, or computers of digital signage system 100, rather than with server 104.

### Rules

In some embodiments, a schedule for the playing or presenting of content need not be determined or completely determined in advance. In some embodiments, a given item of content may be played based on current circumstances or triggering conditions rather than based on a predetermined schedule. For example, a certain item of content may be played when a person of a target demographic is looking at a display. As another example, an item of content advertising sun tan oil may be played only when the weather is currently sunny.

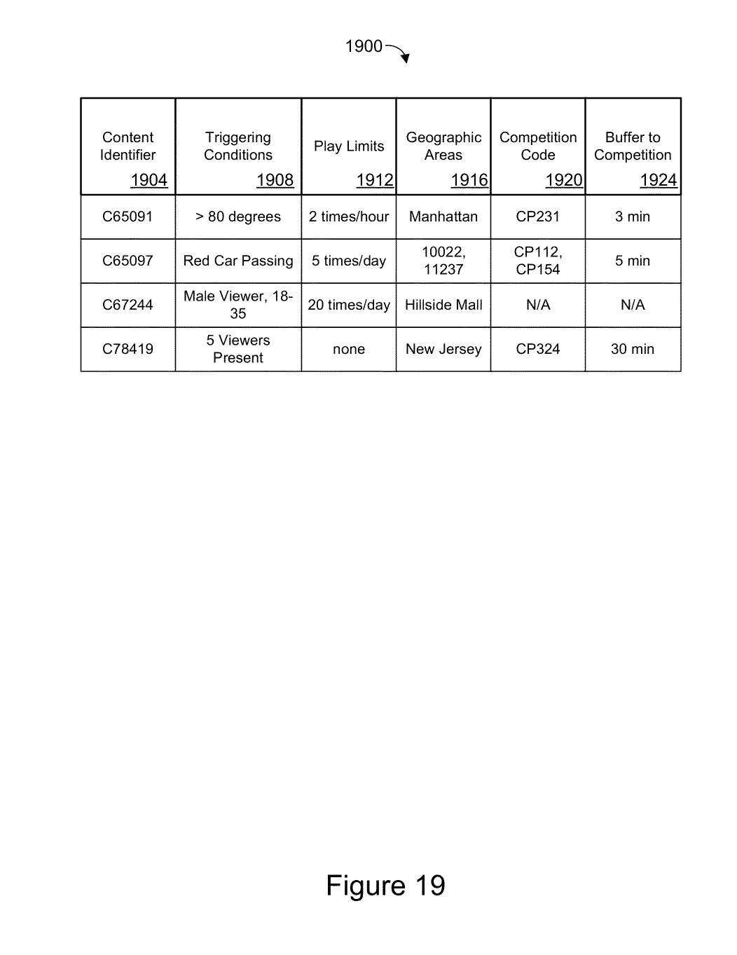

FIG. 19 shows a rules database 1900, according to some embodiments. The database may include one or more rules that determine when a given item of content will play. Field 1904 may include content identifiers. Field 1908 may include triggering conditions. Such conditions may include conditions that, upon their occurrence, will cause the corresponding content to be played. For example, when the weather exceeds 80 degrees, content C65091 may be played. Field 1912 may include play limits. Play limits may put boundaries on the number of times that a given item of content may be played. For example, play limits may indicate that a given item of content is to be played no more than twice every hour. Otherwise, for example, the item of content might play continuously so long as its triggering condition was met. Field 1916 may include geographic areas. Geographic areas may represent areas where the content may be played. In some embodiments, specific geographic areas may be indicated where a given item of content is not to be played.

Field 1920 may include, for a given item of content, one or more competition codes. Competition codes may represent certain industries (e.g., restaurants; e.g., travel), certain product categories (e.g., shoes; e.g., cars; e.g., soft drinks), certain service categories (e.g., medical practices; e.g., barber shops), or any other categorization. A competition code may indicate a category in which competitors of the provider of the content fall. For example, a soft drink manufacturer may have provided a given item of content which is an ad for their soft drink. The competition code for the item of content may therefore represent soft drinks. The provider may desire that the item of content not be played within a given amount of time of content from another soft drink manufacturer. In various embodiments, the competition code may represent a category in which a given item of content falls. In various embodiments, the competition code may represent a category in which a provider of a given item of content falls. In various embodiments, a competition code may represent a code such that a provider of content does not wish for its item of content to be played within a certain period of time of another item of content corresponding to the competition code. Field 1924 may include a buffer time period. This may represent the amount of time that must elapse between the playing of a first item of content, and the playing of a second item of content corresponding to the same competition code.

As will be appreciated, many other rules could be used to determine when a given item of content will be played. Database 1900 is representative of but some examples of some rules that may be used, according to various embodiments. As will be appreciated, in various embodiments, rules could be used for determining when entire playlists will play.

### Interaction Between Two Regions

In some embodiments, content played in a first region of a display may correlate to content played in a second region of the display. For example, a first region of a display may show news. A second region of the display may be keyed to the first, so that, for example, advertisements in the second region will be triggered by certain news events. For example, when the news turns to weather, an ad for home gutters may be triggered to play. When the news turns to Halloween, an ad for costumes may be triggered. In this way, content played in a second region may be more relevant to content played in a first region.

In various embodiments, content may be associated with meta-tags, descriptions, or other associated information. For example, a given news segment may have a meta-tag of “weather, rain”. Another news segment may have a meta-tag of “entertainment”. In some embodiments, a meta-tag may include all or a portion of a transcript of content. In various embodiments, a submitter of content may supply meta-tags. In some embodiments, meta-tags may be determined by a human reviewer or evaluator. In some embodiments, a computer algorithm may use character recognition, speech recognition, image recognition, or some other process for extracting information about content and producing a meta-tag from such information.

In some embodiments, content may include closed captioning. The closed captioning may include a text transcript of an audio portion of content. The closed captioning may be broadcast along with the content. For example, a text transcript of a talk show may be broadcast and displayed in conjunction with the visual and audio portion of the talk show. A viewer of the broadcast might see the visual and hear the audio portions through his television or other display, but may also be able to see the text transcript or closed captioning associated with the broadcast.

In some embodiments, a first region may be an independent, or driving region. Content shown in the first region may not be triggered by content in other regions, but may play according to a preset schedule or according to some other rules. On the other hand, a second region may be a dependent, or following region. Some content that is to play in the second region may be dependent on content that has been shown, that is showing, or that will be shown in the first region. For example, a second item of content may play in the second region only when a first item of content is to play in the first region. It will be appreciated that not all content played in the second region need necessarily be triggered by other content. For example, some content that is to be played in the second region may be prescheduled, while other content that is to be played in the second region may be triggered by content that is played in the first region.

In various embodiments, rules used to schedule content in the second region may utilize meta-data for content that is played in the first region. For example, a scheduling algorithm may search for certain key words in the meta-tags of content that is to be played in the first region. If the algorithm finds one of the key words, then a particular item of content may be scheduled to play in the second region at a particular temporal relationship (e.g., before; e.g., during; e.g., after; e.g., 3 seconds after; e.g., starting two seconds after the beginning; etc.) to the content with the given meta-tags that is to be played in the first region.

As an example, a provider of an ad for pet food may wish for the ad to be featured when a concurrently running news segment mentions such words as “cat”, “kitten”, “kitty”, “pet”, or “purr”. Thus, a scheduling algorithm may search the meta-data of content scheduled to be played in a first region of a display. If the scheduling algorithm finds an item of content (e.g., a news segment) which has “kitten” as a meta-tag (e.g., the news segment is about a kitten stuck up a tree), then the ad for pet food may be schedule to play in the second region concurrently with the identified item of content scheduled for the first region.

In some embodiments, a closed captioning feed, or other transcript of the content played in a first region may be used to trigger, select, or otherwise schedule content that will play in a second region. The closed captioning may be searched for keywords, key phrases, for particular names, or for any other combination of characters, or any search criteria. Upon occurrence of words, names, phrases, etc., that match search criteria, certain content may be triggered. The content may be triggered to play in the second region, or even to play in the first region. For example, if the word “doctor” appears in closed captioning, then a second region may play an advertisement for a local doctor.

In some embodiments, content that is to play in a given region may be triggered by other content that is to play in the same region. For example, when a first item of content plays in the second region, meta-tags associated with the first item of content may trigger the playing of a second item of content in the second region. The second item of content may play immediately after the first item of content.

In various embodiments, multiple criteria may be used to trigger the display or playing of content. For example, a closed captioning feed in a first region may include the word salon. This may trigger the playing of a salon advertisement in a second region. However, the particular salon advertisement played (e.g., out of many possible salon advertisements) may be chosen based on the location of the display. For instance, an advertisement may be played for a salon that is within a 2-block radius of the display.

### Make Adjustments Based on the Direction of a Viewer's Gaze

In some embodiments, two or more items of content may be featured on a particular display at the same time. In some embodiments, the two or more items of content may compete for the attention of one or more viewers. For example, there may be two different advertisements displayed on a given display at the same time. One ad may be in a first region of the display (e.g., on the left half) and another ad may be in a second region of the display (e.g., on the right half).

In some embodiments, digital signage system 100 and/or sensor network 1800 may include a camera. The camera may capture one or more images of a viewer who is looking at a display. The image(s) may be used to determine where on the display the viewer is looking. For example, the image(s) may be used to determine that the viewer is gazing towards the upper right hand corner of the display, or towards the middle of the display. In various embodiments, the image(s) may be used to determine a particular region of the display towards which a viewer is gazing. For example, it may be determined that the viewer is looking towards a second of three regions on the display. In various embodiments, the images may be used to determine a particular item of content the viewer is watching. The particular item of content may be displayed in a particular region and may therefore correspond to a particular region.

Captured images may be used to determine a direction of gaze in various ways. In some embodiments, a viewer's position within a captured image may be determined. The viewer's angle with respect to the capturing camera (or other image capturing device) may then be determined. The user's distance from the capturing camera may also be determined, such as from the viewer's apparent size within the image, or such as from the viewer's relationship within the image to other objects of a known distance or position. For example, if the image shows the viewer to be standing on a particular tile on the floor, and if the distance of the tile to the capturing camera is known, then the viewer's distance from the camera may be determined. In some embodiments, the angle of the focus of the viewer's pupils may be determined from an image of the viewer's face. For example, the shape of the pupils within the image may be determined. A round shape may indicate that the pupils are looking straight on into the capturing device, while a more oval shape may indicate more of a sideways vantage point to the pupils, which may indicate that the pupils are gazing in a direction away from the capturing device. The image may also show portions of the viewer's eye to either side of the viewer's pupil. If equal portions of the viewer's eye are visible on either side of the pupil, then it may be inferred that the viewer is looking directly at the capturing device. However, if more of the viewer's eye is visible on one side of the pupil then the other, then it may be inferred that the viewer is gazing in a direction away from the capturing device. It will be appreciated that there may be various other ways of determining the direction of a viewer's gaze.

In various embodiments, once the distance of the viewer from a camera is known, once the direction of the viewer's gaze with respect to the camera is known, and once the spatial relationship of the camera with respect to the display is known, then the part of the display (e.g., the region of the display) at which the viewer is gazing may be determined with trigonometric algorithms, as will be appreciated.

As will be appreciated, various other means of determining the direction of a viewer's gaze may be determined. For example, infrared light may be reflected off the viewer's eyes, and the angle of reflection (or the occurrence of any reflection) may be used to determine the direction of the viewer's gaze.

Methods of detecting the direction of a viewer's gaze are described in the following patents, all of which are incorporated by reference herein for all purposes:
U.S. Pat. No. 7,346,192, “Image processing system and driving support system” to Yuasa, et al.
U.S. Pat. No. 7,266,225, “Face direction estimation using a single gray-level image” to Mariani, et al.
U.S. Pat. No. 6,456,262, “Microdisplay with eye gaze detection” to Bell.

In various embodiments, the direction of a viewer's gaze may be correlated with an item of content currently playing where the viewer is looking. For example, if it is determined that the viewer is looking at region 1 of a display, it may be determined what item of content is currently being played in region 1 of the display.

In various embodiments, the provider of an item of content (e.g., an advertiser) may be informed that its content was looked at or gazed at by a viewer. The advertiser may thereby measure the impact or effectiveness of its content. In some embodiments, the advertiser may be charged based on the number of viewers who gazed at its content. For example, the advertiser may be charged a fixed amount per person who gazed at the content.

In some embodiments, when it is determined that a viewer is gazing at a particular region or at a particular item of content, the perceptibility of the region and/or of the item of the content may be altered (e.g., the perceptibility may be enhanced). In some embodiments, the region at which a viewer is gazing may be enlarged. The content within the region may be correspondingly enlarged to occupy the newly expanded region. Thereby, for example, the viewer may have a better opportunity to perceive content in which he has shown interest. In some embodiments, other content currently being displayed (e.g., within other regions of the display), may be made smaller.

In some embodiments, when it is determined that a viewer is gazing at a particular item of content, a volume of audio associated with the content may be increased. For example, if the volume had been completely off, the volume may be turned on. As another example, if the volume was on, the volume may be increased. In some embodiments, the volume for other content currently being played (e.g., for content that the viewer is not currently gazing at) may be reduced or eliminated.

In some embodiments, when it is determined that a viewer is gazing at a particular item of content, audio associated with that content may be broadcast to the viewer using directional sound. In this way, for example, the viewer may have the opportunity to hear audio associated with the content, while a nearby person may remain undisturbed by the audio. Audio associated with content may include a soundtrack, spoken words by actors featured in the content, spoken words by a narrator, sounds from the scene the content is depicting (e.g., sounds of lions growling if the content depicts a safari), and so on. In various embodiments, two different viewers may each view the same display. The two viewers may gaze at different regions on the display. Directional sound containing audio from a first of the two regions may then be beamed to the first viewer, and directional sound containing audio from a second of the two regions may be beamed to the second viewer. The two viewers, though they view the same screen, may thereby listen to distinct audio tracks, in some embodiments.

In some embodiments, when it is determined that a viewer is gazing at a particular item of content, the brightness of the content may be altered (e.g., increased), the contrast of the content may be altered (e.g., increased), the color scheme of the content may be altered, or any other alteration to the content may be put into effect. Alterations to the content may enhance the perceptibility of the content, in various embodiments.

In some embodiments, when it is determined that a viewer is gazing at a particular item of content, the rate of play or the rate of progress of the content may be altered. For example, an item of content may be put into slow motion. As another example, an image that had been scheduled to be displayed for only 5 seconds may instead be displayed for 10 seconds. In some embodiments, the progression of a ticker may be slowed. For example, rather than scrolling off the screen in 4 seconds, a given piece of information may remain in the screen for 8 seconds before scrolling off. Alterations to the rate of play or to the progress of content may give a viewer greater opportunity to perceive, admire, understand, or otherwise take in content.

In some embodiments, when it is determined that a viewer is gazing at a particular item of content, the content may be restarted from the beginning. For example, a viewer may begin looking at an item of content halfway through the presentation of the content (e.g., halfway through a video, if the content is a video). If the content is restarted, the viewer may have the opportunity to view the content in its entirety. In some embodiments, an item of content may be repeated one or more times what it is determined that a viewer is gazing at the item of content. The viewer may thereby be given more opportunities to perceive and/or appreciate the item of content.

### Directional Sound

Various embodiments contemplate sound or audio that may be focused in a particular direction. Various embodiments contemplate sound or audio that may be projected to a particular area or location with minimal perceptibility in other locations (e.g., in nearby locations). Various embodiments contemplate sound or audio that can be projected or focused in a tight beam, and which may thereby be heard by some people, but not by others (e.g., by nearby people). Such sound or audio may be referred to herein as “directional sound”, “directional audio”, “hyper-directional sound”, “sound beams”, and the like.

Some methods for producing directional sound are described in the following patents, all of which are incorporated by reference herein for all purposes:
U.S. Pat. No. 7,292,502 “Systems and methods for producing a sound pressure field” to Barger
U.S. Pat. No. 7,146,011 “Steering of directional sound beams” to Yang, et al.
   Pricing Based on Content Viewer Ratings from Other Media

In some embodiments, a first item of content featured on a display of system 100 may include content also featured on broadcast TV, cable, satellite, or the Internet. The first item of content may be a sports game, for example. When shown on TV, cable, satellite, or internet, the same item of content may receive a rating based on the number of viewers. The rating may be a Nielsen rating, for example. The number of viewers may be readily measurable on TV, cable, satellite, or internet, for example. In some embodiments, when the first item of content is shown on system 100, a provider of a second item of content (e.g., an advertisement) may be charged a price based on the number of viewers of the first item of content as measured on television, cable, and/or the Internet. In some embodiments, the number of viewers of a given item of content as measured on television, cable, satellite, the Internet, or on some other medium, may serve as a proxy for the number of viewers of the item of content on a digital signage system. Advertising rates or other rates may be set accordingly. In some embodiments, the showing of a second item of content may be triggered by the viewership ratings of a first item of content that is being shown on the digital signage system. For example, if a football game is being shown on TV and on digital signage system 100, and the ratings exceed a certain level on TV, then a particular ad may be shown on digital signage system 100 in conjunction with the football game.

### Timeline and Scheduling

In some embodiments, a calendar view shows days for which content is scheduled to play on system 100, or on a particular display on system 100. In some embodiments, the calendar view may show what days are fully scheduled (e.g., all available times slots and/or space on the screen is filled), partially scheduled, and what days are not scheduled at all. In some embodiments, a calendar may show the same for shorter lengths of time. For example, a calendar may present a view of a single day and may show which hours are fully scheduled, which hours are partially scheduled, and which hours are not scheduled at all.

In some embodiments, an owner, operator, or other user of digital signage system 100 may wish to schedule content for play on one or more displays of system 100. A user may create a playlist or otherwise designate a set of content. The user may indicate a start time, an end time, and/or a total playing time of the playlist.

In some embodiments, a graphical user interface may show a representation of a calendar or a timeline. Superimposed on the calendar or timeline may be a bar or other indicator showing the duration for which the playlist is scheduled to play. If no playlist has been scheduled for a particular period of time, then the calendar may have no bar or indicator corresponding to that period of time.

In some embodiments, the calendar or timeline may visually indicate to a user what days and/or what times have content scheduled. For example, on a view of a monthly calendar, days shown in a first color may represent days when all available time slots have been filled with scheduled content. Days shown in yellow may represent days when some, but not all available time slots have been filled with scheduled content. Days shown in green may represent days when no available time slots have been filled with content. In various embodiments, other colors, patterns, or other indicators may represent degrees to which available time slots and/or available space on displays has been filled. For example, a day on a calendar may be shown in a first shade of yellow if more than half the time slots have been filled with scheduled content, but may be shown in a second shade of yellow if less than half the time slots have been filled.

In some embodiments, a timeline may show a bar that stretches over time slots when content has been scheduled. If all available time slots within a given time period have been filled, then the bar may stretch continuously to span the entire time period. However, if content is not scheduled for certain times, then there may be breaks or gaps in the bar at those times.

In some embodiments, two or more parallel bars shown on a timeline may represent different regions of a screen. For example, if a first region has had all its time slots scheduled for a given period of time, then the bar representing the first region may be continuous over the time period. However, if a second region has had only some of its time slots scheduled for the given period, then the bar representing the second region may be broken over the same period. As will be appreciated, there may be any number of parallel bars, with each bar representing a different region.

In some embodiments, bars may be shown for more than one display. For example, three displays may be represented on a timeline using three parallel bars. As will be appreciated, any number of displays may be represented in this fashion with a corresponding number of parallel bars.

Though bars have been described with respect to some embodiments, it will be appreciated that different representations may be used relating to the degree to which time slots or space on displays has been filled. For example, a dial may have an indicator varying from 0% to 100% to show the percentage of time slots of a given time period (e.g., of a given hour; e.g., of a given day) that have been filled.

In some embodiments, various statistics may be shown on a calendar or timeline view. Such statistics may be shown in conjunction with indicators (e.g., bars) about which time slots have been filled with scheduled content. Statistics shown may include: (a) foot traffic (e.g., anticipated foot traffic near a given display at a given time of day); (b) predicted weather; (c) scheduled events (e.g., sports games; e.g., conventions; e.g., sales at a nearby retail store); and/or various other data.

### Two Regions Play Content for the Same Period of Time

In some embodiments, a user may create a layout with two regions. The user may create a first playlist that is formed from one or more items of content. The user may create a second playlist that is formed from one or more items of content. The user may designate that the first playlist will play in the first region and the second playlist will play in the second region. For example, the user may drag a representation of the first playlist (e.g., an icon) into the first region and a representation of the second playlist into the second region. In some embodiments, the second playlist will have a shorter total playing time than the first playlist. Thus, for example, if both playlists where to begin playing at the same time, the second region would potentially be left blank after the second playlist had finished playing, and while the first playlist was still playing.

In various embodiments, if two regions are matched to (or otherwise correspond to) playlists of different total run times, then a user may be alerted as to the unequal play times. For example, the user's computer screen may print a warning that the region with the shorter playlist may be left blank for some period of time. In some embodiments, a representation of the second region may be shown in a different color or pattern. The user may be alerted in various other ways, such as through a tone, a flashing background in a representation of a region (e.g., of the second region), or in some other fashion.

In some embodiments, steps may be taken to equalize the playing time of the content to be played in each of two regions, or to otherwise fill empty time slots. In some embodiments, a portion of the content from the second playlist may be repeated after the second playlist has completed one run through. For example, the first two items of content in the second playlist may be scheduled for play in the second region once the second playlist has finished playing. Thus, the first two items of content in the second playlist may be played twice, whereas all other items of content forming the second playlist may be played once. In some embodiments, other items of content from the second playlist may be repeated, not necessarily the first or earliest items of content. In some embodiments, once the second playlist finishes, the second playlist may be started over from the beginning and played until the first playlist has finished playing. In some embodiments, e.g., if the second playlist is much shorter than the first playlist, the second playlist may be repeated multiple times while the first playlist plays.

In some embodiments, default content may be scheduled after the conclusion of the second playlist. Default content may include content that has been supplied by an advertiser or other content provider who is receiving preferential rates in view of filling excess or waste time that no one else has purchased. Default content may include content that has been supplied by the signage system owner or operator, e.g., to promote the system.

In some embodiments, other content may be scheduled to play after the second playlist has finished playing. For example, content not already used to form the second playlist may be scheduled to play after the second playlist has finished playing in the second region. In some embodiments, the user may be prompted to select additional content to schedule after the second playlist. In some embodiments, additional content may be supplied or inserted automatically.

In some embodiments, content in the second playlist may be extended or its content altered so that the second playlist more closely matches the first playlist in total playing time (e.g., so the second playlist becomes equal in playing time to the first playlist). In some embodiments, the rates of play of one or more items of content forming the second playlist may be reduced. For example, a video may be put into slow motion, or into slightly slower motion than the rate at which it was originally intended to play. In some embodiments, a still frame or image that had been scheduled to show for a first amount of time (e.g., for five seconds) may be rescheduled to show for a second amount of time (e.g., for 10 seconds). In this way, the duration of the second playlist may be extended.

In some embodiments, the first playlist may be shortened or otherwise altered so that the first playlist more closely matches the second in total playing time. In some embodiments, still images may be played for a shorter period of time. In some embodiments, the rates of play of certain content within the first playlist may be sped up (e.g., certain frames may be omitted).

In some embodiments, a timeline or calendar view may distinguish between content that has been scheduled by a user, and content that has been inserted into a schedule (e.g., automatically inserted into a schedule). The content that has been inserted into the schedule may have been inserted so that the schedules for the first and second regions matched. As an example, content that has been scheduled by a user may be represented by a first colored bar, and content that has been automatically filled in may be represented by a second colored bar.

Statistics about Current System Operations

In various embodiments, an administrator, an operator, an owner, or other user of digital signage system 100 may view various statistics about the system 100. In various embodiments, the user may view information about the status of one or more displays or other devices within system 100. A user may view an indication of whether a display is working or not. A user may view an indication of the amount of bandwidth to or from a display. A user may view various other statistics or status indicators. Statistics may pertain to: (a) network settings (e.g., mac address, IP, bandwidth and throughput); (b) system status (e.g., CPU and memory usage, load average, usage as a percentage of availability of some resource, system heat); (c) disk (e.g., free space, used space, total space, smart poll/status); (d) screen (e.g., brightness, hours in operation, re-sync, poll (DNC), resolution); (e) play status (e.g., screenshot, current media file, current playlist with progress, ID screen); (f) time (e.g., NTP server, what time is it, time zone, NTP status); (g) command and control (e.g., reboot, shut-down, reset to factory); (h) notes. The user may view information about the system via a computer or other device (e.g., computer 152), including a device connected to server 104.

### 1. BUYING AND SELLING OF SPACE ON THE DIGITAL SIGNAGE SYSTEM.

According to some embodiments, opportunities to have content featured on digital signage system 100, or on any other digital signage system, or on any other system, may be bought and sold. The opportunity to have content featured may be referred to herein as “space”, “advertising space”, “content space”, “time slot”, “content slot”, or the like. Thus, for example, “space” on a digital signage system may be bought and sold. A seller may include an owner or operator of system 100. A buyer may include an advertiser that wishes for its content to be displayed on system 100. A buyer may include any other content provider as well, including a government agency, a non-profit organization, an individual seeking to wish “happy birthday” to another, or any other person. In various embodiments, once bought, opportunities to have content featured may be resold. Thus, for example, a buyer of content space may in turn resell the same content space to another buyer. It is thus possible that a seller of content space does not own the physical displays or the physical signage system where advertising or other content will eventually be featured. The seller may simply be a speculator, for example, who seeks to earn profits by buying advertising space at a low price and selling it at a higher price.
1.1. NATURE OF THE SPACE. The nature of content space that is bought and sold may vary along one or more dimensions. In various embodiments, content space may be denominated using various units of measurement.
   1.1.1. TIME. Content space may be denominated in units of time. Content space may be denominated in terms of seconds, minutes, hours, etc. For example, 10 hours worth of content space may be bought or sold. In various embodiments, a time denomination may represent a total amount of time during which content will be featured. For example, an advertiser who buys 10 hours worth of content space may have its advertisement featured for a total of 10 hours of play time. In some embodiments, a time denomination may represent an amount of time per display, per geographic region, per play cycle (e.g., per hour), and/or per some other unit. For example, an advertiser may purchase 5 minutes of content space per screen across a digital signage system of 100 screens. This may mean that the advertiser's content will actually be played for a total of 500 minutes (e.g., for 5 minutes on each of the 100 screens). As another example, an advertiser may purchase 30 seconds in a “cycle” of content that is 1 hour long. Thus, the advertiser's advertisement may play for 30 seconds every hour on a particular display.
   1.1.2. DISPLAYS. Content space may be denominated in terms of a number of displays, a number of screens, or a number other devices for presenting content. For example, an advertiser may purchase space on 1000 displays.
      1.1.2.1. FRACTIONS OF A SCREEN. In some embodiments, content space may be denominated in terms of fractions of a screen. Note that, in various embodiments, a display may be divided into two or more parts, and separate items of content may be shown on each part. Thus, in various embodiments, an advertiser (or other party) may purchase half screens, quarter screens, eighth screens, or any other fraction of a screen. For example, an advertiser may purchase 30 seconds on 2000 quarter screens. This may allow the advertiser an opportunity to present its ad for a total of 30 seconds on each of 2000 displays, where the ad would occupy a quarter of the screen area on each display when presented. In various embodiments, content space may be denominated in pixels, square inches, square centimeters, in terms of diagonal inches (e.g., in terms of the length of the diagonal across the screen area where the ad would be presented), or in terms of any other unit.
   1.1.3. VENUES. In various embodiments, content space may be denominated in terms of venues. For example, an advertiser may purchase ad space for 50 venues. The advertiser may thereby obtain the right to show ads for a certain amount of time (e.g., 5 minutes total), in each of 50 venues. In various embodiments, a given venue may include a restaurant, retail store, mall, a particular geographic location, or any other place, area, or location. A venue may include one or more displays.
   1.1.4. SIMULTANEOUS DENOMINATION. In various embodiments, content space may be simultaneously denominated in terms of several units. For example, content space may be denominated in terms of time and number of screens. For example, an advertiser may purchase 5 minutes per screen on each of 200 screens.
1.2. THE FORUM. In various embodiments, buyers and sellers of content space may come together in a market, exchange, or other area for transacting and/or for otherwise bringing together buyers and sellers. The forum may by a physical location, such as a building, a trading floor, an exchange pit, or any other physical location. The location may also be a virtual or electronic location. The market may consist of one or more interconnected computers, servers, and/or other devices that allow buyers, sellers, and/or intermediaries to communicate with one another and to transact business. An exchange or other forum may be owned and/or operated by a distinct entity, such as a business entity, a government entity, a non-profit entity, or any other entity.
1.3. APPROVAL PROCESS FOR CONTENT. In various embodiments, displays of digital signage system 100, or of any other system, may be located in a public venue, a retail venue, or a venue otherwise exposed to various people. Owners, operators, or other stakeholders in the venue may have interest in maintaining standards of decency, propriety, morality, etc., in the content that is presented within the venue. For example, an owner of a retail store that hosts displays may not wish for the displays to present vulgar content, as such content may offend customers. According to various embodiments, there may be a process for ensuring that content shown on a digital signage network conforms to one or more standards.
   1.3.1. STANDARDS. In various embodiments, one or more standards are set forth for content. Standards may be set by a seller of content space, by a digital signage network owner or operator, by a host of a one or more displays on a digital signage network (e.g., by an owner of a store that hosts a display), by a standards body, by an exchange or other forum for buying and selling content space, by a government, by a governing body, or by any other entity. Standards may include an indication of forbidden words; an indication of forbidden topics (e.g., politics); an indication of forbidden products; an indication of dress standards (e.g., characters featured in content must dress or not dress in certain ways); and/or an indication of any other standards.
      1.3.1.1. SETS OF STANDARDS. In various embodiments, there may exist different sets of standards. Two or more sets of standards may vary in the degree to which they permit or proscribe content of a certain nature. For example, a first set of standards may forbid all vulgar language (e.g., all words from a certain list that is considered to include vulgar words), and a second set of standards may permit some words (but not necessarily all words) that are considered vulgar. Two different sets of standards may be given different names or short hands, such as “G” or “PG” or the like. Standards may also vary along different dimensions. For example, a first set of standards may describe the standards content must adhere to in order to be politically neutral. A second set of standards may describe the standards content must adhere to so as to be suitable for viewing by a general audience (e.g., by children). In various embodiments, a given item of content may be required to adhere one set of standards, to two sets of standards, or to any number of sets of standards, all at the same time.
   1.3.2. APPROVAL PROCESS. In various embodiments, content that is submitted to be played on a digital signage system goes through an approval process before it is played or otherwise featured. The approval process may be used to verify or ensure that the content meets one or more sets of standards.
      1.3.2.1. WHO APPROVES.
         1.3.2.1.1. EXCHANGE. In various embodiments, an exchange or other market for buyers and sellers may approve content. The exchange may have a designated committee, body, or other group that deals with the approval of content.
         1.3.2.1.2. DIGITAL SIGNAGE NETWORK HOST. In various embodiments, a host of a digital signage system, or of part of a digital signage system, or of one or more displays of a digital signage system, may approve content. The host may include a business or other location, which may stand to suffer a damaged reputation if inappropriate content is presented within its establishment. Thus, the host may have an interest in approving content.
         1.3.2.1.3. DIGITAL SIGNAGE NETWORK OPERATOR. In various embodiments, the owner, operator, and/or manager of a digital signage system may approve content submitted to be played on the digital signage system. The owner may risk damaged reputation if inappropriate content is shown on its network.
         1.3.2.1.4. THIRD PARTY. In various embodiments, a third party may approve content to be shown on a digital signage system. The third party may include a separate business entity, a standards body, or any other entity. The third party may be paid to approve content for display.
      1.3.2.2. SUBMISSION OF A TRANSCRIPT. In various embodiments, a provider of content, or any other entity, may be required to submit a written transcript of the content. The written transcript may aid with the review process. Using the written transcript, a reviewer may search for prohibited words or phrases. A reviewer may search for prohibited topics, such as politics, religion, or any other issue. A transcript may include, in some embodiments, text or other verbiage that is to be shown visually in conjunction with content. A transcript may include a transcript of words or other utterances presented audibly as well.
      1.3.2.3. STANDARD CONTRACT. In various embodiments, a supplier of an item of content may be required to sign a contract. The contract may enumerate standards that the submitted content must meet. The contract may enumerate penalties that the supplier would suffer if the supplied content is found not to meet one or more standards or sets of standards. The contract may enumerate an adjudication, arbitration, or other process by which it will be determined whether submitted content meets one or more standards. Penalties may include fines, bans from the ability to submit further content, and so on.
      1.3.2.4. REVIEW PROCESS.
         1.3.2.4.1. ALGORITHMS. In various embodiments, algorithms (e.g., computer algorithms) may be used to review content that has been submitted. Computer algorithms may scan transcripts of submitted content for key words, phrases, or topics. The algorithm may create an alert if any prohibited works, phrases, or topics are found. Algorithms may include artificial intelligence that is capable of recognizing certain topics, certain tones, or other themes within content. In various embodiments, voice recognition or voice transcription algorithms may be used to convert audio within content to text or to other symbolic form. The text or other symbols may then be searched for particular words, phrases, topics, etc. In various embodiments, image recognition algorithms may be used to recognize potentially inappropriate images, such as images of violence, crudeness, or any other images relevant to certain standards. In various embodiments algorithms may flag an item of content for later review by humans. In some embodiments, algorithms may outright prevent certain content from being featured on digital signage system 100 due to failure to comply with one or more standards or sets of standards.
         1.3.2.4.2. REVIEWERS. In various embodiments, one or more human reviewers may review content that has been submitted to be played or featured on a digital signage system. Human reviewers may search for words, images, text, or other markers that may signify an item of content does not meet one or more standards or sets of standards. In various embodiments, human reviewers may go through training courses or tutorials for reviewing content. Different training courses may apply to different sets of standards. A reviewer may become certified in a particular set of standards, or in more than one set of standards. In various embodiments, an item of content may be shown to multiple reviewers. A certain fraction of reviewers may be required to approve of the content before it will be actually shown on a particular digital signage system (e.g., two thirds of reviewers must approve; e.g., 100% of reviewers must approve).
         1.3.2.4.2.1. VERIFYING THE REVIEWERS. In various embodiments, reviewers may be tested through the presentation to them of content that has already been reviewed by others. For example, an item of content that has already been found not to comply with certain standards may be presented to a reviewer. If the reviewer rates the content as something that does comply with the standards, then it may be inferred that the reviewer is not competently reviewing content. Content that is presented to reviewers, and which has not been reviewed before, may be periodically interspersed with content that has been reviewed before. The reviewer may never know which content has and which content has not been reviewed before. In this way, the accuracy of the reviewers work may be verified.
   1.3.3. TRUSTED PARTY. In some embodiments, a party who submits content (e.g., an advertiser) may become trusted or otherwise accepted as a party whose content can be relied upon to conform to one or more standards. Content submitted by such a party may receive less or no scrutiny. Rather, the content from the party may be trusted to conform to standards. This may save the digital signage network owner, or other parties, from having to review content.
      1.3.3.1. REGISTRATION PROCESS FOR THE TRUSTED PARTY. An advertiser or other party who becomes a trusted party may go through a process for doing so. A party may become trusted after any one or more of: (a) submitting a predetermined minimum number of content items; (b) submitting content items and achieving a certain minimum percent compliance with a set of standards (e.g., a party must achieve 100% compliance with 250 submitted content items); (c) taking a training or certification course; (d) implementing a training or certification course; (e) signing or otherwise entering into a contract; (f) agreeing to pay a penalty if the party is found to have submitted content which did not conform to standards; (g) agreeing to an arbitration clause to determine whether a given item of content satisfies a set of standards; (h) agreeing to an arbitration clause to determine the extent of damage that was inflicted by content that did not conform to a standard.
      1.3.3.2. LOGGING PROCESS TO TRACK CONTENT ORIGINS. Various parties may be interested in tracking the origins of content. For example, if an item of content is shown on a digital signage system, the system's owner may be interested in finding the originator of the content in the event that the item of content turns out not to comply with certain standards (e.g., the content turns out to be offensive). Other parties may be interested in tracking origins of content as well. For example, in order to ensure the integrity of an exchange, an owner or operator of the exchange may wish to verify that content ostensibly from a given source is in fact from that source and not from someone else pretending to be that source (e.g., from someone else trying to damage the ostensible source). In some embodiments, a party may have contact information on file, including email, phone, Web site, postal address, fax, etc. When a party submits content, a confirmation may be sent to the party's address. In some embodiments, the party must then respond and confirm that the content did originate with it. In some embodiments, the party may have the opportunity to respond (e.g., in the event that the party did not originate the content). In some embodiments, a party submitting content may apply a digital signature, digital watermark, or other confirmation that the content originated with it. For example, the party submitting content may: (1) take a sequence of bits representative of the content (e.g., a hash of all the bits in the content); (2) encrypt the sequence with the private key of the party, wherein the encryption protocol used is a public-key encryption protocol; (3) and transmit the encrypted version of the sequence to an exchange, signage network owner, or other receiving party. The fact that the submitting party's public key can be used, through the process of decryption, to arrive at the sequence may serve as verification of the identity of the party who submitted the content.
      1.3.3.3. INSURANCE, BONDING. In some embodiments, a provider of content (e.g., advertising content), or any other party, may purchase or otherwise obtain insurance. The insurance may insure the content provider against liability in the event that the content is found to violate a set of standards. In some embodiments, other parties may purchase insurance. For example, an exchange owner may purchase insurance that insures the exchange against liability in the event that content bought or sold on the exchange violates one or more sets of standards.
1.4. RATING AGENCIES. In some embodiments, an entity (e.g., a corporation; e.g., a government organization) may provide a rating to a digital signage system. A rating may summarize a state of a digital signage system. The rating may incorporate such factors as the reliability of the system, the downtime of the system, the average downtime of displays on the system, the quality of the displays, the resolution of the displays, the age of the displays, the impact of content shown on the displays (e.g., the percent of customers who recall information presented on the displays), the number of viewers of one or more displays in the network, the environment of the displays (e.g., the ambient noise level, e.g., the presence of potential distractions), the number of competing displays (e.g., the number or presence of other displays that could compete for viewers' attention), the quality of content on the displays (e.g., the quality of entertaining or informative content that accompanies advertisements), and any other factors. For example, each of one or more factors may be given a numerical score using tangible data (e.g., using data about system downtime), or using one or more expert evaluators. The scores may be weighted and then added, or otherwise combined. A rating may then be generated. The rating may be a numerical rating (e.g., a number between 0 and 100), a rating with stars (e.g., from 1 to 5 stars), a rating with letters (e.g., from “AAA” to “F”), or any other rating. In various embodiments, a digital signage system may receive two or more separate ratings, each rating corresponding to a different aspect or set of aspects about the system. For example, a given system may receive a rating of “A” for impact, but “C” for reliability. In various embodiments, one or more entities may become rating agencies, trusted rating agencies, or entities that are otherwise highly regarded (or regarded) for providing fair or useful ratings. In various embodiments, when content space is bought or sold, the rating of the content space (e.g., the rating of the digital signage system on which the space is being sold) may be specifically indicated. For example, a seller may sell 1000 hours of content space on a “B” rated digital signage system. Content space on a “B” system may generally sell for less than does content space on an “A” system. When a buyer of content space has bought space of a particular rating, the buyer may thereby obtain the right to show content on a system of the given rating. In some embodiments, the buyer may obtain the right to show content on a system of the given rating or higher.
1.5. SUCCESS RATE. In some embodiments, a buyer and seller of content space may indicate a success rate. The success rate may measure the percentage of time that content scheduled to play on a digital signage system actually does play on the digital signage system. For instance, though content may be scheduled to play, a network outage, a display malfunction, or some other event may prevent content from actually playing. Example success rates may include 90%, 95%, 99%, or other possible success rates. For example, in some embodiments, if a buyer purchases 1000 hours of content space with a 95% success rate, then the buyer may expect its content to play for at least 950 hours on the digital signage system. In some embodiments, the buyer may receive a report indicating the actual play time of its content.

### Capture Someone's Face and do Transition Effects on it

In some embodiments, a camera associated with system 100 may capture an image or video of a person. A display may then show the image or video of the person. In some embodiments, transition effects may be added to the image or video. For example, the person may be shown fading in or fading out. The image of the person may be made to appear filled with ripples, like the surface of a pond. In some embodiments, alterations to a viewer's face may be added. For example, a mustache or beard may be added. Fangs may be added, e.g., in keeping with a Halloween theme. The effects that are added to a person's image may provide entertainment to the person and his/her friends.

The following are embodiments, not claims:

A. A contract for the use of display screens comprising:
a specification of a screen size;
a specification of standards that make content permissible;
a specification of a deadline by which an item of content must be supplied;
a specification of a destination to which the item of content must be supplied; and
a specification of a first time period within which the item of content is to be played.
   B. The contract of embodiment A further comprising a specification of an amount of time.
   C. The contract of embodiment B in which the amount of time is an amount of time per screen.
   D. The contract of embodiment B in which the amount of time is a total amount of time.
   E. The contract of embodiment A further comprising a specification of a number of screens.
   F. The contract of embodiment A further comprising a specification of a number of impressions.
   G. The contract of embodiment A further comprising a specification of a number of impressions from people of a predetermined demographic.
   H. The contract of embodiment A further comprising a specification of a number of times the item of content will be played.
   I. The contract of embodiment A in which a specification of screen size includes a specification of a measure, in inches, of the diagonal of the screen.
   J. The contract of embodiment A in which standards that make content permissible include standards that forbid political opinions.
   K. The contract of embodiment A further comprising a specification of a penalty for supplying content that does not comply with the standards.
   L. The contract of embodiment A further comprising a specification of a geographic region in which the content will play.
   M. The contract of embodiment A further comprising a specification of an area per screen that the item of content will occupy.
   N. The contract of embodiment M in which the screen area is one quarter of a screen.
   O. The contract of embodiment A further comprising a specification of a percentage of time that the item of content must play successfully.
   P. The contract of embodiment A further comprising a specification of a mechanism by which the playing of the item of content will be proven.
   Q. The contract of embodiment A further comprising a specification of a quality rating for a system of displays on which the item of content will be played.
   R. The contract of embodiment A, in which the contract comprises a security.
   S. The contract of embodiment A further comprising a specification of a category of product that the item of content must feature.
   T. A method for scheduling comprising:
determining a first category for a first item of content;
determining a second category for a second item of content;
scheduling the first item of content to play in a first region of a display at a first time;
determining whether the second category is the same as the first category; and
scheduling the second item of content to play in a second region of the display at the first time only if the second category is not the same as the first category.

The following are embodiments, not claims:

A. A method comprising:
determining data associated with a first item of content;
determining a first time when the first item of content is scheduled to play in a first region of a display;
determining a criterion associated with a second item of content;
determining, based on the data, that the first item of content satisfies the criterion;
determining a second time based on the first time; and
scheduling the second item of content to play in a second region of the display at the second time.
   B. The method of embodiment A in which the first item of content is a video featuring a news segment, and the second item of content is a video featuring an advertisement.
   C. The method of embodiment A in which the data associated with the first item of content is a set of keywords that are descriptive of the first item of content.
   D. The method of embodiment C in which the criterion specifies a word and in which determining that the first item of content satisfies the criterion includes determining that the set of keywords includes the word.
   E. The method of embodiment A in which determining a first time includes determining a time in the future.
   F. The method of embodiment A in which determining a second time includes determining a second time that is the same as the first time.
   G. The method of embodiment A in which determining a second time includes determining a second time that is before the first time.
   H. The method of embodiment A in which determining a second time includes determining a second time that is after the first time.
   hh. The method of embodiment A in which data associated with the first item of content includes a closed captioning feed, in which the criterion associated with the second item of content specifies a keyword, and in which determining that the first item of content satisfies the criterion includes determining that the keyword is contained within the closed captioning feed.
   hhh. The method of embodiment hh in which determining that the keyword is contained within the closed captioning feed includes performing a text search of the closed captioning feed.
   I. A method comprising:
playing a first item of content in a first region of a display;
playing, simultaneously to the first item of content, a second item of content in a second region of the display;
determining that a viewer is gazing towards the first region; and
enhancing the perceptibility of the first item of content.
   J. The method of embodiment I in which determining that a viewer is gazing towards the first region includes:
capturing an image of the viewer's face;
determining, based on the image, the distance of the viewer from the display;
determining, based on the image, the angle of the viewer with respect to the plane of the display; and
determining, based on the image, the direction in which the viewer's pupils are focused.
   K. The method of embodiment I in which enhancing the perceptibility of the first item of content includes:
enlarging the first region based on the determination that the viewer is gazing towards the first region; and
scaling the first item of content to fit within the newly enlarged first region.
   L. The method of embodiment K further including:
shrinking the second region; and
scaling the second item of content to fit within the newly shrunk second region.
   M. The method of embodiment I in which enhancing the perceptibility of the first item of content includes eliminating the second region.
   N. The method of embodiment I in which enhancing the perceptibility of the first item of content includes increasing the volume of audio associated with the first item of content.
   O. The method of embodiment I in which enhancing the perceptibility of the first item of content includes directing a beam of directional sound towards the viewer.
   P. The method of embodiment I in which enhancing the perceptibility of the first item of content includes changing the play rate of the first item of content.
   Q. A method comprising:
receiving an indication of a first set of content with a first total playing time;
receiving an indication of a first region of a display in which the first set of content is scheduled to play;
receiving an indication of a second set of content with a second total playing time;
receiving an indication of a second region of the display in which the second set of content is scheduled to play;
determining that the second total playing time is less than the first total playing time; and
providing an indication that the second total playing time is less than the first total playing time.
   R. The method of embodiment Q in which providing an indication includes altering the color of a representation of the second region as an indication that the second total playing time is less than the first total playing time.
   S. The method of embodiment Q further comprising:
determining a portion of the second set of content; and
scheduling the portion of the second set of content to play in the second region after the second set of content has played.
   T. The method of embodiment Q further comprising:
determining a third set of content; and
scheduling the third set of content to play in the second region after the second set of content has played.
   U. The method of embodiment Q further comprising increasing the total playing time of the second set of content.

### Chalkboard Screen

In various embodiments, a screen may simulate a chalkboard or other medium for writing. For example, a screen may serve as a digital menu board. A restaurant employee or manager may write menu items, prices, specials, etc., on the digital menu board as if he were writing on a chalk board. The screen may be touch sensitive or may be sensitive to a writing implement, such as an electronic piece of chalk, an electronic pen, an electronic pencil, or other electronic writing utensil, or any other writing implement. As will be appreciated, the writing implement or utensil need not be electronic, but may be made of any material. The material may be a material that is recognizable so as to create an input that can be translated, e.g., into a written word, a graphic or other item, such as an item to be displayed on the screen. A writing implement may include a pointed piece of plastic, a wand, or a finger, in various embodiments.

A screen may employ various technologies to register touch or contact, as will be appreciated. Exemplary technologies include resistive, surface acoustic wave, capacitive, surface capacitive, projected capacitive, infrared, strain gauge, optical image, dispersive signal technology, and acoustic pulse recognition. Following a touch or contact, a controller may register the touch and provide information about the touch to the processor or other circuit controlling the display. This process may occur via a software driver (e.g., the Windows 7 Touch Screen Driver; e.g., Evtouch).

In various embodiments, inputs from the user's writing implement may be detected (e.g., via a touch sensitive screen overlay), translated into electronic encoding, and stored. The inputs may be stored, for example, as a X-Y coordinates, as a number representing an applied pressure, as a three numbers representing a color (e.g., numbers representing each of red, green, and blue), as numbers representing a hue, saturation, contrast, blurring, or as any other representation of the user's input. In various embodiments, a representation of the user's input may be stored as a file, such as a bitmap file, a jpeg file, a gif file, or any other file.

Once a restaurant employee or other person has written or marked on a digital screen, the writing may be displayed on the screen. The writing may reflect the person's method of input, including the trajectory of the writing implement, the pressure applied, the speed of the writing, or any other manner of input. For example, the writing may be thicker if more pressure has been applied, and thinner if less pressure has been applied.

A person may have the opportunity to customize, stylize or alter the writing in various ways. For example, the person may select a color and apply the color to his writing or markings. For example, if the person picks the color green (e.g., from a color picker or color palette), then the person's writings may be made to appear as if from green chalk.

A representation of the user's input may be displayed on a screen. In some embodiments, a user may make his inputs (e.g., may write) on a given screen, and a representation of the user's inputs may be displayed on that same screen. In some embodiments, a user may make inputs on a first screen, and a representation of those inputs (e.g., an electronic encoding of those inputs) may be transmitted to a second screen for display. Thus, for example, a user may make markings on a single screen and have such markings transmitted to each of three additional screens (e.g., of a 3-panel menu board; e.g., of a 4-panel menu board).

For example, a user may interact with a first screen that represents a workstation (e.g., a workstation for restaurant employees). The person may make writings on the screen using an electronic pen. The person may then select a second screen that is hanging from the ceiling (e.g., a screen being used as a menu board). Once the user has selected the second screen, the writings made by the user on the first screen may be transmitted to the second screen. The writings may then be displayed on the second screen. The transmission may occur via a network, such as a local area network, wide area network, the Internet, wireless network, or via any other network, or via any other mode of transmission.

Thus, in various embodiments, the first screen may act as a dashboard, command center, and/or user interface that is visible only to store managers or employees, while the second screen may represent a menu, sign, or other type of display that is intended for patrons, guests, and/or customers.

In some embodiments, after the writings have been transmitted to the second screen, the user may clear the first screen of writings (e.g., by pressing or selecting a button on the first screen, by pressing an appropriate key combination on a keyboard, or through any other means). The user may then create new writings on the first screen, and then have the new writings transmitted to a third screen. The third screen may represent part of the same menu board as the second screen. For example, the second screen and the third screen may comprise two panels of the same menu board. As will be appreciated, the first screen may be used to create writings, markings, images, etc., for any number of additional screens.

Articulated Arm with Screen

In various embodiments, a given screen may function both as a workstation and/or input terminal, and as a display meant for customers, patrons, and so on. In some embodiments, a user (e.g., a restaurant employee) may make markings on a screen. The screen may display a representation of such markings. The screen may then be positioned to be more visible to patrons and customers. For instance, the user may position the screen at his own chest level in order to make markings on the screen. But once a representation of such markings has been displayed on the screen, the screen may be raised to a level above the user's head so as to be more visible to customers.

In various embodiments, a screen may be mounted or attached to an arm (e.g., to a metal arm). For example, one end of the arm may be affixed to the back of the screen using bolts, screws, etc. The arm may include one or more joints at which the arm can bend to various degrees. The arm may also be affixed to a ceiling, wall stand, or other structure. Thus, for example, the arm may be attached at one end to the screen and at its other end to a wall. The joint or joints of the arm may include considerable mechanical resistance, which may be achieved in a variety of ways, as will be appreciated (e.g., via friction pads). Thus, in various embodiments, the joint or joints of the arm may maintain their angle(s) even while bearing the weight of the screen. Additionally, the joint or joints may include pins to fix the angle, or other means to fix the angle, as will be appreciated.

In various embodiments, an operator or user of the screen may alternately pull the screen (thereby extending the arm, for example), or push the screen (thereby retracting the arm, for example). The joints may allow bending, for example, only with the added force provided by a human. When the user pushes the screen, the user may push the screen towards a wall, ceiling, or other anchor point for the screen. At this point, the screen may be in a position designed for high or optimal visibility. When the user pulls the screen, the user may bring the screen down, or otherwise towards the user to enable the user to interact with the screen. The user may then create text, graphics, effects or other items for display on the screen. For example, the user may use a stylus to “write” on the screen as if he were using a chalk board. Once the user has finished interacting with the screen, the user may push the screen back to its position of heightened visibility.

In various embodiments, a screen may be attached to a ceiling via an articulating arm. In various embodiments, a screen may be attached high on a wall via an articulating arm. The screen may serve as a digital menu board. When the screen is pushed close to the ceiling or wall (e.g., when the arm is in a folded state), the screen may serve as a digital menu visible to customers. On the other hand, when the arm is extended, a restaurant manager or employee may have the opportunity to touch and interact with the screen and to thereby make changes to the screen.

In various embodiments, a screen may be attached to a wall or other structure using a telescoping arm or using any other extendable or retractable arm. In various embodiments, a screen may be attached to a wall or other structure using more than one arm.

In various embodiments, a screen may be locked in place. For example, when a screen is pushed close to a wall, ceiling, or other structure (e.g., when the arm supporting the screen is in a folded or retracted state), the screen may be locked in place. The screen may be locked, for example, using a pin. The pin may fit into a hole on a fixture attached to the screen, and it may also fit into a hole on a fixture attached to the wall or other structure. If the pin is rigid, for example, the pin may thereby lock the screen to the wall or other fixture, as will be appreciated. Locking the screen in place may reduce the possibility that the arm holding the screen will extend on its own under the screen's weight. As will be appreciated, various other means may be used to lock the screen in place. For example, a hook attached to the screen may fit into a metallic loop attached to the wall. Or, a hook attached to the wall may fit into a metallic loop attached to the screen. Multiple hooks, pins, or other locking or fixing means may be used, as will be appreciated.

In various embodiments, a screen may be supported by an arm or other support structure that is jointed or otherwise capable of allowing the screen to tilt, or rotate about one or more axis. For example, the screen may be tilted up or down or side to side. As another example, the screen may be rotated as to its orientation, and may, for instance, be switched from portrait to landscape view, or vice versa. A support structure allowing a screen to title is described in U.S. Pat. No. 5,938,163, entitled “Articulating Touchscreen Interface”, the entirety of which is incorporated by reference herein for all purposes.

In various embodiments, a screen may include a processor, such as a processor in the Intel Pentium series, an Athlon processor, an Arm processor, or any other processor. The screen may further include a graphics processing unit (GPU). The screen may further include a memory, which may include flash memory, disk-based memory, magnetic memory, optical memory, holographic memory, or any other form of memory.

The screen may store (e.g., in memory), various templates, effects, graphics, and/or algorithms for creating the appearance of chalk markings. For example, the screen may store an algorithm for translating a stroke detected on the contact-sensitive portion (e.g., the touch portion), into a stroke that appears to have been made by a piece of chalk on a blackboard. In various embodiments, the appearance of a chalk marking may be created by (1) detecting the trajectory of a stroke or marking made on a contact sensitive portion of a screen; (2) adding or defining a predetermined thickness to the trajectory (e.g., 3 millimeters); (3) applying a filter to create noise (e.g., an “add noise” filter in Adobe Photoshop); and (4) applying a filter to add blur (e.g., applying a Gaussian blur with radius of, for instance, 0.4 in Adobe Photoshop). In some embodiments, an “add noise” filter, or other filter, may create extraneous points, pixels, markings, or the like that are within a predetermined distance of the originally detected stroke. The points may be added according to some probability distribution, such as according to a bell curve (Gaussian), or according to a uniform probability distribution, or according to any other distribution, as will be appreciated. In some embodiments, applying a blurring filter may take existing points, pixels, and/or, markings, or collections of points, pixels, and/or markings, and may spread or smear these out using some mathematical function. For example, a single pixel may be smeared by applying a Gaussian function, such that the color, brightness, and/or other attributes of the pixel are copied to some degree to surrounding pixels, but to a lesser and lesser degree as the distance from the original pixel increases. In some embodiments, an image or other stored marking may be blurred via convolution with a mathematical function, such as with a Gaussian function. An image may be blurred via filtering in the frequency domain as well, as will be appreciated. As will be appreciated, according to various embodiments, other methods may be used for generating the appearance of chalk markings.

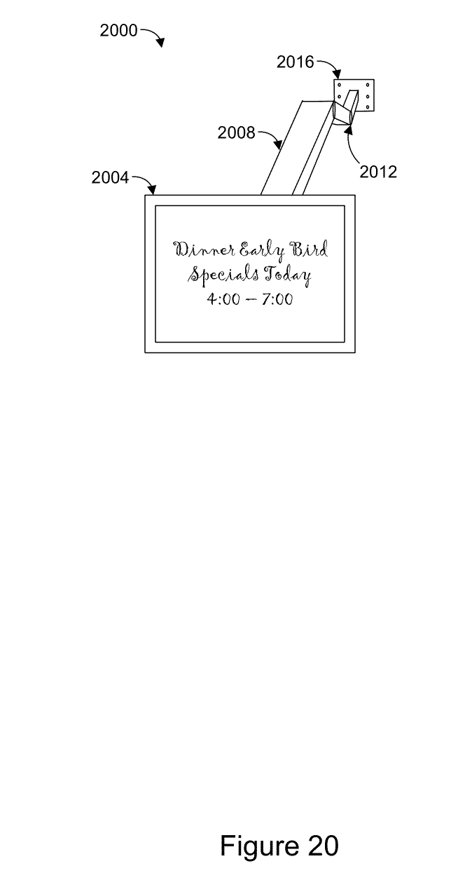

FIG. 20 shows an illustrative display 2000 according to various embodiments. A display screen 2004 is supported by an arm 2008. The arm may be attached to the back of the display screen via screws, bolts, welds, glue, or via any other means. The arm may include one or more joints (e.g., joint 2012), and/or one or more bendable or flexible portions. The arm may, in turn, be attached or affixed to a wall, ceiling or other structure.

For example, attachment plate 2016 may be affixed to a wall via one or more screws, and may in turn support the arm. FIG. 20 illustrates arm 2008 in a somewhat extended state. However, it will be appreciated that the arm could be in a more folded state, in which case display screen 2004 would be closer to attachment plate 2016. FIG. 20 illustrates exemplary writings on display screen 2004, according to some embodiments, where such writings may be designed to mimic the appearance of chalk markings.

The following are embodiments, not claims:

A. An apparatus comprising:
an electronic display with a contact-sensitive portion;
an arm attached to the display, in which the arm can take at least two configurations; and
a processor, the processor operable to:
   receive an indication of a first contact with the contact-sensitive portion;
   determine a first visual representation based on the first contact, in which the first visual representation simulates the marking of chalk on a chalkboard; and
   cause the electronic display to output the first visual representation.

The configurations of the arm, for example, may include a first configuration where the arm is bent at a joint, and a second configuration where the arm is not bent at the joint. In some embodiments, the configurations of the arm may include a first configuration where the arm is telescoped fully, and a second configuration where the arm is not telescoped fully. In some embodiments, the configurations of the arm may include a first configuration where a joint of the arm tilts the screen in a first direction, and a second configuration where the joint of the arm tilts the screen in a second direction. Also, it will be appreciated that the processor may include a generic processor, a graphic processing unit, an electronic circuit, a logic device, a combination of a generic processor and a graphics processing unit, or any combination of the aforementioned.

B. The apparatus of embodiment A in which the electronic display is a liquid crystal display screen, in which the contact-sensitive portion includes an overlay using capacitive technology, and in which the arm is bendable about a joint.
C. The apparatus of embodiment A in which, in order to determine the first visual representation, the processor is operable to:
determine a first trajectory of the first contact based on the received indication of the first contact;
apply a noise filter to the first trajectory; and
apply a blurring filter to the first trajectory.
   D. The apparatus of embodiment C, in which the processor is further operable to:
receive an indication of a second contact with the contact-sensitive portion;
determine a color based on the second contact;
determine a second visual representation by applying the color to the first visual representation; and
cause the electronic display to output the second visual representation.

For example, a user may make a marking on the display, and may then select from a color menu or palette on the display in order to apply a different color the markings. The user may interact with the color menu or palette in the upper left corner of the display, or in some other portion of the display. In some embodiments, the user may activate the color palette or some other menu or selection area by interacting with the display in a particular way. For example, a menu may come up when the user taps the display twice or when the user makes a specialized marking, for example. Otherwise, in various embodiments, user contact with the display may be interpreted as images or graphics that are being created by the user.

E. The apparatus of embodiment C, in which the processor is further operable to:
receive an indication of a second contact with the contact-sensitive portion;
determine a selection of a first time in the future based on the second contact;
determine when the current time matches the first time; and
cause the electronic display to output the first visual representation only when the current time matches the first time.

In various embodiments, a user may interact with the display in order to schedule when content will actually be displayed. For example, the user may create a dinner menu, with the intention that the menu be displayed during dinner time. Accordingly, the user may schedule the menu to be displayed at 6:00 PM in the afternoon, but not before. Thus, for example, a user may write up the dinner specials on the display. The user may then interact with a scheduler or other selection area on the display in order to schedule a time when the dinner menu will be displayed.

### Fantasy Sports

Fantasy sports may include competitions where a person can assemble their own virtual sports teams consisting of various athletes (e.g., professional athletes) from one or more actual teams (e.g., professional teams). For instance, a person may select real football players from each of several different real professional football teams, so as to assemble a virtual fantasy team. The competitiveness of the person's fantasy team may then be assessed based on the statistics of its component players. For example, a person's fantasy team may earn points based on yards gained, touchdowns scored, tackles made, interceptions made, sacks made, etc., by its component players.

Fantasy sports teams may be assembled based on various sports. Exemplary sports include football, baseball, basketball, hockey, and soccer. It will be appreciated that fantasy sports may be based on any suitable sport or based on any suitable activity whether or not it is strictly considered a sport (e.g., competitions may be based on the success of politicians, the success of actors, etc.). It will be appreciated that fantasy sports may be based on any skill level of real competitor, not just professional athletes. For example, fantasy sports may be based on college athletes, high school athletes, intramural players, recreational players, etc.

In various embodiments, a person involved in a fantasy sports competition may compete under the auspices of a service. The service may interface with competitors via a web site and web server, for example. The service may perform a number of functions, including: receiving competition fees, receiving a selection of athletes for a fantasy team roster, compiling statistics about a fantasy team, updating a score for a fantasy team, providing feedback to a competitor about his team, providing news alerts to a competitor about the players in the competitor's fantasy team, determining a final standing of competitors in a fantasy sports competition, awarding prize money to competitors in a fantasy sports competition. The service may interact with a competitor through its website, through sending emails to the competitor, through sending text messages to the competitor, through sending images or videos to the competitor, or through any other means.

In various embodiments, a digital sign may provide information about a fantasy sports competition. Information may include athlete statistics, recent athlete statistics (e.g., recent touchdowns, recent homeruns scored), replays of key plays (e.g., key downs, e.g., downs that affect an athlete's fantasy sports statistics), video footage, images (e.g., images of athletes), standings in a competition, time remaining in a competition, games remaining in a competition, names of competitors in a competition, names of fantasy teams, names of fantasy leagues, indications of where to receive additional information (e.g., uniform resource locators for a website of a service that runs fantasy sports competitions), and any other information.

In various embodiments, a digital sign may include advertisements. Advertisements may advertise products of a competition's sponsors. For example, a fantasy sports competition may be sponsored by a soft drink company. In turn, the soft drink company may have the privilege of placing advertisements on a digital sign in conjunction with fantasy sports information.

In various embodiments, a competitor in a fantasy sports competition may trigger the display of fantasy sports information on a digital sign. For example, the competitor may trigger the digital sign to display information about the competitor's fantasy sports team. The sign may thereupon show, for example, a list of athletes in the competitor's fantasy sports team, together with individual athlete's statistics, and aggregate statistics for the entire fantasy sports team.

A competitor may trigger a sign in various ways. In some embodiments, a sign may be enabled with near field communication (NFC) technology. A competitor may have his own device (e.g., a mobile device) that also is fitted with NFC technology. The competitor may bring his own device in proximity to the digital sign in order to trigger it. The competitor's device may provide an indication or an identifier for the competitor or for the competitor's team. The digital sign may receive the indication or identifier, and then determine what information to display. In some embodiments, the digital sign may communicate received information from the competitor to a central server or other remote server or device. Such server or device may represent a service that operates a fantasy sports competition. The service may look up information provided by the player, and determine appropriate information to show in response. For example, the service may look up what athletes are in the competitor's fantasy team roster. The service may then look up the latest statistics corresponding to such athletes. The service may then communication pertinent information for display back to the digital sign. The service may also provide a command or directive to the digital sign as to what to display.

Having determined what information to display, the digital sign may display such information. In various embodiments, information that may be displayed for a competitor may include: current standings of the player's fantasy sports team or teams; statistics for the competitor's roster of athletes; statistics for the player's team or teams; amount of money the competitor has at stake; amount of money the competitor stands to win; names of fantasy sports teams that are ahead of the competitor's team or teams; names of fantasy sports teams that are behind the competitor's team or teams; video footage of athletes on the competitor's roster; images of athletes on the competitors' roster; indications of upcoming games (e.g., real games) of possible interest to the competitor (e.g., games in which the competitor's athletes will compete; indications of upcoming fantasy sports competitions; information about a competitor's friend's fantasy sports team; and any other information.

In various embodiments, a digital sign may show advertisements and/or advertising information that are tailored to a competitor, to information about the competitor, and/or to information about how the competitor's fantasy sports team is faring. In some embodiments, an advertisement may offer sports memorabilia that include jerseys worn by athletes on the competitors' fantasy sports team roster.

In some embodiments, different advertisements may be triggered based on the performance of a competitor's fantasy sports team and/or based on the standings of the competitor in a fantasy sports competition. For example, if the competitor's team has done well, and the competitor has a good chance of winning money, then an advertisement for an expensive or luxury product may be shown (e.g., an advertisement for a vacation). If a competitor's team is doing poorly, then an advertisement for a comforting product may be shown (e.g., an advertisement for a chocolate beverage).

In various embodiments, various means may be used to trigger the display of information on a digital sign. A digital sign may sense a user device using Bluetooth technology, RFID technology, infrared, or any other communication or proximity technology. In various embodiments, a digital sign may detect cellular signals emitted by a user device. In various embodiments, a user device may determine its own location (e.g., via GPS) and transmit this location to a server (e.g., to a server operated by a service that runs fantasy sports competitions). The server may, in turn, determine whether the user is in proximity to any known digital signs, and, if so, may cause such signs to display information for the user.

In various embodiments, a digital sign may recognize some biometric or other signature of the user. For example, the digital sign may comprise a camera that captures an image of the user. The digital sign may determine, based on the image, the identity of the user (e.g., using facial recognition technology). The digital sign may then display information relevant to the user. In various embodiments, a digital sign may detect the presence of a user via heat, vibration, voice recognition, fingerprint, or via any other means.

In some embodiments, a user may present to a digital sign (e.g., to a camera associated with a digital sign) a code, barcode, two-dimensional barcode, or any other indicator. The indicator may be associated with the user, and may thereby allow the sign to identify the user and to display information relevant to the user. In some embodiments, the user may show a ticket (e.g., a ticket to a sporting event), or a bar code displayed on a mobile device.

In some embodiments, a user may interact with a digital sign (e.g., using a touch screen of the digital sign) to enter his name, his fantasy sports team name, or other identifying information. The digital sign may then display information relevant to the user.

In some embodiments, a digital sign may transfer to a competitor's device (e.g., to a competitor's mobile device) information that may be of interest to the competitor. Such information may include information about the competitor's fantasy sports team, or athletes that are part of the team. The competitor may then have the opportunity to peruse the information on his mobile device. Information may include statistics, images, replays of segments of sporting events, and so on. Information may be transferred via Near Field Communication, or via any other means of communication.

In various embodiments, a digital sign may determine its location. For example, the digital sign may contain a location sensor, such as a GPS sensor. The digital sign may determine, based on its locations, what are nearby sports teams. The digital sign may then present information about such sports teams. For example, if a digital sign is located in the stadium of a given real sports team, then the digital sign may present statistics about athlete's in that real sports, but presented in a way that is relevant to fantasy sports teams.

In some embodiments, when a competitor interacts with a digital sign, the competitor may receive a benefit in a fantasy sports competition. For example, a competitor may receive extra points for his team in a fantasy sports competition. The competitor may receive one or more other benefits, such as preferential draft picks, the ability to field extra athletes, the ability to do more trades, or any other benefit. In various embodiments, when a competitor interacts with a digital sign, the interaction may be recorded and sent to the service administering the fantasy sports competition. The service may then provide the benefit to the player. In some embodiments, there is a limit on the amount of benefit a competitor may receive in a given competition, or in a given period of time. For example, no matter the number of interactions with a digital sign, a competitor may be limited to receiving 10 extra points in a fantasy sports competition.

In some embodiments, a given digital sign, or group of digital signs (e.g., group of digital signs in the same stadium) may serve as interfaces to a miniature or contained fantasy sports competition. For example, the only entries allowed may be for those people who have physically visited the signs. Thus, in some embodiments, a fantasy sports competition may occur only among a set of people who have physically visited a digital sign at a particular location (e.g., at a particular stadium). In some embodiments, a fantasy sports competition may begin just prior to a real sporting event, and may end right after the real sporting event. For instance, people may come to a stadium for a sporting event, enter a fantasy sports competition at the stadium, have the outcome determined by the happenings in the sporting event at the stadium, and then know the winners and losers upon the conclusion of the sporting event.

### Proof of Play

In various embodiments, a display may include a built in sensor and/or camera that faces the display. In some embodiments, this camera may be built into a small overlay atop the main display screen. The camera may thus face backwards towards the display screen in order to capture any image or portion of an image emanating from the display. In various embodiments, the camera may be small and/or simple, and may include, for example, as little as one capture element (e.g., one charge coupled device (CCD) pixel).

In various embodiments, the camera may be used as a detector to determine whether the screen is on when it is supposed to be. For instance, a hardware malfunction may result in frame-buffer data being sent to the display, but no image actually appearing on the display. In this case the lack of an image may be detected via the sensor or camera, but may not otherwise be apparent. Thus, in various embodiments, the sensor and/or camera may server as an independent mechanism to determine whether or not the screen is on. The sensor and/or camera may provide a separate or independent output, which can be polled by an external device. For example, the sensor or camera may output a 24-bit signal indicating the level of each of three colors (e.g., primary colors) detected by the sensor or camera. This signal may be transmitted to, and interpreted by an external device. If the external device determines that no image is present on the screen, then the device may take remedial action, such as alerting a technician.

In various embodiments, a sensor may be capable of detecting a difference in state between when a display is outputting an image or not. For example, a dark screen may have a characteristic light signature (e.g., emitting no light). On the other hand, a screen that is showing an image or video may have a differing light signature (e.g., one that provides positive values for one or more colors).

In some embodiments, a signal received from the sensor may be averaged or otherwise accumulated over a period of time to allow for the possibility that an image or other content may contain dark portions that are indistinguishable from a dark screen (e.g., from the point of view of the sensor). For example, if the sensor views only a small corner of a display, and the display shows a video that is dark in one corner, then the sensor may have no way of distinguishing between the video and a blank screen. However, of the video brightens in that one corner at some point in time, then this change might be detected by the sensor, and the sensor may thereby successfully detect that there is, in fact, content playing on the screen.

In some embodiments, it may be desirable not only to detect whether or not a display is showing content, but also to distinguish one item of content from another. For example, in some embodiments, it may be desirable to determine whether a first advertisement is playing, whether a second advertisement is playing, or whether a news clip is playing.

In various embodiments, a unique visual code, tag, color, or other indicator may be displayed in conjunction with an image, video, text file, or other displayed item. The indicator may be displayed at such a position or location so as to be visible to a sensor within the display. For example, if a sensor is located facing the bottom right-hand corner of the display, then the indicator may be displayed at the bottom right-hand corner of the image. In this way, the indicator can be read by the sensor.

In various embodiments, the indicator may be a static indicator. For example, the indicator is a monochromatic single pixel, or monochromatic single region. The indicator may not change for the duration of display of the corresponding content (e.g., a corresponding video or image). In some embodiments, the indicator may have spacial variation. For example, the indicator may have alternate light and dark regions, or alternate regions of different colors. Such spatial variation may be suitable, for example, if the sensor has more than one capture element, in which case spatial variation in the incident signal from the display may be perceived as variation across the capture elements.

In various embodiments, the indicator may be time varying. For example, the indicator may alternate in time between light and dark, or between one or more shades of gray, or between one or more colors. In some embodiments, the indicator may vary its brightness over time. In this case, even if the sensor has just a single capture element, it may be capable of detecting a complex signal, because the sensor may be capable of capturing multiple snapshots over a period of time. In turn, a given content item (e.g., video, image, text file) may be associated with a unique time-varying indicator, which may allow the display of the content to be accurately ascertained by the sensor.

In various embodiments, a digital signage system determines one or more items of content to be shown on a display. The system assigns to each item of content an indicator, such as a visual indicator. The system causes the indicator to be displayed in conjunction with the content. The indicator is then detected by a sensor facing a display on which the content is shown. The sensor reports back to the system a signal it has captured. The signal may consist of a visual capture of the indicator, with possibly some noise built in. The system may then compare the captured signal to a set of assigned visual indicators. If there is a match, then the system may determine which item of content is associated with the visual indicator. Then system may then record that the item of content has successfully played.

In various embodiments, an indicator may be shown within an item of content at such a location as to be visible to a sensor facing a display. However, depending on various factors, the sensor may be positioned differently. Such factors may include the model, screen orientation (e.g., portrait versus landscape), screen dimensions, and so on.

In various embodiments, a server may determine where within content to show an indicator based on a screen model, based on a screen orientation, based on screen dimensions, and/or based on any other factor. For example, a server may determine that a first display screen has a sensor positioned in the upper right corner. Accordingly, the server may cause an indicator to be positioned in the upper right corner of any content displayed in the first display screen. In turn, the server may determine that a second display screen has a sensor positioned in the lower left corner. Accordingly, the server may cause the indicator to be positioned in the lower left corner of any content displayed in the second display screen. Thus, in various embodiments, the same content may be shown with indicators in different places depending on the screen on which the content is played.

In some embodiments, a server may determine the orientation of a given screen. For example, if in portrait orientation, then the sensor may be in the lower left-hand corner of the screen. However, if in landscape mode, the sensor may be in the upper left hand corner of the screen. Thus, based on the screen orientation, the server may place an indicator either in the lower-left hand corner, or in the upper left hand corner of a screen.

In some embodiments, an indicator may be a separate feed or separate item of content from the content with which it is associated. For example, an indicator may be placed into a separate zone or region. The indicator may only be added at the last minute by the renderer (e.g., by a compositing engine of the renderer).

In various embodiments, the renderer may make a determination as to where to add an indicator within an overall displayed image. The renderer may be local to the display, and may thus know details about the display, such as orientation, model, and so on. Thus, the renderer may create a composite image of two content feeds (e.g., advertisement and indicator), in real time based on its knowledge of the details of the display.

In some embodiments, an indicator may only be displayed or rendered if there is a sensor in the display itself. In various embodiments, a server and/or a rendering device may make the determination as to whether or not an indicator should be rendered. The server and/or the rendering device may make the determination based on knowledge of the display (e.g., the display model). Thus, in various embodiments, if there is no sensor, then the actual content need not be obscured by an indicator.

### Counting Venue Traffic

In various embodiments, it may be desirable to track people, customers, employees, or other parties at a venue. It may be desirable to track people who view a digital sign, people who have the opportunity to view the digital sign, people who view and/or have the opportunity to view a product, people who handle a product, people who view a video, employees who view a video (e.g., a training video), and so on. For example, an advertiser may wish to ascertain the impact of its advertising and may therefore wish to know the number of people viewing a sign where its advertisement is displayed.

In various embodiments, a camera or other image capture device or other capture device may be used (e.g., in conjunction with a computer and image processing algorithms) to recognize the presence of people within the line of site of the device. The count of the number of people may be stored and/or transmitted to a server or other device. The count may be reported to an advertiser or other interested party.

In various embodiments, it may be desirable to filter out certain people from a count of venue or location traffic. For example, in a retail store setting, an advertiser may be interested in the number of store customers who view its advertisement, but may not be interested in the number of store employees who view its advertisement. Moreover, in some embodiments, it may be assumed that store employees may walk back and forth in the vicinity of a digital sign, and thus it may be desirable to avoid repeated counting of such employees.

According to some embodiments, a tracking system may be used to track foot traffic and/or other traffic at a venue. The tracking system may include a camera or other image capture device, a microphone, a pressure sensor (e.g., for footsteps), a laser and detector (e.g., for detecting interruptions in laser transmission caused by passing traffic), an infrared sensor (e.g., for sensing heat from passersby) or any other sensor or sensing system. In some embodiments, the tracking system may include one or more computers, computer processors, graphical processing units, memories, and/or other computer components. The computer may execute algorithms to determine based on sensory input, information about people in the vicinity (e.g., whether or not people are present; age; gender; demographic; clothing worn; etc.). Such algorithms may include image recognition algorithms, facial recognition algorithms, or any other algorithms.

In various embodiments a tracking system may determine one or more baseline metrics to which to compare identified foot traffic. In some embodiments if the characteristics of the identified foot traffic match the baseline metrics, then the foot traffic is counted. Otherwise, the foot traffic is not counted. In some embodiments if the characteristics of the identified foot traffic match the baseline metrics, then the foot traffic is not counted. Otherwise, the foot traffic is counted.

In some embodiments, baseline metrics may include a style of clothing worn. The style may include the color of clothing worn. For example, the tracking system may determine a baseline metric of a person with a blue shirt and brown trousers. Subsequently, if the system detects any person wearing a blue shirt and brown trousers, then the system may not count that person in its tally (e.g., its tally of store customers in a retail store).

In some embodiments, by utilizing a baseline metric for comparison, the tracking system may filter out store employees. For instance, store employees may wear a particular uniform consisting of a recognizable combination of colors, or combination of shirt and trousers, each with distinctive color. Thus, whenever the tracking system detects a person with that uniform, the system may not count the person. In some embodiments, a tracking system may determine a baseline metric at a time that is not during normal store hours. For example, the system may determine a baseline metric at 8:00 am for a store that does not open until 9:00 am. Presumably, for example, at hours when the store is not open for business, the tracking system will only be detecting store employees. The tracking system may thereby generate a baseline metric to recognize employee uniforms with a higher degree of confidence than if it was during business hours and non-employees were milling about. Accordingly, in various embodiments, a tracking system may determine a first time when a store is not open for business, and may determine a baseline metric at that time.

In various embodiments, a baseline metric may include physical characteristics, such as facial features, height, size, foot size, etc. For example, in various embodiments, a tracking system may determine one or more physical characteristics of one or more store employees. The tracking system may then avoid counting foot traffic for people who possess these physical characteristics, so as to avoid counting store employees as foot traffic.

In various embodiments, a tracking system may utilize any identifiable characteristic of a store employee so as to determine a baseline metric. These may include gait, voice characteristics, paths taken, cell phone signal, Bluetooth signal, or any other characteristic or identifier. In various embodiments, an identifiable characteristic of a store employee may include a characteristic of the person or a characteristic of a device or other object associated with the person, such as a device or object belonging to the person (e.g., such as the person's cell phone).

In various embodiments, a tracking system may utilize any identifiable characteristic of a customer or other non-store employee so as to determine a baseline metric.

In some embodiments, it may be desirable to avoid repeated or duplicative counting of any person who is tracked. Accordingly, in some embodiments, a tracking system may store one or more characteristics of a first person who is counted. If a second person is counted sharing one or more of the recorded characteristics of the first person, then the tracking system may assume that it is the same person that was previously counted. Accordingly, the tracking system may not count the second person.

In some embodiments, a tracking system may partially count a person based on the degree to which characteristics of the person match characteristics of a previously recorded person. For example, if five out of 10 characteristics for a second person appear to match those of a first person already counted, then the second person may be counted as half a person. This may represent a 50% confidence level that the second person is a new person. As will be appreciated, other fractions may be used to count a second person based on confidence levels that the second person is a new and distinct person that has not yet been counted.

### Capture

In various embodiments, a system records lectures and makes them available for later review by students and/or other interested parties. The system may receive a schedule of lectures in advance, such as a schedule of lectures and associated rooms in a university. The system may include capture devices in various classrooms. Such capture devices may be in communication with cameras, microphones, laptops with slideshows, and/or any Audio Visual equipment, and/or any equipment. At an appropriate time based on the schedule of lectures, a capture device may start recording a lecture via the video cameras, microphones, etc. At the conclusion of the lecture (or at some other time), the capture device may upload the recorded lecture to a server.

Students, teaching assistants, and/or other parties may then access the server, such as through a web browser. The students may then view the recorded lecture. Further, students and professors may post questions and comments about the lecture, and generate discussions centered around the lecture. The professor and others may post clarifying or supplementary materials about the lecture. Accordingly, the recorded lecture may server as the basis for a collaborative environment whereby students can further their learning and understanding of the lecture material.

In various embodiments, students may benefit knowing that a recorded lecture will be available to them after class. Accordingly, students may focus less on taking notes in class, and more on active participation. Students may further benefit from reviewing the lecture at their own pace, emphasizing specific portions of the lecture in their study, having questions answered, seeing the comments of others, and so on. In various embodiments, professors may benefit from receiving rapid feedback about the effectiveness of their lectures and the points where students are still having trouble. In various embodiments, professors may also benefit from being able to gauge the participation and involvement of various students through tracking of their comments and other use of the system.

### System

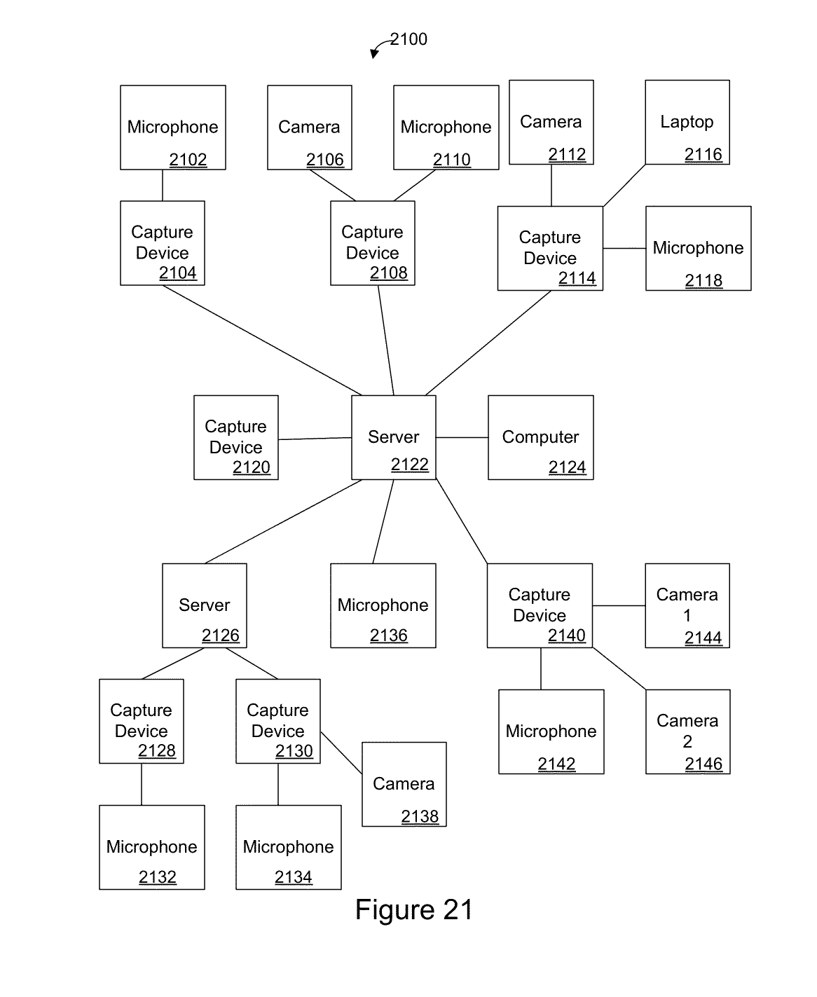

FIG. 21 shows a system 2100 according to some embodiments. System 2100 is illustrative of one or more possible system architectures, but it should be understood that various embodiments may include alternate architectures. Server 2122 may be linked with various other devices and/or programs. In various embodiments, server 2122 is linked to capture devices 2104, 2108, 2114, 2120, 2126, 2140 and to microphone 2136, to computer 2124, and to server 2126. It will be appreciated that, in various embodiments, server 2122 may be linked to any number of devices and/or programs, including various capture devices, computers, servers, microphones, cameras, and/or other programs or devices.

Exemplary capture devices include capture devices 2104, 2108, 2114, 2120, 2128, 2130, and 2140. A capture device may be connected to one or more input devices. Input devices may include audio/visual devices, cameras, microphones, or other input devices. Input devices may include computers, laptops, or other devices that can output audio/visual or other signals, e.g., via VGA, DVI, HDMI, or USB outputs.

A capture device may perform various functions, including: (a) storing input signals; (b) synchronizing input signals (e.g., synchronizing an audio and a video signal, e.g., synchronizing two video signals); (c) controlling audio/visual equipment (e.g., transmitting instructions to a microphone or camera to turn on or off); (d) receiving control signals from audio/visual equipment (e.g., receiving an indication that an item of AV equipment is turned on, e.g., receiving an indication that an item of AV equipment is recording, e.g., receiving an indication that an item of AV equipment is functioning properly, etc.); (e) processing input signals (e.g., compressing video signals, e.g., down-sampling audio signals, e.g., converting an input signal from one format to another format, such as from one video format to another video format, e.g., converting an input signal from one resolution to another resolution, e.g., converting an input signal from one sampling rate to another sampling rate, e.g., converting an input signal from one frame rate to another frame rate, e.g., removing background noise, e.g., cropping, e.g., adjusting lighting, e.g., adjusting volume, e.g., adjusting speed, and/or any other processing functions); (f) transmitting input signals to another device, such as a server, or any other function.

In various embodiments, a capture device serves to coordinate and control several input devices (e.g., AV devices) in a given location, such as in a given classroom. In various embodiments, input devices may include cameras, microphones, computers, and any other input devices.

In various embodiments, a computer may serve as an input device by transmitting a slide show or other presentation to a capture device. For example, a professor may bring a laptop with a slideshow presentation on it to show the class. The laptop may be connected to the capture device. As the laptop displays the slideshow to the classroom, the laptop may also output the slideshow to the capture device.

System 2100 may operate as a web application in various embodiments. System 2100 may utilize a web application framework such as Django or Ruby on Rails. Data models may be created in Python. Data may be stored in a database such as MySQL. Interactive web pages may be created using javascript, jQuery, and/or Asynchronous JavaScript and XML (Ajax). In various embodiments, alternative frameworks may be used, alternative software languages may be used, alternative mechanisms of creating, exchanging, and storing data may be used, and so on.

FIG. 21 illustrates various configurations of input devices and capture devices, according to various embodiments. A capture device 2104 may be connected to a single input device, such as to microphone 2102. A capture device 2108 may be connected to a multiple input devices, such as to camera 2106, and to microphone 2102. Capture device 2114 may be connected to multiple input devices, including camera 2112, laptop 2116, and microphone 2118. In various embodiments, a capture device may be connected to two or more similar input devices. Capture device 2140, for example, may be connected to two cameras (2144 and 2146), as well as to other input devices, such as to microphone 2142.

In some embodiments, a capture device may incorporate or subsume one or more functions of an input device. For example, a single capture 2120 device may include a built in camera and/or a built in microphone.

In some embodiments, capture devices may link directly to a main server, e.g., to server 2122. In some embodiments, there may be an intermediate server to which capture devices link. An exemplary intermediate server 2126 links to server 2122. In turn capture devices 2128 and 2130 link to intermediate server 2126.

In various embodiments, an intermediate server may perform one or more functions locally, such as to reduce storage or processing burdens on the main server, such as to reduce bandwidth requirements, such as to reduce the amount of simultaneous transmissions to the main server, or any other functions for any other purpose. For example, server 2126 may compress input signals received from capture devices 2126 and 2130, before sending the processed signals to server 2122. In some embodiments, server 2126 may store signals (e.g., video files of recorded lectures) until such time as traffic going into server 2122 is below a certain threshold. When traffic into server 2122 is at low enough levels, server 2126 may take the opportunity to transmit files into server 2122.

As will be appreciated, server 2126 may have various other functions and purposes. For example, server 2126 may also store content locally (e.g., at a university) so that people downloading the content locally can enjoy reduced latency as compared to downloading content from server 2122.

### Server

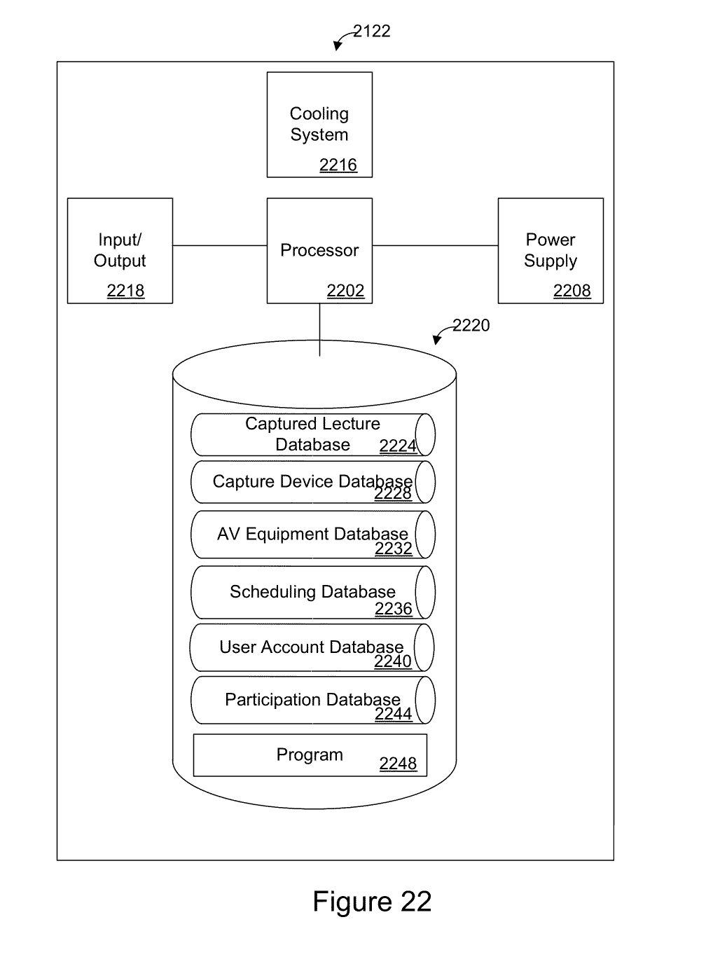

FIG. 22 shows server 2122 according to some embodiments. Server 2122 may contain similar components and may perform basic operations in a fashion similar to server 104.

Server 2122 may store various databases, including captured lecture database 2224, capture device database 2228, AV equipment database 2232, scheduling database 2236, user account database 2240, and participation database 2244 according to various embodiments. As will be appreciated, server 2122 may include more or fewer databases, in various embodiments. In various embodiments, databases may be combined or separated, and data depicted herein may be arranged in alternate formats.

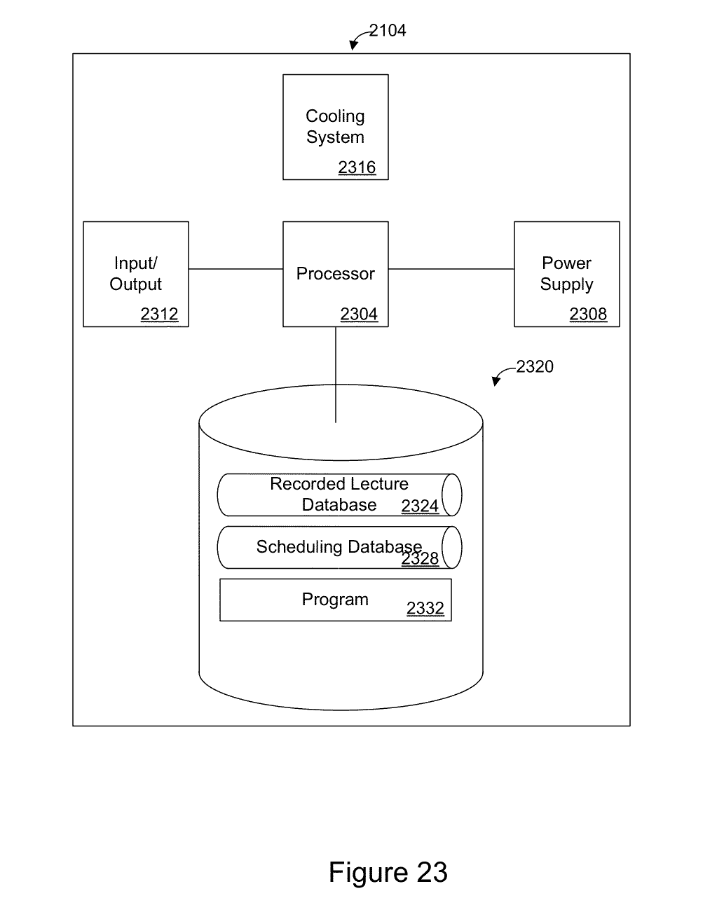

FIG. 23 shows a capture device 2104 according to some embodiments. The capture device may be a dedicated computer, appliance, circuit, or other suitable device. In some embodiments, the capture device may be a subsystem within a larger device, such as within a larger computer. In some embodiments, a capture device may be distributed, and may be instantiated as one or more separate devices. In various embodiments, a capture device may take any suitable form. In various embodiments, a capture device may include one or more input devices or sensors, such as cameras and/or microphones.

In various embodiments, a capture device 2104 may include a processor 2304, which may execute computer instructions and may direct the various components of the capture device to act in accordance with various embodiments. The capture device may include a cooling system 2316, which may include circulating air, liquid, or other coolant, which may include one or more fans, and/or one or more heat syncs. The capture device may include a power supply 2308. The power supply may include a direct power source, such as a battery or generator. In some embodiments, the power source may include a converter for converting one form of power (e.g., power from a wall outlet) into power suitable for running the processor and/or other components of the capture device. In some embodiments, capture device 2104 may include an input/output system 2302, which may facilitate transmitting and receiving signals to and from external devices and/or an external network.

Storage 2320 may allow capture device 2014 to store various data. In some embodiments, capture device 2104 stores a recorded lecture database 2324. Database 2324 may store one or more lectures that have been recorded by the capture device. These may include lectures that have not yet been transmitted to server 2122, or to an intermediate server. In various embodiments, capture device 2104 may store recorded lectures (or other items) until such time as it has transmitted the recorded lectures to an external server or other device.

In some embodiments, capture device 2104 may store a scheduling database 2328. The scheduling database may allow the capture device to track when lectures are supposed to start and stop. When the time comes for a lecture to start, the capture device may automatically begin recording data from the lecture (e.g., video and audio data of the lecture). When the time comes for a lecture to end, the capture device may automatically stop recording.

Program 2332 may include computer instructions that allow the processor to operate in accordance with various embodiments.

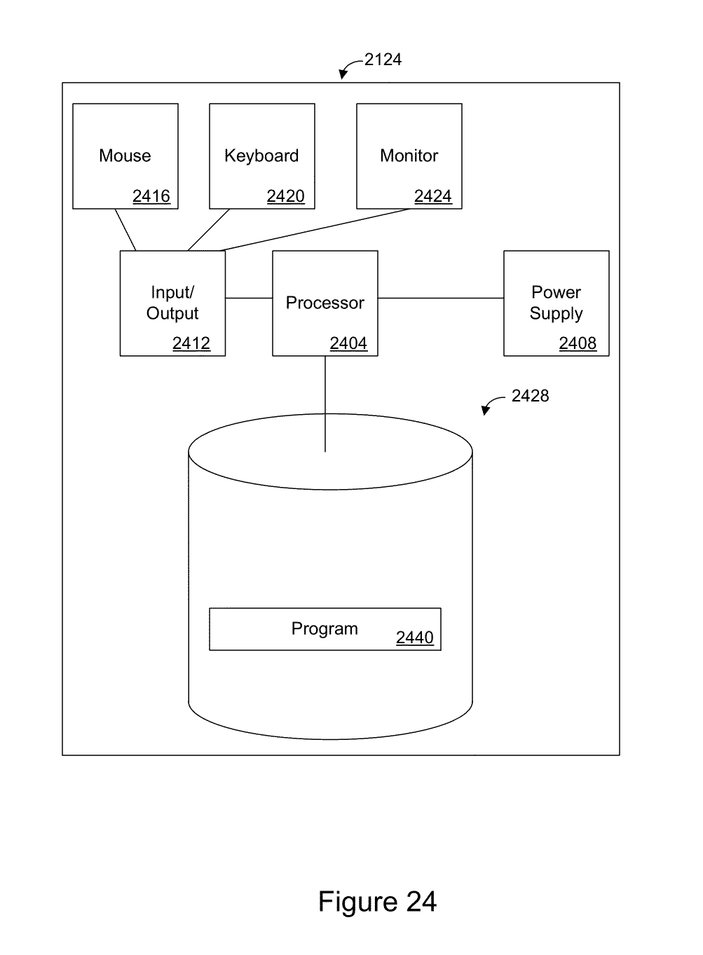

FIG. 24 shows a computer 2124 according to some embodiments. The computer may allow an administrator or other party to communicate with server 2122.

In some embodiments, computer 2124 may be a user device. A user (e.g., a student, e.g., a professor) may connect to server 2122 via the computer 2124. The user may download recorded lectures and associated comments from the server. The user may download any other appropriate data from the server. The user may also transmit information to the server, including comments made by the user, bookmarks made by the user, usage data generated by the user, and any other appropriate data.

It will be appreciated that while computer 2124 is depicted with standard components of a personal computer, a computer may take any appropriate form, in various embodiments. In various embodiments, a computer may be a laptop, tablet computer, cellular phone, smart phone, mini-tablet computer, notebook computer, internet appliance, personal digital assistant, music player, or any other suitable device.

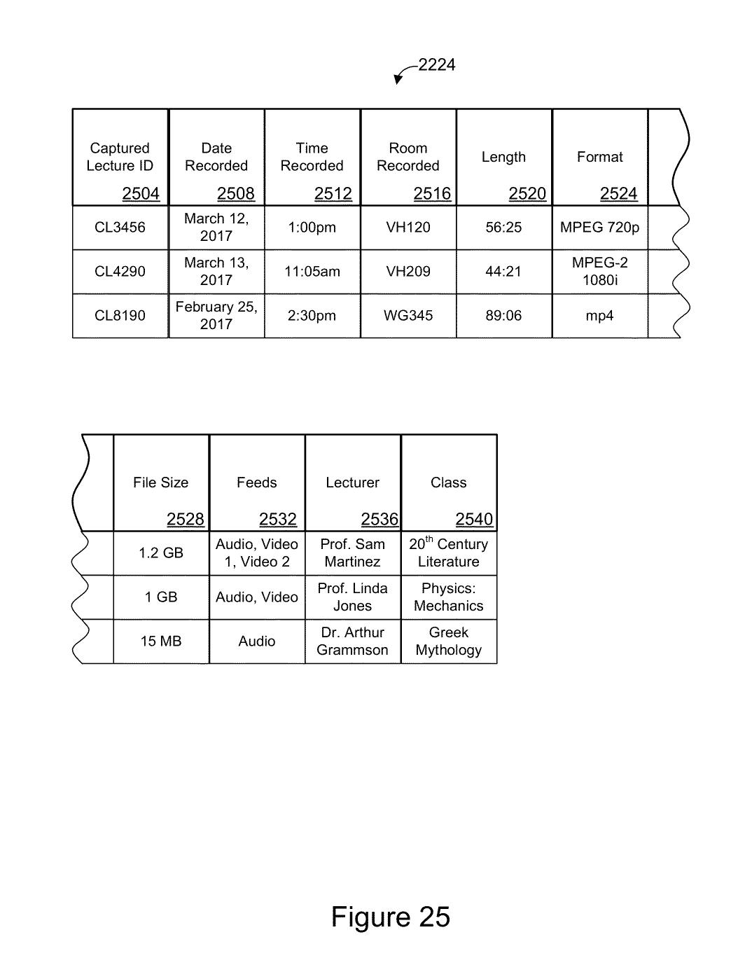

FIG. 25 shows a captured lecture database 2224 according to some embodiments. Database 2224 may store data from recorded lectures. Such data may include video data, audio data, data from slide presentations shown during the lecture, data from video or animations shown during the lecture, and/or any other data associated with the lecture.

In various embodiments, lectures may be provided with unique identifiers listed in field 2504. Various information may be stored in association with lecture data, such as the date recorded 2508, the time recorded 2512, the room in which the lecture was recorded 2516, the length of the recorded lecture 2520, the format in which the lecture was recorded (e.g., the video file format; e.g., the audio file format; e.g., the slide show format; e.g., the video resolution), the file size of the recorded lecture 2528, the nature of the feeds that were recorded 2532 (e.g., the number of video feeds; e.g., the number of audio feeds), the lecturer 2536, and the class or subject for which the lecture was recorded 2540. It will be appreciated that various embodiments contemplate other appropriate data that may be stored in conjunction with a recorded lecture.

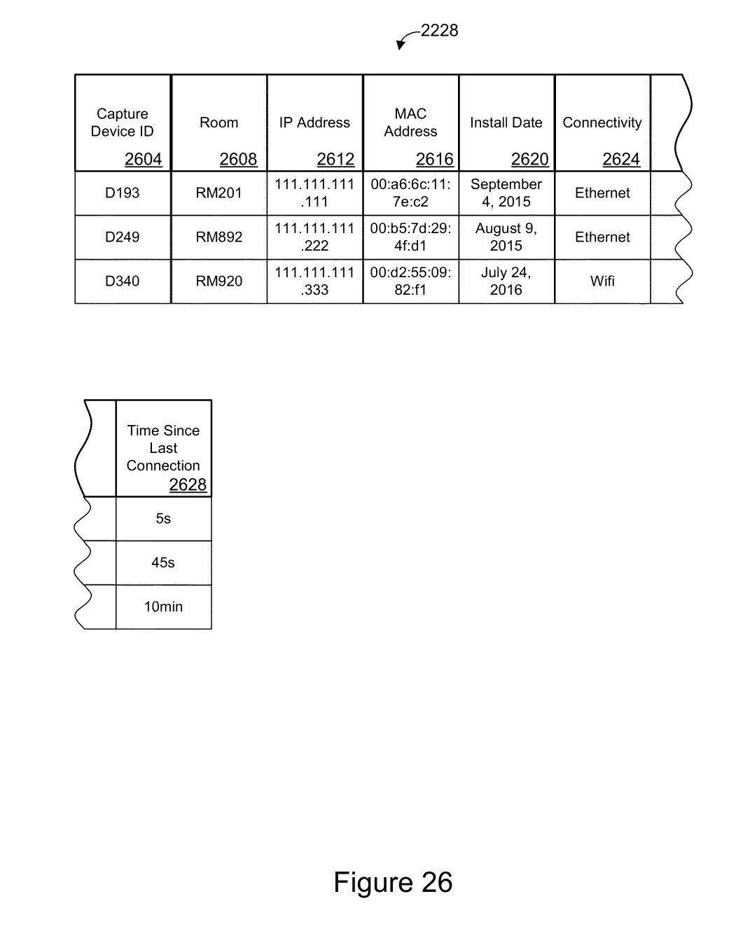

FIG. 26 shows a capture device database 2228 according to some embodiments. The capture device database may allow server 2122 to keep track of the various capture devices so that the server can communicate with them, transmit schedules to them, receive recorded lectures from them, receive status information from them, and so on. Each capture device may have an associated unique ID, stored in field 2604. Field 2608 may store the room in which the capture device is installed. The room may be a classroom, for example. Field 2612 may store an IP address or other network address associated with the capture device. Field 2616 may store a Media Access Control address (MAC address), a hardware address, or any other type of address. This may allow the server, for example, to keep track of individual capture devices so as to make sure that each receives the latest software updates, security updates, etc. Field 2620 may store an install date. This date may be useful, for example, in determining when a capture device might need maintenance, servicing, or replacement. Field 2624 may store an indication of the type of connectivity by which the capture device links to the Internet or other network. Field 2628 may store an indication of the time since the last connection was achieved with the capture device. In various embodiments, if this time is too long (e.g., more than 1 minute), then this may be indicative of a problem (e.g., the network is down, e.g., the capture device may not be functioning properly).

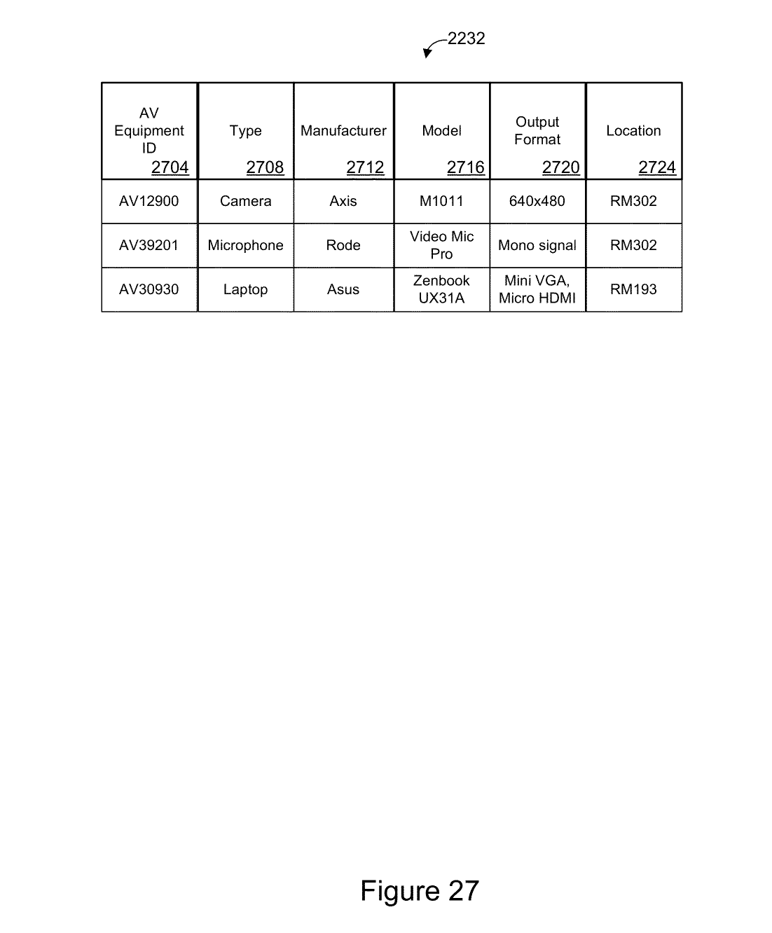

FIG. 27 shows an AV equipment database 2232 according to some embodiments. The AV equipment database may allow the server to keep track of the existence, specifications, location, etc., for one or more items of AV equipment. As will be appreciated, database 2232 may, in various embodiments, track other devices or equipment besides AV equipment. In various embodiments, database 2232 includes an ID field 2704, such that each item of equipment has a unique identifier. Type field 2708 may identify the type of equipment, such as “camera”, “microphone”, or “laptop”. Manufacturer field 2712 may identify the equipment manufacturer. Model field 2716 may identify the model of the equipment. Output format field 2720 may track the output format of an item of equipment. This may include the resolution, frame rate, size, compression format, number of channels, or any other output format. Location field 2724 may store the location of an item of equipment, such as the room, rack, closet, building, etc.

In various embodiments, by tracking the type of equipment, the server may be able to send the right control signals to the equipment (e.g., start, stop, etc.), or to instruct the capture device as to the right control signals to send to the AV equipment. The server may also provide proper instructions to the capture device as to how to capture the incoming signal from the AV equipment (e.g., which signal format to expect).

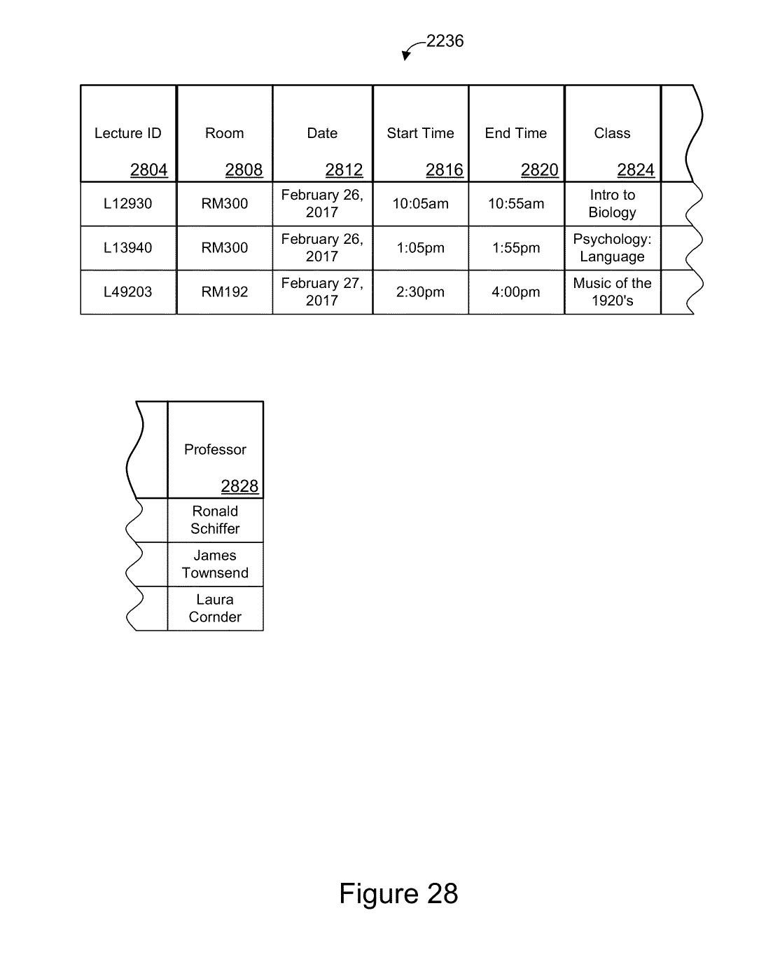

FIG. 28 shows a scheduling database 2236 according to some embodiments. The scheduling database may allow the server 2122 to track when and where lectures will occur, so that recording of the lectures can begin and end automatically. In various embodiments, the server continuously monitors the current date and time, and monitors the scheduling database to see if any lectures should be recorded at the current date and time (or, in various embodiments, in the next predetermined amount of time, e.g., 5 minutes). If it is time to begin recording, the server may signal the capture device to begin recording. The server may signal the AV equipment to begin recording. In various embodiments, a capture device may signal AV equipment to begin recording. In various embodiments, if a lecture is to begin within a predetermined amount of time (e.g., within 5 minutes), then the server may signal the appropriate capture device to prepare for recording. In various embodiments, if a lecture is to begin within a predetermined amount of time (e.g., within 5 minutes), then the server and/or a capture device may signal the appropriate items of AV equipment to turn on, warm up, or otherwise prepare.

In various embodiments, one or more entries, or one or more portions of entries of scheduling database 2236 may be transmitted to a capture device. For example, entries pertaining to lectures in the room of the capture device may be transmitted to the capture device. The capture device may thus have a local schedule of lectures that it should record.

In various embodiments, field 2804 may store a unique ID for each lecture (e.g., for each upcoming lecture and/or for each passed lecture). Field 2808 may store the room in which the lecture will be given. Fields 2812, 2816, and 2820 may store, respectively, the date, start time, and end time of the lecture. Field 2824 may store the class with which the lecture is associated. For example, the lecture may be part of a class that includes many lectures. Field 2828 may store the professor that delivers the lecture. As will be appreciated, various other items related to a scheduled lecture may be stored in scheduling database 2236.

In various embodiments, server 2122 may obtain the data for scheduling database 2236 in various ways. Server 2122 may interface with an existing software package, such as a learning management system (LMS), course scheduling system, or other software package. Server 2122 may access an API, for example, to download course schedule data from an existing system. In some embodiments, the server may receive course scheduling data from a spreadsheet, other database, via manual entry, or via any other means.

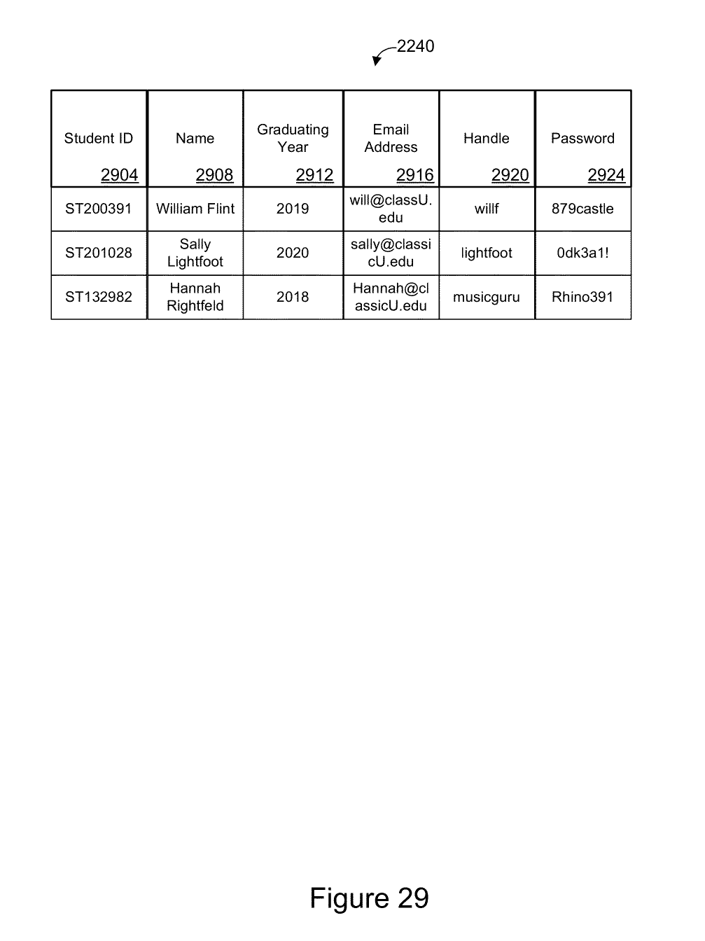

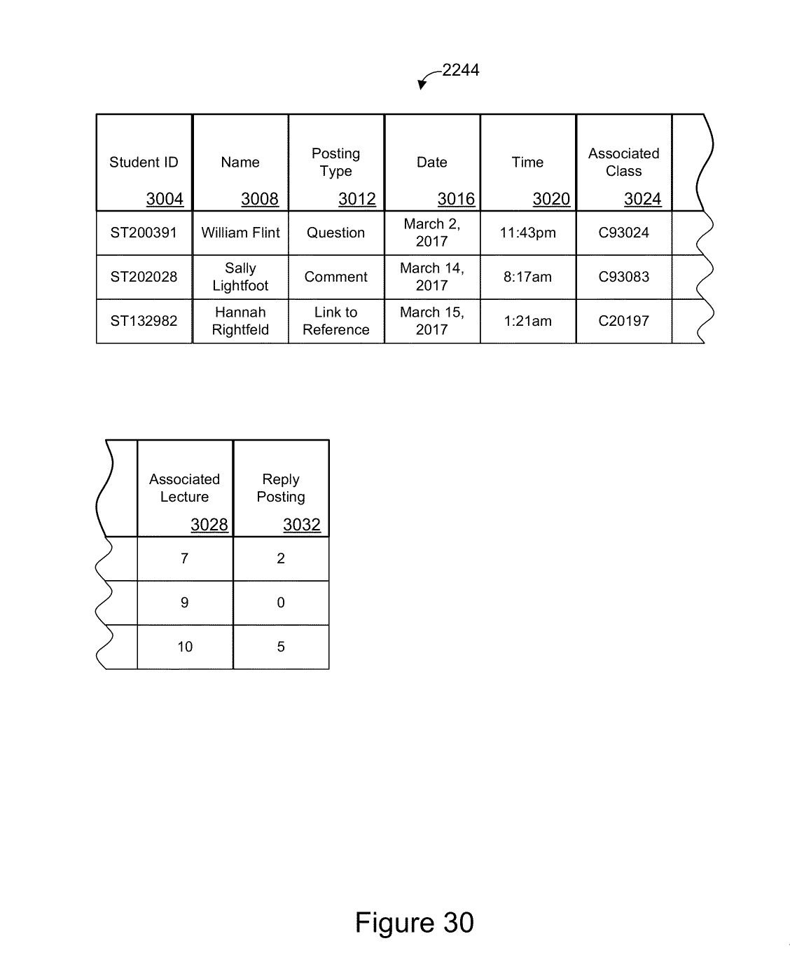

FIG. 29 shows a user account database 2240 according to some embodiments. The user account database may keep track of those who are allowed to view recorded lectures, make comments about recorded lectures, and/or otherwise interact with a system according to various embodiments. Field 2904 may store a unique ID for each user. Although FIG. 30 shows users as students, it will be appreciated that users may include other parties as well. In various embodiments, users may include professors, administrators, teaching assistants, former students, people auditing a class, parents, advisors, and/or any other type of user.

Field 2908 may include a user name. Field 2912 may store a graduating year. Field 2916 may store an email address. Field 2920 may store a handle. The handle may be the on-line name or identifier by which a user is recognized when using or interacting with the system (e.g., when making comments about recorded lectures). Field 2924 may store a password. The user may be required to enter a password before accessing the system. For example, in various embodiments, to view a recorded lecture, a user would visit a particular URL, and enter his email address (or handle) and password.

As will be appreciated, in various embodiments, user account database 2240 may store various other data. Such data might include user privileges. For instance, a user might be able to view lectures, but not comment. A user might be able to ask questions, but not reply to other questions. A user may require a privilege to post supplementary materials. In various embodiments, a user may have privileges for any functionality of the system, or for any combination of functionalities. With such privileges, the user may be able to access the functionalities, while without such privileges, the user may be unable to access such functionalities.

FIG. 30 shows a participation database 2244 according to some embodiments. The participation database may allow the server to track user participation and/or interactions with the system. Such participation may provide insight into users' learning progression, the effectiveness of lectures, the need for intervention, the need for the professor to focus on particular topics, etc. Participation data may influence users' grades, in some embodiments. In various embodiments, participation data may be aggregated into charts, graphs, or other summaries. For example, a professor may be able to view a chart of the number of comments that a student (or all students) have made over time.

Field 3004 may include a user ID, such as a student ID. Field 3008 may include a user name, such as a student name. Field 3012 may store a posting type. The posting type may divide postings into various categories. Such categories may include questions, comments, or links to reference material. As will be appreciated, in various embodiments, there may be various other categories or types of postings that may be tracked. Fields 3016 and 3020 may include, respectively, the date and time of a posting. Field 3024 may include the class for which a posting was made. Field 3028 may include the lecture for which a posting was made. For example, a student might be reviewing a particular recorded lecture, and may then make a posting related to material in that lecture (e.g., may ask a question about material from that lecture). Field 3032 may store reply postings. These reply postings may include postings that have been made as a consequence of an original or an earlier posting made by a given user. For example, a user might make a first comment, and then three other students might respond to that comment in some way. Thus, the original user may be credited with having three postings made as a reply to his original posting.

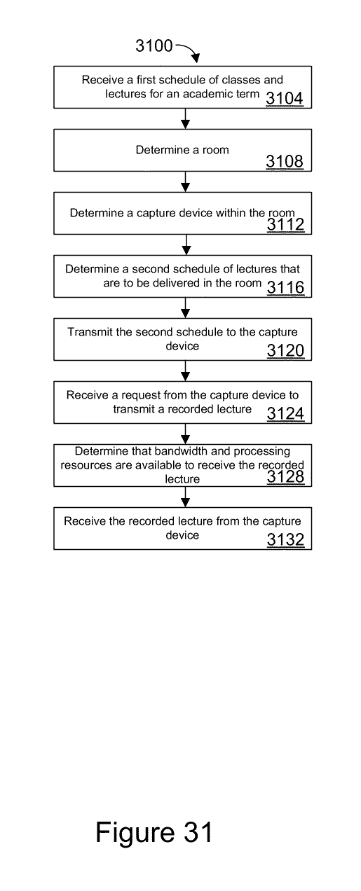

FIG. 31 shows a process for recording from the point of view of a server, according to some embodiments. At step 3104, the server 2122 receives a first schedule of classes and lectures for an academic term. These may be received in various ways, such as through an API to a learning management system. These may then be stored in scheduling database 2236.

In various embodiments, the server may transmit to individual capture devices a schedule of lectures that will occur in their respective rooms. At step 3108, server 2122 may determine one such room. At step 3112, the server may determine a capture device that is in that room. For example, server 3112 may access capture device database 2228 to determine which capture device is in the particular room. The server may also look up the IP address or other address for the capture device.

At step 3116, server 2122 may determine a second schedule of lectures that are to be delivered in the room. That is, the server may generate a schedule that is a subset of the main schedule, consisting only of the lectures that are to be delivered in the determined room. In various embodiments, to do so, the server may comb through scheduling database 2236 and select only those entries corresponding to the determined room.

At step 3120, the server may transmit the second schedule to the capture device. Thereafter, the capture device may proceed to capture lectures automatically in accordance with the second schedule. After capturing one or more lectures, the capture device may send a request to the server 2122 to transmit a recorded lecture back to the server. Thus, at step 3120, the server may receive a request from the capture device to transmit a recorded lecture.

After receiving such a request, at step 3128, the server may determine whether bandwidth and processing resources are available to receive the recorded lecture. In various embodiments, a server may be in communication with numerous lecture capture devices at once. Further, lectures may tend to start and stop at similar times (e.g., at the turn of the hour). Accordingly, in various embodiments, a server may receive multiple requests for it to receive recorded lectures from capture devices. With resource limitations (e.g., limits on bandwidth and/or processing), the server may be unable to honor all such requests at the same time. Accordingly, in some embodiments, the server may transmit to a capture device an indication that it is not yet ready to receive a recorded lecture. In various embodiments, the capture device may be programmed to keep asking the server to receive the recorded lecture until the server is able to. In some embodiments, the server may tell the capture device when it is ready to receive the recorded lecture. As will be appreciated, various embodiments include other protocols by which the capture device and server may agree on when a captured lecture can be transmitted from the capture device to the server.

At step 3132, the server and capture device have agreed that a recorded lecture can be transmitted to the server. The server then receives the recorded lecture from the capture device.

In various embodiments, a lecture may be captured even if it had not been scheduled in advance. For example, an ad-hoc lecture or event may arise, and it may still be desirable to record such lecture. In such cases, a user (e.g., an administrator) may manually tell the server 2122 to capture a lecture. For example, an administrator may access a designated URL, and may enter the room, start time, end time, and a title for the lecture. As will be appreciated, the administrator may enter other information as well, such as who may be allowed to view the lecture, a class with which the lecture is associated, the professor giving the lecture, etc. The server may then transmit instructions to the proper capture device to capture the lecture at the appropriate times.

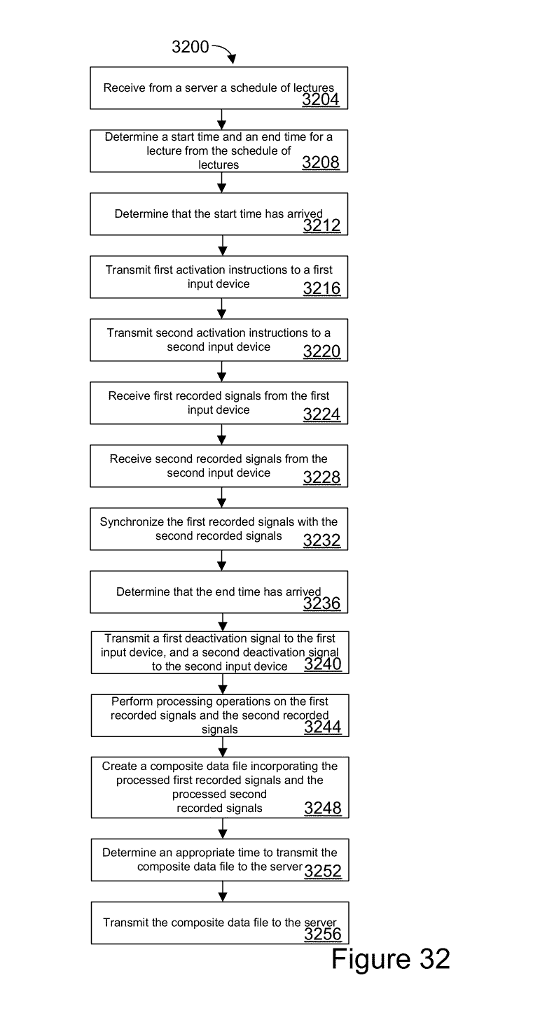

FIG. 32 shows a process for recording from the point of view of a capture device, according to some embodiments. At step 3204, the capture device may receive from a server a schedule of lectures. At step 3208, the capture device may determine a start time and an end time for a lecture from the schedule of lectures. At step 3212, the capture device may determine that the start time has arrived. At step 3216, the capture device may transmit first activation instructions to a first input device.

In some embodiments, a capture device may take preparatory actions in advance of the start of a lecture. In various embodiments, a capture device may instruct in input device to turn on or otherwise activate a predetermined amount of time (e.g., 5 minutes) in advance of the start of a lecture. A capture device may also capture a test signal via one or more input devices, in some embodiments. In various embodiments, a capture device may determine whether there are any potential problems. For example, a capture device may determine whether an item of AV equipment is on and/or functioning properly. If the capture device determines that there is a problem, then the capture device may send an alert message to the server 2122 and/or to any other device or person. In some embodiments, the capture device may flash a light, sound an alarm, or otherwise provide a physical indication that something is wrong. In this way, for example, a professor in the room can be alerted not to begin the lecture until the problem is fixed.

As step 3220, the capture device may transmit second activation instructions to a second input device. For example, there may be multiple input devices involved in recording a given lecture (e.g., video camera and microphone). As will be appreciated, step 3220 may be omitted if there is only one capture device.

At step 3224, the capture device may receive first recorded signals from the first input device. These signals may be received in real-time, with delay, and/or as aggregated signals (e.g., as entire files after an input device has recorded for a given period of time). At step 3228, the capture device may receive second recorded signals from the second input device.

As step 3232, the capture device may synchronize the first recorded signals with the second recorded signals. For example, the capture device may insure that an audio signal is synchronized with a video signal, or that two video signals are synchronized. In doing so, the capture device may account for any latencies in transmission and/or for any delays in transmission from a given item of AV equipment to the capture device.

As will be appreciated, various embodiments contemplate various methods of transmission. In some embodiments, recorded signals include periodic time stamps. Thus, if two items of AV equipment are running according to synchronized clocks (and/or to clocks with a known relative difference), then the time stamps of the respective signals can be lined up appropriately. In some embodiments, signals may be synchronized via lip-reading algorithms.

At step 3236, the capture device may determine that the end time for recording a lecture has arrived. At step 3240, the capture device may transmit a first deactivation signal to the first input device, and a second deactivation signal to the second input device. These signals may instruct the respective input devices to stop recording and/or to turn off, for example.

At step 3240, the capture device may perform processing operations on the first recorded signals and the second recorded signals. Processing operations may include noise filtering, filtering, synchronization, compression, re-sampling, down-sampling, file type conversion, resolution conversion, cropping, cutting out certain portions, or any other processing. As will be appreciated, other processing operations may be performed, in various embodiments.

At step 3248, the capture device may create a composite date file incorporating the processed first recorded signals and the processed second recorded signals. For example, the capture device may create a composite data file containing both video and audio signals. In some embodiments, the capture device may combine two video signals, e.g., to create a split-screen video signal. As will be appreciated, various other means of creating a composite signal are contemplated, according to various embodiments.

At step 3252, the capture device may determine an appropriate time to transmit the composite data file to the server. For example, the capture device may wait for instructions from the server indicating that the server has the bandwidth and/or processing resources available to receive the data file. At step 3256, the capture device may transmit the composite data file to the server.

Though various embodiments contemplate transmission of a composite data file to the server, various embodiments also contemplate transmission of separate data files to the server (e.g., separate audio files and video files; e.g., multiple separate audio files; e.g., multiple separate video files).

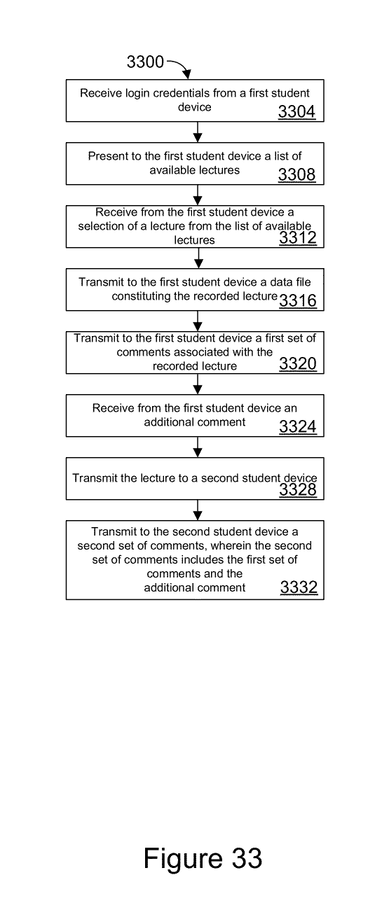

FIG. 33 shows a process 3300 by which students can collaborate according to some embodiments. At step 3304, the server may receive login credentials from a first student device. A student may log in via a personal computer, tablet computer, laptop, smartphone, or any other student device. Student credentials may include such things as username, handle, name, password, student identifier, identifier, social security number, unique code, credit card number, thumb print, retinal scan, voice reading, biometric, or any other login credentials. A student may log in via a web browser pointed to a web page served by the server, via a native software application, via a third-party website (e.g., via a third party website that provides a branded face to the system; e.g., via a University website), or via an other means.

In various embodiments, once a student or other user logs in, they are presented with a dashboard, menu, or other selection of options, messages and/or other functionality. The dashboard may include classes in which the student is enrolled, current alerts for the students (e.g., alerts about new lectures posted; e.g., alerts about responses made to the student's prior comments; etc.), an indication of the student's upcoming schedule, an indication of homework or other assignments due, an indication of upcoming special events, and/or any other information.

In various embodiments, the student may navigate from the dashboard to one or more additional screens and/or web pages. For example, the student may select a link or button on the dashboard in order to view more specific or specialized information. In some embodiments, specific or specialized information may be presented to the student initially upon login.

At step 3308, the server may present to the first student device a list of available lectures. These may include lectures that have been recorded and are available for student viewing. The list may be presented to the student in any suitable fashion. A lecture may be listed with such information as the class, lecture number, date of the lecture, time of the lecture, professor, room of the lecture, topic of the lecture, title of the lecture, subject of the lecture, and/or any other information about the lecture. In some embodiments, the lecture may be listed with one or more associated images or thumbnails (e.g., images of slides that were shown by the professor during the lecture).

In various embodiments, the server selects a list of lectures to present to a user based on various criteria. Such criteria may include one more of: (a) the lecture has been recorded; (b) the lecture is available for viewing; (c) the user is enrolled in the class for which the lecture was given; (d) the user is authorized to view the lecture; (e) the user attended the lecture in person; (f) the user has paid to view the lecture; (g) the user has paid for a lecture viewing service not specific to any given lecture; (h) the user has viewed all prior lectures in the series (e.g., all prior lectures in the class); and/or any other criteria.

At step 3312, the server may receive from the first student device a selection of a lecture from the list of the available lectures. The student may, for example, touch or click on a lecture. At step 3316, the server may transmit to the first student device a data file constituting the recorded lecture. The data file may include one or more video components (e.g., a video of the lecturer; e.g., a video of a presentation shown by the lecturer; e.g., a video of the audience), one or more audio components, one or more images (e.g., images of slides shown during the lecture; e.g., images of the blackboard or whiteboard from the lecture), one or more files (e.g., handouts given during the lecture or otherwise associated with the lecture), one or more items of supplementary material (e.g., readings that the professor has assigned or suggested for the given lecture), and/or any other item or information.

In various embodiments, the server may transmit to the student device more than one data file corresponding to a given lecture. For example, the server may transmit to the student device a first file with lecture video, and a second file with lecture presentation materials.

In various embodiments, the server does not explicitly transmit an entire file, but rather transmits a streaming data feed (e.g., a streaming video file; e.g., a streaming audio file) to the user device. As will be appreciated, various embodiments contemplate other ways in which a user may be provided access to a recorded lecture.

At step 3316, the server may transmit to the first student device a first set of comments associated with the recorded lecture. These comments may include comments made by other students about the lecture, comments made by professors, questions, answers, explanations, tips on studying, reviews of the lecture material, ratings, elaboration, and/or any other comments.

In various embodiments, the server may transmit to the student device a transcript of all or a portion of the lecture. The transcript may include a written record of what was said in the lecture. The transcript may include what was said by the lecturer, what was said by the audience, what was said on any videos shown, etc. In various embodiments, the server may transmit to the student device a translation of all or a portion of the lecture. The translation may include a translation of the lecture into another language. In various embodiments, the server may store a record of the preferred or native language of the student. Accordingly, the server may send the appropriate translation to the student. In some embodiments, the server sends a translation of a recorded lecture after the student has requested a translation.

It will be appreciated that various embodiments contemplate various ways in which transcriptions and/or translations may be transmitted to a student device. These may be transmitted at once or piecemeal, and with or apart from the main recording of the lecture.

After having received a recorded lecture, the first student may view/review portions of the lecture. The first student may view comments made by others. The first student may also make one or more comments of his own. For example, the student may indicate a portion of the lecture (e.g., touch a point on a time-bar associated with the lecture; e.g., touch a point in a transcript). The student may then type in a comment which will be associated with that portion of the lecture. For example, the student may wish to comment on what a professor said 22 minutes and 44 seconds into a lecture. In various embodiments, a student may comment about the entire lecture, or otherwise make a general comment.

In various embodiments, a comment may be written. In various embodiments, a comment may include a picture or illustration. For example, a student may post a picture of an equation he has written down as an explanation of something said in a lecture. In various embodiments, a comment may include a video, an audio file, and/or any other type or format of information.

A student may hit a “post”, “send”, “submit” or similar such button, and/or otherwise provide an indication that he wishes his comment to be entered, to be visible to others, etc. The comment may thereupon be transmitted to the server 2122.

At step 3324, the server may receive from the first student device an additional comment, e.g., the comment made by the student. The server may then incorporate the comment into a set or record of comments associated with the lecture.

In some embodiments, the comment from the first student may go through a filtering, verification, or other screening process. The process may screen comments that have inappropriate language or content, that have irrelevant content, that are offensive, that are duplicative, that are insulting, that promote a political view point, that promote a religious view point, that are meant as advertisements, and/or comments that meet any other criteria. In various embodiments, the screening process may be performed automatically by one or more software algorithms. In some embodiments, the process may occur by human intervention, e.g., by intervention of teaching assistants, professors, or administrators.

In some embodiments, other students may participate in flagging or filtering a comment. For example, a comment from the first student may be posted and may become visible to other students. Another student may tag the comment as “irrelevant”. Thereupon, the server may remove the comment, and/or may remove the comment after one or more further steps (e.g., after a confirmation from another student or teaching assistant that the comment is irrelevant).

If a comment triggers a flag, the first student may receive a message from the server informing him that his comment has been rejected and/or requires reworking. The student may be informed of reasons for rejecting or otherwise flagging the comment. In some embodiments, if a comment meets certain criteria, the comment may be submitted to a disciplinary committee for further action against the first student.

Assuming the first student's comment is successfully posted, at step 3328 the server 2122 may transmit the lecture to a second student device. For example, the second student may have requested to review the lecture.

At step 3332, the server 2122 may transmit to the second student device a second set of comments, wherein the second set of comments includes the first set of comments and the additional comment made by the first student. Thus, the comment made by the first student will have become available for other students to review. It will be appreciated that the second student may make further comments, which may in turn become visible to other students, and so on. In this way, multiple students may collaborate with one another. In this way students and professors may collaborate. In this way, any users may collaborate.

Although process 3300 has made reference to students, various embodiments contemplate that process 3300 also applies to teaching assistants, professors, administrators, audience members of a meeting, audience members of a lecture, interested parties, and/or to any other parties. Although process 3300 has made reference to lectures, various embodiments contemplate that process 3300 could just as well apply to seminars, readings, meetings, board meetings, discussions, debates, plays, musicals, performances, presentations, legal presentations, interviews, depositions, conferences, hearings, announcements, ceremonies, sermons, and any other discourse, and any other dissemination. In various embodiments, process 3300 may apply to non-live, remote, or pre-recorded presentations.

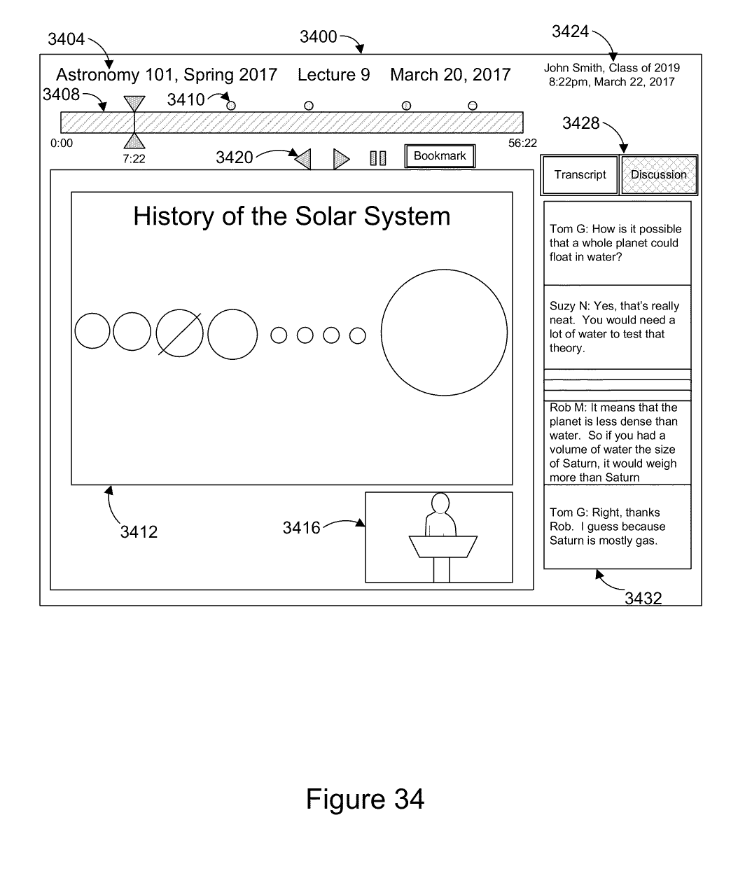

FIG. 34 shows an interface 3400 via which students can view lectures, according to some embodiments. Interface 3400 may represent a web interface, application interface, or any other interface, display, or software application. Interface 3400 may be shown to a student after the student navigates to a particular webpage. Interface 3400 may be shown to a student after a student has logged on to server 2122 and selected a particular lecture he wishes to review.

Interface 3400 depicts a particular lecture 3404, entitled “Astronomy 101”, which was taught in the Spring Semester of 2017, which represents the ninth lecture in the course, and which was delivered on Mar. 20, 2017. As will be appreciated, this is but an exemplary lecture, and a student could just as easily review any other lecture via a similar interface.

At 3424 is depicted information about the user logged in, including name and class, as well as the current date and time. In various embodiments, other information may be depicted as well, including class section, study group, etc.

At 3408 is depicted a time bar. The time bar may represent the timeline or duration of the lecture. A student may quickly navigate through the lecture by touching or clicking on a particular place in the time bar in order to reach the associated point in the lecture. For example, a student could touch the middle of the time bar to start viewing in the middle of the lecture. As depicted, a marker progresses through the time bar as the student watches the lecture. Currently, the student is at 7 minutes and 22 seconds into the lecture.

At 3410 is depicted a marker (e.g., a bookmark) that is placed on the time bar. A student may create a marker to note an interesting point in the lecture, a point for further review, etc. In various embodiments, markers made by one student may become visible to others. Thus, in various embodiments, a marker may server as an alert or message to another student to review the lecture from the designated point.

In various embodiments, markers may have different colors, patterns, sizes, shapes, etc. For example, one color marker may indicate a portion of a lecture that a student wishes to review later only for the final exam, while another color marker may indicate a portion of a lecture that the student wishes to review again in the near future. In various embodiments, a student may have the ability to customize a marker (e.g., as to color, shape, image depicted, etc.).

At 3420 are depicted various controls. These may include such controls as “play”, “rewind”, “forward”, “backward”, “pause”, and so on. These controls may have the effect of moving through the recorded lecture in the corresponding fashion. A “bookmark” control may allow a student to bookmark the current portion of the lecture. In some embodiments, upon pressing the bookmark button, a dialog box or other interface may appear through which the student can select the color of the bookmark, a tag for the bookmark, a description of the bookmark, and so on.

At 3412 is a first viewing window through which a student may view lecture content. Depicted is a slide from a slideshow that was shown during the lecture. At 3416 is a second viewing window through which a student may view lecture content. Depicted is an image of the lecturer. Various embodiments contemplate that more or fewer windows may be visible. For example, there may be a third viewing window, in various embodiments, for a second video feed from the lecture or for some other content.

In various embodiments, a student may have the ability to switch the sizes of viewing windows. In various embodiments, a student may switch which content or which feed is shown in which viewing window.

At 3432 is a panel with a series of comments about the lecture. In various embodiments, comments may be arranged chronologically. In various embodiments, comments may be arranged according to “threads” (e.g., according to which comments relate to each other), according to topic, according to speaker, according to relevant portion of the lecture, or in any other fashion. In various embodiments, comments may be searchable based on one or more factors. Such factors may include speaker, topic, tags, meta-tags, portion of the lecture, keywords, words, rating, etc. In various embodiments, a user may be able to screen or filter comments to view only a subset of the original comments. A user may filter by any of the aforementioned search factors, in various embodiments.

At 3428 are buttons which can toggle panel 3432 between a “discussion” and a “transcript”. In various embodiments, a user may press the “discussion” button in order to view comments. A user may press the “transcript” to view a transcript of the lecture. Various embodiments contemplate other buttons as well, including a “translation” button, buttons for various specific languages (e.g., “Spanish translation”), a “links” button for a list of links to supplementary materials, and so on.

As will be appreciated, interface 3400 represents some arrangements of elements according to some embodiments. However, various embodiments contemplate other arrangements of elements. Various embodiments contemplate that names, titles, videos, time bars, transcripts, slide shows, control buttons and any other elements may be placed in any suitable arrangement. Various embodiments contemplate that additional elements, or fewer elements could be used. Various embodiments contemplate that the depicted elements may be spread across multiple pages or interfaces. For example, a transcript may be on a separate page from a window showing a video of the lecture.

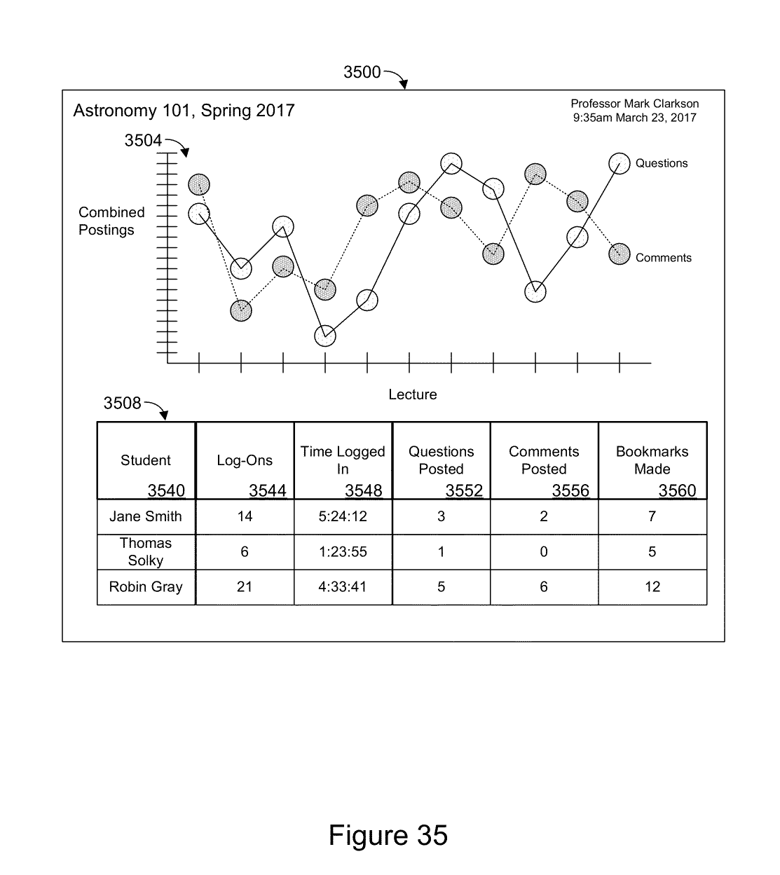

FIG. 35 shows an exemplary depiction of student participation, according to some embodiments. Interface 3500 may be visible, for example, to a professor or to an administrator. The interface may allow the professor to get a summary view of the degree to which students are viewing lectures, commenting on lectures, asking questions about lectures, and/or otherwise participating.

Graph 3504 shows a time series of participation as a function of lecture. The graph shows a time series for questions asked, and a time series for comments posted. As depicted, the graph represents an aggregate of questions and comments made by all students for a given lecture. However, in various embodiments, the graph may be customized to show data for a particular student, or a particular group of students (e.g., the group of students for which a particular teaching assistant is in charge).

At 3508 is depicted a table listing participation data for individual students. Such data may include the number of times a student logged on 3544, the total amount of time spent logged in 3548, the number of questions posted 3552, the number of comments made 3556, and the number of bookmarks made 3560.

Though FIG. 35 depicts certain types of data, various embodiments contemplate that other types of data may be tracked, aggregated, displayed, graphed, etc. Various embodiments further contemplate that other types of graphs, charts, tables, and other presentation formats may be used.

### Recorded Lecture Presentation

In some embodiments, a user may view a recorded lecture at a computer. The computer may be a personal computer, laptop computer, desktop computer, personal computer, tablet computer, mobile computer, mobile phone, personal digital assistant, an electronic book, or any other computer.

A user may view a lecture via a web browser. Exemplary browsers include Microsoft Internet Explorer, Mozilla Firefox, Google Chrome, Apple Safari, and the like.

A lecture may be presented via one or more viewing areas. Such areas may alternatively be considered viewing regions, windows, frames, boxes, or the like. Each viewing area may include a different type of content. In some embodiments, a first viewing area contains video of a lecture presenter, such as a professor. A second viewing area contains video of presentation materials, such as PowerPoint slides. A third viewing area contains a transcript of the lecture.

As will be appreciated, content shown in multiple viewing areas may originate from one file, or from multiple files. In some embodiments, there may be one source file for each viewing area, one source file for two or more viewing areas, or multiple source files for a single viewing area. For example, a first video file may show a video of a lecturer, and may play in a first viewing area. A second video file may show an animation presented by the lecturer, and may play in a second viewing area. However, in some embodiments, a video of a lecturer and an animation shown by the lecturer may be merged into a single video file. The single video file may then play in a single viewing area, or may occupy two viewing areas, or may occupy more than two viewing areas.

### Manipulating Viewing Areas

In some embodiments, a user may switch content shown in different viewing areas. For example, a first viewing area may be larger than a second viewing area. Initially, the first viewing area may show the presentation materials from a lecture, while the second viewing area shows a video of the lecturer. The user may wish to focus more on the lecturer, and so may click a button labeled “flip content” or having some other label. At this point, the first viewing area may now show the lecturer, and the second viewing area may now show the presentation materials.

In some embodiments, a user may drag and drop content between viewing areas. For example, if a user drags a video of a lecturer from a first viewing area to a second viewing area, then the video of the lecturer may now play in the second viewing area. In some embodiments, the content that had been playing in the second viewing area may now automatically move to the first viewing area. In some embodiments, the content that had been playing in the second viewing area may stop playing.

In some embodiments, a user may be presented with a list of content associated with a lecture or other event. The list may present the titles or other descriptions of available content, such as “Video of Lecturer”, “Presentation Materials”, “Video of Audience”, “Blackboard”, etc. The user may select, for a given viewing area, one of the items from the list. The associated content may thereupon appear in the viewing area.

In some embodiments, a user may resize one or more viewing areas. For example, if a user wants to get a better view of a professor giving a lecture, then the user may resize the viewing area in which the video of the professor plays. As will be appreciated, there may be various ways of resizing a viewing area, in various embodiments. For example, on a touch screen interface, the user may place two fingers in the viewing area and then spread the two fingers apart. On a personal computer, the user may drag and drop the corners or edges of the viewing area to resize it.

The Video with Time Bar

In various embodiments, a time bar 3408, time line, progress bar, or similar construct may visually indicate a user's progress through a lecture. The time bar may represent the duration of the lecture, with the leftmost terminus representing the beginning of the lecture, the rightmost terminus representing the end of the lecture, and points in between representing times during the lecture. As will be appreciated, there are many other ways by which a lecture might be represented, in various embodiments.

As a user views a lecture, an indicator on the time bar may progress gradually from left to right. For example, as the user reaches the midway point of the lecture, the indicator on the time bar may reach the midpoint of the time bar. The indicator may be an arrow or any other indicia, as will be appreciated.

In various embodiments, a user may quickly navigate to different portions of the lecture using the time bar. For example, the user may drag the indicator forward on the time bar to jump to a point later in the lecture. The user may drag the indicator backward on the time bar to jump to a prior point later in the lecture.

In various embodiments, a user may navigate to a point in time on a lecture by touching the time bar in a particular location, or by clicking the time bar in a particular location.

### Marking a Portion of a Lecture

In various embodiments, the time bar may allow one or more users to mark, tag, or otherwise notate certain points in the lecture, or portions in the lecture. For example, a user may place a little dot 3410 on the time bar (e.g., by touching the time bar). The dot may server as a bookmark. The user may use the dot to mark a point in the lecture that he regards as particularly worthy of further study.

In various embodiments, a user may tag a mark on the time bar. For example, a user may make a mark on a time bar, then enter text such as “interesting”, “first major point”, “dissenting opinion”, or any other tag.

In various embodiments a user may directly associated a tag or any descriptive words or images with a time point in a lecture, regardless of whether there is a corresponding mark placed on the time bar.

In various embodiments, a user may return to a portion of the lecture by touching a mark on the time bar. For example, if a user touches a mark placed at 5 minutes and 42 seconds into a lecture, then the lecture may begin playing from the point 5 minutes and 42 seconds into the lecture.

In various embodiments, a user may use different types or styles of marks. For example, a user may make marks in different sizes or shapes. A user may use different types of images as marks. For instance, a user may make a red mark to note a portion of a lecture that was confusing, and may make a green mark to note a portion of a lecture that he found particularly insightful.

In various embodiments, marks made by a first user may be visible to a second user. For example, a second user may see that a first user has placed a mark on a time bar of a lecture. The second user may respect the opinion of the first user, and may accordingly review the lecture starting at the point marked by the first user.

In various embodiments, a mark is placed on a time bar. In various embodiments, a mark may be placed within a transcript. As will be appreciated, various embodiments contemplate various other ways by which a user may mark or tag a particular portion or particular moment in a recorded lecture.

### Control Buttons

In various embodiments, one or more control buttons may be available to the user for navigating through a recorded lecture. Control buttons may include buttons to play, stop, pause, fast forward, rewind, go in slow motion, go backwards in slow motion, etc. Control buttons may have any suitable labels, including text labels (e.g., “play”), or symbolic labels. A user may utilize the control buttons in any suitable fashion, such as by touching them, or clicking on them.

In various embodiments, a user may use other means to control the presentation of a recorded lecture, or of any other content. For example, dragging his finger quickly along the time bar may cause the content to fast forward, whereas dragging his finger backwards may cause the content to rewind.

### Transcript

In some embodiments, a transcript may include a written version of a lecture. For instance, the words spoken by the lecturer may be put into written form. A transcript may confer a number of benefits and or uses. A transcript may allow those who are hearing impaired or unable to listen (e.g., due to a noisy environment) to still view the content of the lecture. A transcript may allow a user to more quickly review the lecture than would be possible through audio alone. For instance, a user may be able to skim a transcript faster than he can listen to a lecture.

In some embodiments, a transcript may serve as a basis or “hook” for supplementary material, comments, highlights, bookmarks, and other layers of information. For example, different portions of the transcript may be hyperlinked to supplementary Web pages with additional content on the topic of the lecture.

In some embodiments a transcript may serve as a basis for comments. For example, a comment may be tied to a particular word or a particular sentence in a transcript. The word or sentence may be underlined, highlighted, or otherwise distinguished. A user may then view the associated comment by clicking on the word, touching the word, or using any other indication of a desire to see the comment.

Once a user has indicated interest in viewing a comment, the comment may appear. The comment may appear in a different viewing window, as a different browser tab, as a different browser window, as a different window, and/or may appear in any appropriate fashion.

In some embodiments, a transcript may include words spoken by a lecturer. In some embodiments, a transcript may include words spoken by a student or other class or seminar participant. In some embodiments, a transcript may include words from presentation materials. In some embodiments, a transcript may include descriptions of actions or demonstrations performed. For example, a transcript may include a note that says, “The professor now holds up a small red ball and a large green ball.” In some embodiments, a transcript may include a description of non-text items in presentation materials. For example, the transcript may include a description of an image shown in a slide show, or a description of a video or animation shown by the presenter.

### Comments

In various embodiments, a user may post a comment. The comment may pertain to a recorded lecture, in various embodiments. As will be appreciated, the comment may pertain to a seminar, video, or any other content or information. A comment may be a question, an answer to a prior question, an elaboration, a clarification, a reaction to a prior comment, or anything else. A comment may consist of text, images, videos, hyperlinks, or any other information.

In various embodiments, a comment may be associated with a particular moment in a lecture. For example, a comment may be associated with the point of time of 14 minutes and 12 seconds into a lecture. Accordingly, for example, the comment may be a question about what a professor said in the moment just prior to the 14 minute and 12 second point in the lecture.

A comment may become associated with a point of time in a lecture in various ways, in various embodiments. In some embodiments, a user may be watching a recorded lecture on his user device (e.g., tablet computer). The user may reach a confusing point in the lecture, and may touch a “pause” button in order to freeze the lecture at a moment in time. The user may then touch a “comment” button (or similarly labeled button). The user may then type a comment. The user may then, for example, touch a button labeled “post”, or “send”, or “complete”, or “submit” or the like. The comment may then become associated with the point in time at which the user has paused the lecture.

In some embodiments, a user may indicate a portion of a transcript that will be associated with a comment. For example, the user may indicate he wishes to post a comment associated with a particular sentence in a transcript. For instance, the user may highlight a sentence in the transcript and then touch a “comment” button. The user may then type in his comment and submit the comment. The comment may then become associated with that point in the transcript and/or with a corresponding point in the lecture. For example, if that point in the transcript corresponds to what was spoken at 22 minutes 5 seconds into the lecture, then the comment may become associated with the point in time of 22 minutes and 5 seconds into the lecture.

In various embodiments, when a user posts a comment, he may enter a time of the lecture with which he desires his comment to be associated. For example, after a user enters a comment, the user device may prompt the user to enter a time. The user may then enter a time. The user's comment may then become associated with the point in the lecture corresponding to the time entered by the user.

In some embodiments, a comment may be associated with a range of times. For example, a user may indicate that his comment pertains to the portion of the lecture from 5 minutes and 10 seconds through 8 minutes and 54 seconds. The user may indicate a range of times, for example, by entering digits corresponding to a beginning of the range and an end of the range. The user may highlight a segment of the time bar of the lecture. For example, the user may run his finger along the time bar of the lecture, starting at 5 minutes and 10 seconds and moving his finger to 8 minutes and 54 seconds. As will be appreciated, there may be many other ways with which a user may associate a comment with a portion of a recorded lecture.

In various embodiments, a second user may enter a second comment in reply to a first comment previously entered by a first user. Additional users may post further comments in reply to the first or second comments, and so on. In various embodiments, a chain of discussion may thereby form based on an initial comment and comments stemming from the initial comment. In various embodiments, the entire chain of discussion may be associated with the same point in time of the lecture as is the initially posted comment.

In various embodiments, a mark may indicate the presence of comments. For example, when a user posts a comment, the comment may become visible on the time bar associated with the recorded lecture. Thus, in some embodiments, a second user may see a mark on his time bar corresponding to a comment that has been posted by a first user. The second user may view the comment, for example, by clicking on the mark on the time bar.

In various embodiments, clicking on a mark for a given comment may allow the user to view an entire thread or discussion stemming from the comment.

### Translation

In some embodiments, a translation may be generated based on all or based on a portion of a transcript. The translation may be generated by a software program, by a translation service, a human translator, and/or any combination of the aforementioned. In some embodiments a user may be presented with a button or other means to switch languages. For example, if the transcript is originally in English, then a person may switch from English to his native language by clicking a button. The English transcript may thereupon disappear, and the translation of the transcript may then appear.

In some embodiments, a translation may be generated based on a user comment. For example, a first user may post a first comment in English. A second user may wish to read the comment in another language. Accordingly, the second user may click a button that says “translate comment” or something similar, and may thereby view a translated version of the comment.

As will be appreciated, transcripts, comments, and other text may be translated in advance in some embodiments, and in real time in some embodiments. For example, in some embodiments, when a user indicates a desire to view a translation, a pre-translated translation may be loaded. In some embodiments, when a user indicates a desire to view a translation, the translation may be generated in real time. In some embodiments, when a user indicates a desire to view a translation, the translation process may be initiated at that point, but may take some time to complete (e.g., 1 minute; e.g., 1 week).

### Different Fonts

In some embodiments, a user may adjust the font, the text size, the text spacing, or any other aspect of text shown to him. For example, a user may adjust the transcript of a lecture from 10-point font to 12-point font.

In some embodiments, different fonts are reserved for different participants. For example, comments from a professor are in a first font, comments from teaching assistants are in a second font, comments from students are in a third font, etc. In some embodiments, a given participant or type of participant may have more than one font reserved for them.

### Avatar

One or more users may have an associated image, symbol, or avatar. For example, a student in a class may upload a headshot. The system may associate the headshot with the student. Then, anytime the student posts a comment, the headshot may appear in association with the comment. As will be appreciated, the same may hold for images besides headshots.

### Comment Ratings

In various embodiments, a first user may rate the comment of a second user. For example, the first user may rate the comment as “helpful”, “not helpful”, “agree”, “like”, etc. In some embodiments, a first user may rate a comment with a numerical rating (e.g., between 1 and 5), with a number of stars, etc. As will be appreciated, various embodiments contemplate other ways in which a first user may rate the comments of a second user.

In various embodiments, the system may aggregate ratings of a comment by different users, and may generate an average rating or some other summary statistic.

In various embodiments, a user may view the ratings of a given comment, and use such ratings to determine whether or not the comment is worth looking at, or not.

### Removing Comments

In some embodiments, the system may remove a comment automatically under certain conditions. In some embodiments, the system may remove a comment if: (a) the comment receives a low rating; (b) the comment receives a predetermined number of low ratings; (c) the comment receives a low average rating; and/or (d) based on any other criteria.

In some embodiments, the system may screen comments for certain words or phrases. These may include profane or offensive words or phrases. If comments are found meeting certain criteria (e.g., are offensive in nature) then they may be removed automatically.

In some embodiments, a user may have one or more privileges revoked based on comments he has made. In some embodiments, if a user makes a comment that is removed, then the user's ability to post comments may be removed. In some embodiments, if a predetermined number of user comments are removed, then the user may have one or more privileges revoked.

### Privileges

In various embodiments, a user's ability to interact with the system may be governed by privileges. Privileges may give the user the ability to use certain functionalities of the system. In various embodiments, privileges may include: (a) the ability to post comments; (b) the ability to post a predetermined number of comments; (c) the ability to view comments of other users; (d) the ability to respond to the comments of other users; (e) the ability to create marks (e.g., marks on the timeline); (f) the ability to create marks that are visible by others; (g) the ability to make comments that are visible by others; (h) the ability to ask questions; (i) the ability to answer questions; (j) the ability to view one or more portions of the recorded lecture (e.g., the video of the lecturer; e.g., the video of the presentation materials; e.g., the video of the audience); (k) the ability to view the transcript; (l) the ability to view translations of the transcript; (m) the ability to fast forward; (n) the ability to resize viewing windows; (o) the ability to access supplementary content on the system (e.g., supplementary articles posted by a professor); and so on.

In various embodiments, privileges may include administrative privileges. Privileges may include the ability to admit new users to the system to revoke privileges of other users, to confer privileges to other users, to view information about other users, to access the accounts of other users, and so on.

### Dashboard

In various embodiments, a user may be enrolled in more than one course. Accordingly, in various embodiments, a user may access recorded lectures from more than one course.

In various embodiments, a single course may have more than one session or lecture. Accordingly, in various embodiments, a user may access recorded lectures from more than one course session.

In various embodiments a user may be presented with a “dashboard”, home screen, menu screen, or the like. The user may be presented with such a screen upon logging in, upon clicking a particular link (e.g., “home”), or upon various other circumstances.

The home screen may allow the user to select from among one or more recorded lectures to view. The available lectures may be indexed in various ways. The lectures may be indexed by course, by professor, by lecturer, by date, by room, by time of day delivered, by subject, by keyword, or in any other fashion, as will be appreciated. In various embodiments, a user may view a list of available lectures. The user may sort the list or tailor the list so that lectures are presented to him in a desirable fashion. For example, the user may wish to see a list of lectures sorted by date, or a list of lectures corresponding to a single course. Various button, menus, or other input mechanisms may allow the user to select an appropriate view of the available lectures.

In some embodiments, a user may view lectures: (a) of a given course; (b) on a given subject; (c) within a given major; (d) given by a particular professor; (e) from a given period of time; (f) from a given week; (g) from a given month; (h) from a given semester; (i) within a given minor; (j) given in a particular room; (k) given in a particular building; and so on. Various buttons or inputs may allow the user to see only those lectures meeting certain criteria (e.g., belonging to a particular course).

In various embodiments, a dashboard, home screen, menu, or other mechanism may allow a user to access metrics, reports, or other indications of participation by the user and/or by other users. For example, in some embodiments, a user may touch a button labeled “Activity”, in order to access one or more reports on other users' activity on the system.

In various embodiments, a dashboard, home screen, or the like may allow a user to change settings. Settings may include ways in which information is presented to the user, color themes used, arrangements of windows, language in which text is presented, font size, speed at which videos are played, and/or any other manner of function or presentation by the system.

In some embodiments, a user may configure how he will be tracked. For example, the user may provide permission or revoke permission for the system to track one or more of his interactions with the system (e.g., for the system to track how often he logged into the system).

As will be appreciated, though various arrangements and presentations of information described herein may be accessed from a home screen, various embodiments contemplate that such information could be accessed from other screens, from screens with other designations, from multiple areas, or in any other fashion.

In various embodiments, a screen (e.g., a home screen) may include a current date and/or time. In various embodiments, a screen (e.g., a home screen) may include an indicator showing any notifications, alerts messages, or other items of interest that have been received by the user and/or that have transpired. In some embodiments, a user may receive notifications when another user has posted a comment in response to a comment posted by the user.

In various embodiments, a notification, message, and/or alert may include an indication of one or more of the following: (a) a new recorded lecture is available; (b) a new transcript is available; (c) a new comment has been posted; (d) a new comment matching certain criteria has been posted (e.g., a comment containing certain key words has been posted); (e) a new comment has been posted by a certain user; (f) a new item of supplementary material has been posted; (g) a rating has been posted; (h) a rating has been posted for a comment made by the user; (i) a comment has been posted in response to a comment that was posted by the user.

### Settings

In various embodiments, one or more settings may govern the look and feel of a user interface, or any other behavior of the software. Settings may dictate: (a) the background color of the user interface; (b) the theme of the user interface; (c) any other color or image scheme of the user interface; (d) placement of one or more buttons on the user interface; (e) the information that appears on the user's home screen, login screen, dashboard, or any other screen; (f) the size of one or more viewing windows; (g) the type of content that goes into one or more viewing windows; (h) the people about whose messages the user wants to receive alerts; and/or any other aspects of the software and/or system.

In various embodiments, a user may adjust settings. For example, a user may go to a “settings” page or some other page where the user may change one or more settings. In various embodiments, an administrator may make one or more global settings changes. For example, an administrator may make a settings adjustment that changes the background color scheme for all users of a system.

### Private Study Rooms

In some embodiments, a subset of users of the system may be able to post comments, make marks on the time bar, highlight portions of the transcript, post supplementary materials, etc., in such a way that only the given subset of users can see what the other users have done. In this sense, the subset of users may effectively have a private virtual study room in which they can exchange notes and comments, but where others do not see what they are doing. In some embodiments, a format such as this may reduce the inhibitions of certain users. E.g., a user may be afraid that his comment would be ridiculed, so he may prefer that only a few people within his study group see the comment.

In various embodiments, a private virtual study room may allow users the freedom to express themselves without worry that faculty would see their comments.

As will be appreciated, private virtual study rooms or similar set-ups may be created in various ways. In some embodiments, a first user creates a “group”, “team”, “study room”, or similar construct. The first user may then invite one or more other users to join the group. In some embodiments, other users may express a desire to join the group without prompting. In some embodiments, one or more existing members of a group may have to approve the admission of a new member to a group. In various embodiments, admission may occur by vote. In some embodiments, groups are assigned (e.g., automatically by the system according to predetermined criteria, e.g., by a professor, e.g., by a teaching assistant).

### Highlights

In various embodiments, a user may highlight a portion of a transcript, translation, question, comment, or any other information. The highlights may remain private to the user. In some embodiments, the highlights may be visible to other users of the system. In some embodiments, a first user may be able to see the identity of a second user who has made a highlight. For example, the first user may hover his mouse pointer over a highlighted area of text, which may then make the name of the second user appear. In various embodiments, a first user may indicate one or more other users whose highlights he wishes to see. The highlights may then appear in his user interface.

Various embodiments contemplate other markings, markups, alterations, etc., that a user may make to text or other aspects of the system. These may then become visible to other users, in some embodiments. In some embodiments, these may remain private to the user.

### Reporting

In various embodiments, the system may track interactions with the system by one or more users. An interaction may include: (a) posting a comment; (b) posting a question; (c) viewing a comment; (d) posting supplementary material; (e) making a mark on the time bar; (f) making a bookmark; (g) rating the comment of another user; (h) rating a lecture; (i) rating supplementary material; (j) viewing a transcript; (k) viewing a translation; (l) viewing an entire lecture; (m) viewing a portion of a lecture; (n) resizing a viewing window; (o) highlighting a portion of the transcript; (p) highlighting a portion of a time bar; (q) indicating that a point is confusing (e.g., a point made in a lecture); (r) indicating that a point made is interesting; and so on.

In various embodiments, the system may track the ratings given to a user's comments. In various embodiments, the system may track the number of responses to a user's comments.

In various embodiments, the system may create aggregate data of user interaction with the system. Aggregate data may include: (a) total interactions by all users; (b) average interactions per user; (c) total interactions of a given user; (d) total interactions of a given user per unit time (e.g., per day; e.g., per week); (e) total interactions by a user for a particular course; (f) total interactions by a user for a particular lecture; (g) interactions of a particular type (e.g., questions; e.g., comments; e.g., postings of supplementary materials; e.g., viewings of a lecture); (h) uses of the system by an individual user; (i) uses of the system by all users (j) viewings of a particular lecture by all users; and so on. As will be appreciated, many types of aggregate data may be generated, in various embodiments. As will be appreciated, aggregate data may be generated over various time frames, scenarios, users, and types of interactions, according to various embodiments.

In various embodiments, the system may generate a report detailing one or more aspects of the system. In various embodiments, the system may generate a report detailing one or more interactions with the system.

### Student Microphones

In various embodiments, the system 2100 may utilize devices and/or equipment that is not fixed or installed in a classroom or other room. Such devices may serve as input devices. Such devices may include mobile devices, cellular phones, smart phones, music players, portable computer, laptop computers, tablets, notebooks, netbooks, personal digital assistants, and any other devices. Such devices may belong to students or to any other parties.

In various embodiments, mobile devices and other devices may include microphones, camera, or other input facilities. A student (or other party) may utilize his mobile phone (or other device) to record a lecture and/or aspect of a lecture. The student may then place the mobile phone in communication with the server 2122. In some embodiments, the student may call up a URL on his mobile phone, in which the URL is associated with the server. The student may then upload any recorded material to the server.

In some embodiments, the recorded material may include meta-information, such as a time at which the recording was made, and/or a location at which the recording was made. The location may include GPS coordinates, for example. As will be appreciated, mobile phones, and other devices, may include GPS sensors that may be capable of recording GPS data. The mobile phone may, in turn, associate such GPS data with a lecture.

In various embodiments, using meta-data about a lecture, server 2122 may determine the room in which the lecture was made, the time at which the lecture was made, and any other ascertainable information about the lecture. The server may then determine, (e.g., via cross-reference to a schedule), the title of the lecture, the class for which the lecture was given, the professor, and/or any other information about the lecture.

In various embodiments, a server may determine information about a lecture from the source of the captured lecture. For example, if a student uploads recorded lecture from a mobile device, the server may recognize the phone number of the mobile device, associate the phone number to a student, and then cross reference the student's name to a list of classes in which students are enrolled. In various embodiments, a student may explicitly enter information about a recorded lecture. For example, prior to uploading a recorded lecture to server 2122, the student may be asked to enter information about the lecture, such as the lecture name, title, class, professor, date, time, and/or any other information.

In various embodiments, a device may include an application (e.g., an “app”) that facilitates, streamlines, and/or automates one or more aspects of capturing and/or uploading recorded lectures. In some embodiments, an app may reduce student involvement to the pressing of a single or limited set of buttons (e.g., to pressing a “record” button). The app may thereupon record and upload a lecture automatically. Various embodiments contemplate other functionalities that an app may provide. For example, an app may add tags to a recorded lecture, perform processing on a recorded lecture (e.g., eliminate noise, e.g., compress), provide alerts if the device is not picking up good sound or video, and so on.

In some embodiments, a mobile device may upload a recorded lecture to a capture device. The capture device may be local, such as being in the same classroom. This may make it easier to perform the upload, as the capture device may be reachable via a short-range communication protocol (e.g., Bluetooth, e.g., Wi-Fi). The capture device may, in turn upload the recorded lecture to the server.

In some embodiments, recordings by student devices may provide additional information not available from a main recording. For example, during a class, students may be asked to break into smaller discussion groups to discuss a question amongst themselves. With multiple separate discussion groups, it may be difficult for a fixed microphone to capture all the different discussions. Therefore, individual student devices may be used within each study group to record the local discussion. These recordings may all then be uploaded to server 2122. Accordingly, server 2122 may have available recordings not only of a main lecture, but also of different splinter discussions that occurred during a class.

In various embodiments, as described herein, splinter or supplementary discussions may receive comparable treatment as does a main lecture or discussion. In various embodiments, a server may transcribe and/or facilitate transcription of a splinter discussion. Similarly, the server may translate and/or facilitate translation of the splinter discussions. Students and other parties may then have the ability to review splinter discussions, comment on them, ask questions, and so on.

In some embodiments, recordings from multiple devices may be used to enhance or reinforce one another. For example, two students in a class may record a lecture with their mobile phones, and upload the lecture to server 2122. The server may then combine the two recordings so as to enhance the signal versus noise ratio in the recordings.

### Tags

In various embodiments, a tag may be associated with a lecture. In various embodiments, a tag may be associated with a portion of a lecture. Such portion may include a time interval, a set of words or phrases spoken, a slide shown, a gesture made, an experiment demonstrated, and/or any other portion and/or any other aspect of a lecture.

In various embodiments, a tag may be associated with a comment and/or a portion of a comment. In various embodiments, a tag may be associated with a link. In various embodiments, a tag may be associated with an article, video, or other item of supplementary material.

In various embodiments, a tag may include word, a phrase, a set of words, a sentence, and/or any other text or writing, and/or any series or combination of the aforementioned. In various embodiments, a tag may include a picture, image, symbol, animation, video, piece of art, or any other representation. In various embodiments, a tag may include an audio portion.

In various embodiments, the existence of tags may facilitate searching, organization, reporting, and other uses of system 2100. For example, if a user wishes to search for comments on a particular topic, the user may be shown only comments with a tag matching the user's search terms. If a user wishes to review a portion of a lecture that discussed a particular topic, the user may similarly be shown only lecture portions whose tag matches the user's search terms.

In various embodiments, a user may create and/or associate a tag in various ways. In various embodiments, a user may press an appropriately labeled button, such as an “add tag” button. In various embodiments, a user may right click on a comment (or other piece of information) in order to generate a menu allowing the user to select a tag. In various embodiments, a user may click, double click, or otherwise select an item to be tagged.

In various embodiments, to add a tag, a user may type in the tag in a dialog box, use his finger to write the tag directly on the screen of his user device (e.g., utilizing handwriting recognition), speak a tag (e.g., into a microphone of his user device), or effectuate some other means of entry.

In various embodiments tags may be restricted to a discrete set of tags. For example, a user, other party, and/or the system may apply a tag, but the tag must be one of 25 possible tags. In this way, the system may enforce uniformity among the tags, and there may be a cleaner classification of information by tags. In various embodiments a user may select a tag to apply (e.g., to a portion of a lecture) from a drop-down menu of tags, or from some other discrete list of tags.

In various embodiments, the system 2100 may track and/or store tags in various ways. In some embodiments, the system stores a table that associates time intervals with tags. For example, the time interval from 2 to 3 minutes into a lecture may be associated with the tags “introduction”, “background”, and “important”. The time interval between 3 and 4 minutes may have other associated tags. In various embodiments, time intervals need not be of a particular length, but may vary (e.g., from one second to one hour). In various embodiments, time intervals may be overlapping.

In various embodiments, the system may store a table that associates words, sentences, paragraphs, or other portions of a transcript with tags. For example, each sentence in a transcript may be associated with tags.

In various embodiments, the system may store a table that associates comments and/or portions of comments with tags. For example, the table may list a comment identifier, the text of a comment, the person who posted the comment, the time at which the comment was posted, and one or more tags associated with the comment.

Various embodiments contemplate other ways of associating tags with information pertaining to a recorded lecture or to any other information.

In various embodiments, the system may create tags automatically. In some embodiments, the system may scan text and use onboard dictionaries, thesauruses, encyclopedias, references, word association lists, etc., in order to generate an appropriate tag for text. In this way, the system may generate tags for portions of a lecture transcript, for comments posted, for supplementary materials, etc.

In some embodiments, the system may utilize image recognition algorithms to tag images, slides, videos, or other elements presented during a lecture.

In some embodiments, the system may utilize optical character recognition algorithms, or other character recognition algorithms in order to tag slides that are shown as part of a lecture. Slides may be tagged with the actual words on the slides and/or with other words representing topics, summaries, etc.

In various embodiments, a tag may be created by various parties. Such parties may include students, professors, teaching assistants, third parties, former students, or any other parties.

In various embodiments, the system 2100 my record the number of tags made by students and/or by other parties. The system may generate summary statistics about the number of tags created or posted by students or by other parties. A professor may be able to access a record of a student and see how many tags were created by the student. In various embodiments, the creation of tags by a student may be used in determining the student's grade.

In various embodiments, a portion of a lecture may be tagged based on comments associated with the portion of the lecture. The system may extract key and/or recurring words in comments about a portion of a lecture, and make those words into tags about that portion of a lecture. Various embodiments contemplate other ways by which tags may be generated from comments.

In various embodiments, a tag may be generated automatically based on student behavior or other parties' behavior. For example, if many students repeatedly view the same portion of a lecture, then a tag of “important” may be generated automatically for that portion of the lecture. A tag may be generated based on the number of comments associated with a portion of a lecture, the number of questions, the amount of time students spend viewing that portion of the lecture, the amount of reference or supplementary materials linked to that portion of the lecture, and/or based on any other behavior.

In various embodiments, system 2100 may prompt one or more users to enter a tag. A user may be prompted, in various embodiments, for such reasons as: (a) the user is the first to review the pertinent portion of the lecture; (b) the user has entered less than a predetermined number of tags; (c) the user has entered more than a predetermined number of tags; (d) the user is known to have knowledge of the subject matter; (e) the user is has a certain grade in the class; (f) the user has posted a predetermined number of comments; and/or for any other reasons.

In various embodiments a student, professor, or other party may view summary data about the tags added by another party. In various embodiments a student, professor, or other party may view summary data about the tags added by themselves. Data viewable may include: (1) number of tags added; (2) number of items tagged; (3) total words used in tags added; (4) number of times added tags came up in a search (e.g., in a search by another user); and any other data. In some embodiments, a professor may view data about tags added by students in order to gauge the participation or involvement of the student. The professor may view a graphical depiction, such as a graph showing a number of tags added by lecture, by time period, or by any other unit of time or by any other unit of measure.

In various embodiments, a professor, student, and/or other user may be able to view data on what search terms were used. These search terms may be used, e.g., by students searching for particular topics, particular portions of a lecture, particular comments, or for any other information. For example, a professor may view a list of the top search terms used. In some embodiments, based on this list, the professor may gain a better understanding of what topics are interesting or confusing to students.

In some embodiments, the system may track search terms used by one or more students and/or other users. If a search term meets certain criteria (e.g., the search term is in the top ten most frequently used search terms; e.g., the search term has been tried more than fifty times; etc.) then a professor may be alerted as to the use of the search term and/or as to the need to extrapolate further on the topic(s) of the search term.

In various embodiments, a professor, instructor, teaching assistant, and/or other party may be prompted to take action based on the content of one or more tags. For example, if a tag includes the word “confusing” or “unclear”, then the system may prompt the professor to look at the information that was tagged, to post supplementary information, to post a response, and/or to take any other action. In various embodiments, such prompting of a professor may occur automatically via action of system algorithms.

In various embodiments, a professor or other party may be prompted to take action based on one or more comments made by a student (or other party). For example, if the system detects a question, the system may send a message to the professor urging him to respond to the question. In some embodiments, the system may detect the posting of a question, and may prompt a professor to take action if the question has not been answered within a predetermined time of its posting. In some embodiments, the system may prompt a professor to take action if it detects multiple similar questions (e.g., 5 similar questions); if it detects multiple similar comments; and/or if it detects activity meeting any other predetermined criteria.

In some embodiments, the system may prompt other students to take action based on activity in the system. For example, if a first student posts a question, the system may prompt a second student to post a response. The system may prompt more than one other student to post a response. The system may send a blanket notice to other students to post a response.

In some embodiments, the system may take action on its own in response to one or more questions. In some embodiments, if a question is posted about a topic, the system may post a link to supplementary material on the topic, the system may post an article on the topic, the system may post a link to a point in the current lecture where the answer can be found, the system may post a link to a point in another lecture (e.g., a prior lecture) where the answer can be found, or may take any other action. The system may take action based on a database associating key words or topics with links, articles and references. The system may use any suitable algorithm to take action (e.g., to take action automatically) based on posted questions. In various embodiments, the system may take action automatically based on any posted comment, and/or based on any other activity in the system.

### Alerts

In various embodiments, a student, professor, and/or other party may make a first posting. The first posting may be a question or comment, for example. Other users may then have the possibility to respond. A discussion thread may thereby be created.

In various embodiments, a user may be alerted when another user has responded to his posting. The user may see an alert when he logs in, on his dashboard, on his login screen, on his home page, in a particular section of any page (e.g., in the top right hand corner), etc., and/or the user may be alerted in any other fashion. In various embodiments, a user may be alerted via email, via text message, or in any other fashion. By alerting users that others have responded to their comments, the system may facilitate the rapid progression of discussions.

In various embodiments, a user may be alerted based on various occurrences in the system. A user may be alerted when: (a) any comment has been posted; (b) when a comment has been posted for a discussion thread in which he has participated; (c) when an answer to a questions has been posted; (d) when a questions has been posted; (e) when a new lecture has been posted; (f) when a transcript has been posted; (g) when a translation has been posted, and/or when any other event has transpired.

### Rankings

In various embodiments, a professor may view data about student participation or activity. Participation may include comments made, hours of lecture reviewed, hours spent on the system, etc.

In various embodiments, the system may display students in rank order by one or more metrics, such as by one or more participation metrics. For example, in some embodiments, the system may display students in rank order by number of tags made.

Having the ability to view students in rank order may facilitate grading. For example, professors may assign the top 20 students the grade of ‘A’, the next 20 students the grade of ‘B’, and so on. As will be appreciated, grades may also account for other areas of student achievement, in various embodiments.

### Anonymity

In various embodiments, legal constraints, school policies, privacy rules, and/or any other laws or regulations may limit the degree to which student identities may be revealed. In various embodiments, student identities may be obscured and/or hidden. Identities may be hidden from one or more of: (a) recorded lectures; (b) comments posted; (c) activities performed on the system; and/or any other activity.

In various embodiments, a recorded lecture may include audio and/or video of a student speaking. In various embodiments, student faces may be blurred out. In various embodiments, student voices may be fuzzed or otherwise distorted. In various embodiments, student voices may be masked or eliminated entirely, and replaced by text indicating what was said by the student. In various embodiments, if a student can be identified by a name tag, name plate, or the like, such may be blurred out as well. In various embodiments, the system may hide or obscure identities automatically. In various embodiments, the system may hide or obscure identities with human intervention. For example, a human may go through a recorded lecture using a video editing tool, and remove information that can be used to identify a student. As will be appreciated, various embodiments contemplate that identities may be hidden or obscured for any participants in a lecture or other forum, including for teachers, professors, teaching assistance, passive audience members, and/or for any other parties.

The following are embodiments, not claims:

B. A device for facilitating knowledge capture and learning, the device comprising:
a power supply;
a memory;
a communications interface; and
a processor, in which the processor executes instructions stored in the memory, and in executing such instructions the processor is operable to:
   receive an indication of a start time for a lecture;
   receive an indication of an end time for the lecture;
   receive an indication of a room for the lecture;
   determine a capture device that is in the room;
   direct the capture device to record audio of the lecture, in which the capture device is directed to begin recording audio at the start time and end recording at the end time;
   direct the capture device to record video of the lecture, in which the capture device is directed to begin recording video at the start time and end recording at the end time;
   receive from the capture device a first file encoding the recorded audio;
   receive from the capture device a second file encoding the recorded video;
   perform a processing step on the first file to create a third file constituting processed audio;
   create a fourth file encoding the processed audio and recorded video, in which the fourth file thereby encompasses a recording of the lecture;
   associate an index with the fourth file;
   transmit to a first user device a list of indices, in which the index is among the listed indices;
   receive from the first user device a first selection of the index;
   transmit the fourth file to the first user device in response to receiving the first selection;
   receive from the first user device an indication of a first comment and a first moment within the recording of the lecture;
   generate a first tag based on the first comment;
   associate the first tag with the first moment;
   receive from a second user device a second selection of the index;
   transmit the fourth file, the first comment, and an indication of the first moment to the second user device in response to receiving the second selection;
   receive from the second user device an indication of a search phrase;
   determine that the search phrase matches the first tag; and
   direct the second user device to present an indication of the first moment to the second user.
      B.1 The device of embodiment B in which, in directing the second user device to present an indication of the first moment to the second user, the processor is operable to:
direct the second user device to present the recording of the lecture starting from the first moment.
   B.2 The device of embodiment B in which the processor is further operable to:
receive from a third user device a request to view summary data about the first user;
determine a total number of comments made by the first user, in which the total number of comments includes the first comment; and
transmit to the third user device an indication of the total number of comments made by the first user.
   B.3 The device of embodiment B in which the processor is further operable to:
receive from a third user device a request to view summary data about a set of users, in which the set of users includes the first user;
determine a total number of comments made by the set of users, in which the total number of comments includes the first comment; and
transmit to the third user device an indication of the total number of comments made by the set of users.
   B.3.1 The device of embodiment B.3 in which the set of users includes a set of all students enrolled in a particular class.
   B.4 The device of embodiment B in which the processor is further operable to:
receive from a third user device a request to view summary data about the participation of a set of users, in which the set of users includes the first user;
determine, for two or more time periods, a number of comments made by the set of users in each time period, in which the number of comments made within one of the time periods includes the first comment; and
transmit to the third user device an indication of the number of comments made by the set of users in each time period.

In various embodiments, users may belong to study groups or other groups. In various embodiments, comments made by a given user may only be visible to other users within the group.

B.5 The device of embodiment B in which the processor is further operable to:
determine a first group that includes a first set of users;
determine a second group that includes a second set of users, in which the second set of users includes one or more users not in the first set of users;
determine that the first user belongs to the first group;
determine whether the second user also belongs to the first group; and
direct the second user device to present the first comment to the second user only if the second user does belong to the first group.
   B.6 The device of embodiment B in which, in performing a processing step on the first file to create a third file constituting processed audio, the processor is operable to:
determine a portion of the first file that corresponds to the voice of a student; and
masking the voice of the student in the processed audio.
   A. A device for facilitating knowledge capture and learning, the device comprising:
a power supply;
a memory;
a communications interface; and
a processor, in which the processor executes instructions stored in the memory, and in executing such instructions the processor is operable to:
   receive an indication of a start time for a lecture;
   receive an indication of an end time for the lecture;
   receive an indication of a room for the lecture;
   determine a capture device that is in the room;
   direct the capture device to record audio of the lecture, in which the capture device is directed to begin recording audio at the start time and end recording at the end time;
   direct the capture device to record video of the lecture, in which the capture device is directed to begin recording video at the start time and end recording at the end time;
   direct the capture device to record presentation materials from the lecture;
   receive from the capture device a first file encoding the recorded audio;
   receive from the capture device a second file encoding the recorded video;
   receive from the capture device a third file corresponding to the presentation materials;
   generate a transcript of the recorded audio based on the first file;
   create a fourth file encoding all of the audio, video, and presentation materials, in which the fourth file is created such that audio, video, and presentation materials are synchronized, and in which the fourth file thereby encompasses a recording of the lecture;
   associate an index with the fourth file;
   transmit to a first user device a list of indices, in which the index is among the listed indices;
   receive from the first user device a first selection of the index;
   transmit the fourth file and the transcript to the first user device in response to receiving the first selection;
   receive from the first user device an indication of a first comment and a first moment within the recording of the lecture;
   generate a first tag based on the first comment;
   associate the first tag with the first comment;
   receive from a second user device a second selection of the index;
   transmit the fourth file, the transcript, the first comment, and an indication of the first moment to the second user device in response to receiving the second selection;
   receive from the second user device an indication of a search phrase;
   determine that the search phrase matches the first tag; and
   direct the second user device to present the first comment to the second user.
      A.0 The device of embodiment A in which, in receiving an indication of a start time, the processor is operable to receive an indication of a start time from a learning management system.
      A.1 The device of embodiment A in which, in directing the capture device to record presentation materials, the processor is operable to direct the capture device to copy a presentation file from a laptop computer.
      A.1.1 The device of embodiment A.1 in which the presentation file is a Microsoft PowerPoint presentation file.
      A.2. The device of embodiment A in which the first file and the second file are the same file, and in which such file encodes both the recorded audio and the recorded video.
      A.3 The device of embodiment A in which the index indicates at least one of: (a) the start time; (b) the end time; (c) the room; (d) a name of a person who delivered the lecture; and (e) a title of the course with which the lecture is associated.
      A.4 The device of embodiment A in which, in generating the transcript, the processor is operable to:
transmit the first file to a transcription service; and
receive from the transcription service a fifth file containing the transcript.
   A.5 The device of embodiment A in which the first user device is one of: (a) a personal computer; (b) a laptop computer; (c) a desktop computer; (d) a personal computer; (e) a tablet computer; (f) a mobile computer; (g) a mobile phone; (h) a personal digital assistant; (i) an electronic book.
   A.6 The device of embodiment A in which the capture device is a dedicated computer.
   A.7 The device of embodiment A in which, in generating a first tag based on the first comment, the processor is operable to:
transmit to a third user device an indication of the third comment; and
receive from the third user device an indication of the first tag.
   A.8 The device of embodiment A in which, in generating a first tag based on the first comment, the processor is operable to:
select a word from within the first comment; and
generate the first tag such that the first tag consists of the word.
   A.9 The device of embodiment A in which, in generating a first tag based on the first comment, the processor is operable to:
transmit to a third user device an indication of the third comment;
transmit to the third user device a discrete set of available tags; and
receive from the third user device a selection of the first tag from among the set of available tags.

### Procedural Prompting

In various embodiments, a word or combination of words spoken in a lecture may take on special meaning, such as when read, recognized, or otherwise processed by a device and/or computer program, such as by server 2122, or by capture device (e.g., 2108). The word(s) may serve as one or more of: (a) commands; (b) delimiters for certain parts of the lecture; (c) indicators of the beginning or end of a part or section of the lecture; (d) indicators of a question for the students to answer (e.g., as a homework assignment); (e) indicators of an important point; and (f) any other indicators, delimiters, commands, or the like.

In some embodiments, words spoken may represent delimiters. The delimiters may come in pairs, with each pair including an opening delimiter and a closing delimiter. In various embodiments, such delimiters may be analogous to HTML or XML opening and closing tags. As such, the device that processes the words spoken may expect to see delimiters that come in pairs. The device may then take some action in regards to the content, words, video, audio, time, etc., that occurs between the two delimiters. For example, the device may cause all words in a transcript that lie between the two delimiters to be rendered in bold, to be highlighted, or to otherwise be transformed. In some embodiments, a device may alter the video between two delimiters, such as inserting a video segment from a secondary source into what was otherwise a straight video recording of a class lecture.

In some embodiments, the phrase, “The question is” may take on special meaning as an opening delimiter. The corresponding closing delimiter may be “So that is the question”. Between these two delimiters, for example, a professor may actually ask a question for the class to ponder. When the lecture is later processed (e.g., by server 2122), the text in the transcript between the opening and closing delimiters may be highlighted automatically. In this way, students may quickly scan through the transcript and see what question they were asked to ponder.

In some embodiments, a device reacts to words with special meaning by creating an HTML tag. For example, the device may insert a <b> (i.e., bold opening tag) after the phrase “The questions is”, and may insert a </b> (i.e., bold closing tag) just before the phrase, “So that is the question”. In some embodiments, the tags may be inserted into a transcript of the lecture.

In various embodiments, word(s) with special meaning may influence one or more aspects of a lecture. Aspects may include: (a) a written transcript of the lecture; (b) audio of the lecture; (c) video of the lecture; (d) video of slides, overheads, etc.; (e) slide presentations, overhead presentations, etc.; (f) supplementary material that is included with a recorded lecture (e.g., supplementary educational videos that are shown with a recorded lecture; e.g., 3D models that are stored and/or presented in association with a lecture); and any other aspects of a lecture. Influencing aspects of the lecture may include influencing the presentation of the recorded lecture, influencing the manner in which a lecture is recorded, influencing what is left out of a recording, influencing what else is presented with a lecture, and so on.

In various embodiments, certain word(s), phrases, and/or other sounds may have one or more of the following effects. A portion of a lecture may be caused to be not recorded and/or not presented. In some embodiments, only audio is omitted. In some embodiments, only video is omitted. In some embodiments, only a portion of a transcript is omitted. In some embodiments, only a portion of a slides/overhead presentation is omitted. In some embodiments, any combination of the audio, video, slides, and transcript is omitted.

In some embodiments, a recording may be stopped. In some embodiments, a recording may be started. Exemplary phrases are “Stop recording”, “Start recording”, “Off the record”, “On the record”.

In some embodiments, a camera may be commanded to zoom in, or to zoom out. For example, a professor may wish for a camera to get a closer image of a certain experiment that he is conducting for the class. Exemplary phrases are “Zoom in”, “Zoom out”, and “Magnify”, and so on.

In some embodiments a camera may be commanded to move and/or to change its area of focus. For example, the camera may be commanded to move right, left, up, and/or down.

In some embodiments a camera may be commanded to film at high speed. For example, a professor may wish to capture a high-speed record of an experiment where it might be possible to otherwise miss some information between frames. Exemplary phrases are “fast motion” and “slow motion”.

In some embodiments a camera may be commanded to film in high definition. In some embodiments a camera may be commanded to film at a lower definition. In some embodiments a camera may be commanded to film at a higher definition. In some embodiments, a professor may use words to specifically identify the definition at which he would like the camera to file, such as “high definition”, “ultra-high definition”, “1080p”, etc.

In some embodiments, word(s) and/or phrases with special meaning may be used to cause supplementary content to be included with a lecture recording. For example, a professor may wish for a supplementary quiz to be listed on a Web page where a student will play back a lecture recording. As another example, a professor may wish for a PDF of a scientific paper to be included on the Web page. A professor may wish to include supplementary video, audio, text, 3D models, graphs, etc. Exemplary phrases may include, “Check out the video clip of”, after which the professor may say the name of the video clip. The server may thereupon insert the video (or a link to the video) by the name given by the professor.

In some embodiments, a professor may use transitional words, delimiters, and/or other words to indicate the end of a topic and/or the beginning of a new topic. Exemplary phrases include, “Is everyone clear on that”, “Next topic”, “Next subject”, “Next section”, “Alright then”, and so on. Following use of such phrases, the server may break up the transcript into appropriate sections (e.g., place extra space between sections of the transcript; e.g., break up the transcript into separate pages), may break up a video of the lecture into smaller video segments, may break up the audio of the lecture into smaller segments, may break up slides of the lecture into smaller segments or groups of slides, may break up the lecture or components of the lecture in any other fashion, and/or may perform any other action based on transitional words, etc.

In various embodiments, a single word may take on special meaning. In various embodiments, a particular combination of words make take on special meaning. In various embodiments, a particular sound may take on special meaning. The sound may include, clapping, whistling, snapping, yelling, scraping, and/or any other sound and/or any other combination of sounds. The sound may or may not be human generated.

In various embodiments, gestures, expressions, or other motions may take on special meaning. For example, when a professor put both hands over his head, this gesture may indicate to increase the volume of recording. As will be appreciated, gestures, etc., may be recognized by various motion recognition algorithms, such as those used by Microsoft Kinect™, or via any other means.

The use of words, phrases, etc., with special meaning may present various advantages. In some embodiments, a professor may be able to modify or augment his lecture using just spoken words, without necessitating further work after class and/or without necessitating that he log in, specify changes, etc. In some embodiments, advantages may include the ability to make modification or augmentations to a lecture in real-time, when the professor is still in the moment and knows what he would like to change.

In some embodiments, authority to use words or phrases with special meaning may be limited. For example, only the professor may be allowed to use words, phrases, and/or other indicators to alter a lecture and/or recorded lecture. Therefore, in some embodiments, the server and/or other device may perform one or more verifications that words or gestures with special meaning came from an authorized party (e.g., from the professor). Verifications may include performing voice recognition (e.g., comparing the words with special meaning to other words in the spoken lecture to make sure that the voice qualities are similar); performing image recognition (e.g., recognizing that it is a professor making certain gestures; e.g., recognizing that a professor's lips are moving as certain words are being spoken, etc.); and any other verifications.

In various embodiments, a capture device may react to words with special meaning and/or other directives during a lecture and/or other presentation. The capture device may include voice recognition algorithms, image recognition algorithms, gesture recognition algorithms, and/or any other pertinent or useful algorithms. The capture device may react in such a way as to stop capturing (e.g., stop capturing video; e.g., stop capturing audio), start or resume capturing (e.g., resume capturing video; e.g., resume capturing audio), and so on.

In various embodiments, any other device may react to words with special meaning during a lecture and/or other presentation. For example, a server may receive a real-time or near real-time feed of audio or video from a lecture. The server may process the feed, determine if any words with special meaning are contained in the feed, and, if so, direct a capture device or other device to react accordingly. Other devices may include device managers, which may be devices located on school campuses that communicate with and/or control capture devices in individual school classrooms.

In various embodiments, a verbal prompt by professor might cause a camera (or video feed) to zoom into the board, so a user can see the board better.

In various embodiments, a “prompt” may occur via professor writing on the board. An algorithm may be used to recognize the professor's writing on the board, to interpret it, and to take some action (e.g, to highlight a certain portion of a transcript).

In various embodiments, words with special meaning may provide a directive to leave a blank space (e.g., within a transcript) to be filled in later. For example, a professor may be writing an equation on the board. The professor may wish for the equation to appear in the transcript. However, the equation may not be easily expressible in words. Accordingly, the professor may speak a directive such as “Add equation here”. The professor may later (e.g., after class) be prompted to enter in an equation (e.g., via user interface), to select an image to be inserted, etc. The blank may then be filled in based on what the professor does.

Words with special meaning may include instructions to load or insert a 3D model, or some other media. For example, a professor may say “Here you'll see a model of a building”, at which point an algorithm may understand to insert a pre-loaded 3D rendering of a building.

The following are embodiments, not claims:

Y. A device comprising:
a memory;
a processor that is caused to execute instructions stored in the memory to:
   receive an audio recording of a lecture;
   determine a transcript of the lecture based on the audio recording;
   determine a first location within the transcript of a predetermined first phrase;
   modify the transcript based on the first phrase; and
   direct the modified transcript to be presented to a first user.
      Y.x The device of embodiment Y in which, in modifying the transcript, the processor is caused to remove a portion of the transcript.
      Y.y The device of embodiment Y in which the processor is further caused to:
modify the audio recording based on the first phrase; and
direct the modified audio to be presented to the first user.
   Y.y.1 The device of embodiment Y in which, in modifying the audio recording, the processor is caused to remove a portion of the audio recording.
   Y.0 The device of embodiment Y in which the processor is further caused to:
determine a second location within the transcript of a predetermined second phrase; and
direct a media item to be associated with the second location, in which, in directing the modified transcript to be presented to the first user, the processor is caused to direct that the media item appear to the first user when the first user reaches the second location within the transcript.
   Y.1 The device of embodiment Y in which, in modifying the transcript, the processor is caused to tag a portion of the transcript for presentation in bold font.
   Y.3 The device of embodiment Y in which, in modifying the transcript, the processor is caused to create a blank space within the transcript at the location of the first phrase.
   Y.3.1 The device of embodiment Y.3, in which the processor is further caused to:
transmit a reminder to a second user to provide an input; and
receive from the second user a set of symbols,
in which, in modifying the transcript, the processor is caused to insert the set of symbols within the transcript.

In various embodiments, a portion of a transcript is rendered in bold between first phrase and second phrase.

Y.2 The device of embodiment Y in which the processor is further caused to determine a second location within the transcript of a predetermined second phrase, and in which, in modifying the transcript, the processor is caused to tag a portion of the transcript between the first phrase and the second phrase for presentation in bold font.
Y.2.2 The device of embodiment Y.2 in which the first phrase is “the question is” and the second phrase is “so that is the question”.

Various embodiments provide for the automatic breaking up of lectures into smaller segments. Advantages may include creating segments that are more amenable to a user's attention span, to the amount of free time a user may have, etc.

Z. A device comprising:
a memory;
a processor that is caused to execute instructions stored in the memory to:
   receive an audio recording of a lecture;
   receive a first video that shows a presenter delivering the lecture;
   receive a second video of supplementary content presented by the presenter during the lecture;
   determine a transcript of the lecture based on the audio recording;
   determine a first location within the transcript of a predetermined first phrase;
   determine a time into the lecture, in which the time is determined based on when the first phrase occurred within the lecture;
   separate the audio recording into a first audio portion that occurred before the time, and a second audio portion that occurred after the time;
   separate the first video into a first video portion that occurred before the time, and a second video portion that occurred after the time;
   separate the second video of supplementary content into a third video portion that occurred before the time, and a fourth video portion that occurred after the time;
   separate the transcript into a first transcript portion that includes speech that occurred before the time, and a second transcript portion that includes speech that occurred after the time;
   associate the first audio portion, the first video portion, the third video portion, and the first transcript portion into a first segment of the lecture;
   associate a first heading with the first segment;
   associate the second audio portion, the second video portion, the fourth video portion, and the second transcript portion into a second segment of the lecture;
   associate a second heading with the second segment;
   receive a selection of the first heading from a first user;
   receive a selection of the second heading from a second user;
   cause only the first segment of the lecture to be presented to the first user; and
   cause only the second segment of the lecture to be presented to the second user.
      Z.0 The device of embodiment Z in which the first phrase is “next topic”.

In various embodiments, a slide transition may be used to determine where a lecture should be broken up.

Z.1 The device of embodiment Z in which the processor is further caused to determine a point within the second video in which there is a change in an image presented, in which, in determining the time into the lecture, the processor is caused to determine the time based on the point within the second video and based on when the first phrase occurred within the lecture.

In various embodiments, student comments, questions, or other writings may be used to determine where a lecture is broken up.

Z.2 The device of embodiment Z in which the processor is further caused to:
cause the transcript to be presented to a third user;
receive a comment from the third user; and
receive an indication of a second location within the transcript with which the comment is associated, in which, in determining the time into the lecture, the processor is caused to determine the time based on the point within the second video and based on the indication of the second location.

In various embodiments, student listening, viewing, or other interactions with the material determines where a lecture broken up.

Z.3 The device of embodiment Z in which the processor is further caused to:
cause the audio recording to be presented to a third user; and
receive an indication of a second location within the audio recording at which the third user stopped listening to the audio recording, in which, in determining the time into the lecture, the processor is caused to determine the time based on the point within the second video and based on the indication of the second location.

In various embodiments, the server may listen for silence to determine where lecture is broken up.

Z.4 The device of embodiment Z in which the processor is further caused to determine a second location within the audio at which there is a change in volume, in which, in determining the time into the lecture, the processor is caused to determine the time based on the point within the second video and based on the indication of the second location.

### Live Questions

In various embodiments, a professor may be teaching a class which may include a large number of students and/or may include remote students (e.g., students viewing a live stream of the lecture). The professor may wish to accept questions from students, but it may be impractical or impossible to use the traditional method of hand raising.

In various embodiments, students may ask questions via a user interface (e.g., via a student user interface). The questions may be transmitted to the server, and from there may be transmitted to a professor device (e.g., a laptop; e.g., a mobile device). The professor may have a user interface open (e.g., a professor user interface), and the student questions may appear for the professor in the professor interface. As will be appreciated, various embodiments contemplate that questions may reach the professor by other means as well, such as via peer-to-peer transmission.

The student user interface may include one or more of: (1) an area to type questions; (2) an area to view video of a lecture; (3) an area to view a live stream of a lecture; (4) an area to view slides from a lecture; (5) an area to view a transcript of a lecture; (6) an area to view a closed caption feed of a lecture; (7) an area to view questions from other students; (8) an area to view a video of other students; (9) an area to view comments from other students; (10) an area to view answers from other students; (11) an area to see a list of other students, professors, users, and/or others who are logged in and/or viewing the lecture; (12) an area to engage in chat and/or instant messaging with other students and/or with other professors and/or with other user; and other areas.

In various embodiments, a user may have the opportunity to engage in more than one activity or action in a given area of a user interface. For example, a single area may allow a student both to ask questions of the professor and chat with other students.

When a student has submitted a question, the question may appear on the user interface of the professor. The question may appear in conjunction with one or more other pieces of information, including a student's name, student's picture, student location, student grade on the most recent test, and/or any other information.

In various embodiments, a professor may select a question that has been asked. The professor's user interface may present more than one question, in which case the professor may select from among the multiple questions. The professor may select a question by e.g., clicking on the text of the question, clicking on a button next to the question that says “select question”, or via any other means.

In various embodiments, prior to the professor selecting a question, a question may only appear on the professor's user interface. That is, other students may be unable to view the question. In various embodiments, once a professor selects a question, the question may appear on the screens of other students. In this way, other students may have context for a subsequent answer that the professor provides. In various embodiments, when a professor selects a question, his own user interface may highlight the question and/or may otherwise indicate that the question has been selected.

In various embodiments, when a professor selects a question, a chat session may be initiated between the professor and the student who asked the question. The chat session may consist of any one or more of text, audio, and video. A video chat session may include streaming video from the student. A video chat session may be initiated via WebRTC or via any other technology.

When the professor initiates a chat session, a video of the student may appear on the screen of the professor. In this way, the professor may be able to see a student who is remote. Other students may also be able to view the chat session between the professor and the student whose question was selected. In various embodiments, another student may be able to view videos of both the professor and of the student whose question was selected. In this way, other students may follow the discussion between the professor and the student who asked the question.

In various embodiments, having finished answering a first question (or for whatever other reason), the professor may select a second question. The second question may come from another student who is in a different place from where the first student is. Thereupon, a chat session may be initiated between the professor and the second student. The first student may be disconnected. Other students may then also be able to watch the chat session between the professor and the second student.

In various embodiments, a video of a student engaged in a chat session may come from a student device, such as from a webcam associated with a student personal computer, or laptop, or from a camera associated with a student mobile device.

In various embodiments, a video of a professor shown during a chat session may come from one or more of: (a) a professor device (e.g., a professor laptop with associated webcam); (b) a camera installed in a classroom (e.g., a ceiling-mounted camera). Various embodiments contemplate other places from which a video of a professor may originate. Similarly, in various embodiments, audio for a professor may originate from a professor device (e.g., from a professor laptop and associated microphone), from an in-classroom microphone, and/or from any other place.

In various embodiments, students may submit questions to a professor during a live lecture or other class session. In some embodiments, the questions may be visible to other students before they are selected by the professor. In some embodiments, the questions may be visible to other students before they are visible to the professor. E.g., questions of other students may appear within the user interface of a given student.

In various embodiments, it may be advantageous to allow a student to answer the question of another student. This may help the other student arrive at an answer more quickly. It may also save the professor time addressing the question. In various embodiments, a first student can answer a question provided by a second student. The first student may select the question of the second student, or may simply begin typing in an answer beneath the second student's question. The first student's answer may become visible to the second student (e.g., on the user interface of the second student). The first student's answer may become visible to all other students. The first student's answer may become visible to the professor. In various embodiments, other students and/or the professor may respond or reply to the answer given by the first student. For example, other students may rate the answer as good or bad, satisfactory or not, etc. Other students may also provide answers. In various embodiments, an entire discussion thread may be initiated in association with a student's question.

In various embodiments, a student who asked a question may mark it as resolved. For example, another student may have satisfactorily answered the question, or the professor may have gone on to answer the question just incidentally during the lecture. For example, the student may click a “resolved” button or the like. Once resolved, a question may be removed from the list of questions displayed for the professor. The question may or may not remain visible to other students, in various embodiments.

In various embodiments, due to a large class, inquisitive students, or for any other reason, a large number of questions may flow in to the professor. The professor may not have sufficient time or willingness to answer them all. As such, or for other reasons, various embodiments contemplate methods for filtering down the number of questions that reach the professor.

In various embodiments, students may rate or vote on a question. Questions may then be presented to a professor in an order that is based on which has the most votes, highest rating, most “likes”, or based on some other aggregate statistic. In various embodiments, when a first student asks a question, the question may appear on the user interfaces of other students (e.g., of all other students). A second student may then have the opportunity to give the question a score, rating, vote, etc. For example, the second student may check a box associated with the question, indicating his vote for the question. The votes, ratings, etc. of all questions may be periodically or continuously (or in some other fashion) tallied by the server. The questions with votes, ratings, etc., that meet certain criteria (e.g., with votes above a certain threshold number of votes) may be presented to the professor.

In various embodiments, questions may be selected automatically according to some predefined criterion or criteria. Criteria may be defined, for example, in a way to help ensure diversity in terms of the questions asked, students asking the questions, participation rates of students, etc. In various embodiments, criteria for selecting a question may consider one or more of the following with respect to a student: age; gender; nationality; race; geographic location of residence; history of prior class participation; grades in the class; marital status; income level; current job; occupation; work history; and/or any other factors. In various embodiments, questions may be selected in such a way as to obtain a good mix or diversity in terms of any one of the aforementioned characteristics of the asker. For example, if questions have been selected from students located in North America and Asia already, then the next question may be selected from a student residing in Africa, Europe, or South America. As another question, if a prior question was from a male student, the next question selected may be from a female student. In this fashion, for example, classes may benefit from more diverse perspectives.

### Live Notes

In various embodiments, notes, comments, or other discussions created by a user (e.g., student) may be synced with a recorded lecture and/or with components of a recorded lecture. Syncing may include matching the times at which the notes were taken to corresponding time during the lecture. For example, if a student took a note at one hour into the lecture, then the note may be associated with a time one hour into the lecture. Accordingly, when the student later plays back a recording of the lecture, the student's note may appear on screen when he reaches the one-hour point in the lecture. As will be appreciated, various other means of presenting synchronized notes and lecture materials are contemplated.

In various embodiments, a note may include text, a set of keystrokes, symbols, pictures, etc. The note may include a written record taken by a student to help remember or clarify a point from a lecture. Thus, it may be advantageous to a student that he/she be able to view notes taken in the context when they were taken.

In various embodiments, a student listening or watching a live lecture may type in notes within a user interface (e.g., a student user interface). Each note may be associated with a particular time, which may be termed a “timestamp”. The time may be, e.g., the time at which the note was typed, the time at which a user started typing the note, the time at which a user finished typing a note, the mid-point time between when the student started and finished typing the note, or the time may be any other appropriate time, in various embodiments. The timestamp may later allow the server (or some other device) to associate the student note with a corresponding point in the lecture.

A note may include a set of keystrokes that are typed in a continuous or semi-continuous fashion (e.g., where there is no more than a predetermined temporal gap between any two keystrokes; e.g., where there is no more than a 0.5 second gap between any two keystrokes). A note may include a set of characters that do not include a particular character (e.g., that do not include a carriage return). A note may be defined in any other fashion, as will be appreciated.

In various embodiments, once a student types a note, the student may provide some indication that the note is complete. The student may provide such an indication by pressing “enter” twice. The student may provide such an indication by pressing “carriage return” twice. As will be appreciated, in various embodiments, various other numbers of keystrokes, and/or combinations of keystrokes may be used to signify the end of a note. In various embodiments, a student may press or click a button on a screen to indicate that a note has been finished.

In various embodiments, once a student has finished typing a note, the note may be given a time stamp. The note may also be associated with a given point in a recorded lecture (e.g., with the point in the lecture corresponding to when the note was taken).

### Surveys

In various embodiments, a professor (or other use) may administer surveys during a live lecture (or at some other time). A professor may have a button on his user interface (or some mechanism other than a button) by which he can instruct the system to transmit a survey out to the students.

Students viewing the lecture (e.g., via a student user interface) may see the surveys (e.g., once the professor has issued the aforementioned instruction.

In various embodiments, surveys may be preloaded into the system. E.g., the professor may upload a survey before class. The professor need only then select the survey and/or indicate at what point the survey should be transmitted out to students.

In some embodiments, the professor may create a survey during class. For example, the professor may verbally ask a question during class. The professor may then press a button on his user interface that initiates a survey. At this point, potential answers may appear on students' user interfaces. For example, a student viewing a live lecture may see the buttons “A”, “B”, and “C” appear on his screen. The buttons need not contain any more than simply letters, as the professor may also verbally indicate what answser “A”, “B”, and “C” correspond to. In some embodiments, potential answers are written out in text format. These answers may include machine and/or human transcriptions of answers that have been verbally spoken by the professor immediately prior. As an example, a professor might say in class, “Survey: Please indicate whether this reaction is A) Exothermic; B) Endothermic; C) Neither”. The system (e.g., a capture device; e.g., the server; e.g., a user device) may perform language recognition and may generate a graphical and/or text survey using transcription of the professor's spoken words. Thus, on a student's user interface, the buttons “A”, “B”, and “C” may appear, and each may appear with the corresponding possible answer next to it, i.e., “Exothermic”, “Endothermic” and “Neither” respectfully. As will be appreciated, various embodiments contemplate various other means by which surveys may be created and may be caused to appear for students.

In various embodiments, surveys may be pre-scheduled. Thus, in various embodiments, during a live lecture, surveys may automatically appear on students' user interfaces. The surveys may appear at pre-scheduled times. For example, a professor teaching a class from 1 pm to 2 pm may schedule a survey to appear automatically at 1:30 pm on the user interfaces of students following the lecture.

In various embodiments, a survey may be pre-loaded, but may not be broadcast and/or transmitted to students until the professor provides an instruction or other signal. For example, a professor may load a survey with a question, and possible answers already pre-loaded. The professor need then only press a “broadcast survey” or similarly labeled button in order to cause the survey to appear on the user interfaces of the students. A professor may also have more than one survey pre-loaded. The professor may then select one of the pre-loaded surveys to transmit to students when he desires. For example, each pre-loaded survey may have an associated button labeled “present” or similarly labeled. The professor need then only touch or click the button to have the associated survey sent out.

In various embodiments, a survey may appear for students in a text format. In various embodiments, a survey may appear in graphical format. In various embodiments, a survey may be presented to students in audio format. For example, a student may be following a lecture by listening to it on a mobile device, and may not be viewing any graphical presentation. Accordingly, such a student may listen to the survey (e.g., listen to the questions and possible answers) rather than seeing it appear in a text form. Other modes of survey presentation are also contemplated.

In various embodiments, the server or some other device (e.g., the professor device) may tally the results of a survey. The server may determine how many students gave answer “A”, how many gave answer “B”, and so on. One or more statistics may be generated based on the results of a survey, such as the percentage of students that gave a given answer, the percentage of students that voted, the median answer, the average answer, and/or any other statistics. Results of the survey (e.g., absolute tallies of answers, e.g., summary statistics) may be presented on the user interfaces of the professor and/or of the students. Results may be presented graphically, e.g., as a bar chart showing the votes for different answers.

In some embodiments, the server (or other device) may capture the user information of a student in conjunction with the student's answer. For example, as students may be logged in, the server may know when a given student (e.g., with a particular name, id, etc.) has provided a given answer. In various embodiments, student names, identifiers, screen names, etc., may be associated with student answers in a survey. The student identifiers may be presented to other students, so that, for example, other students may see who has given what answer to the survey. Similarly, in some embodiments, student identifiers may be presented to professors. In various embodiments, a professor may decide to call upon a student who has given a particular answer to a survey question, e.g., to ask the student what their reasoning was behind that answer. The professor may be able to click on the student's name (e.g., if the student name is listed as one of the students who has given a particular answer). The professor may then type a message, such as “Please explain your reasoning”. The message may then be transmitted to the student and appear on the student's user interface. The professor may also verbally ask the student, by name, to explain his reasoning. As will be appreciated other means by which a professor may ask students to justify or explain their answers are also contemplated.

In various embodiments, surveys need not have only a few possible answers (e.g., A-D). In various embodiments, surveys may have free form answers, including answers that are numerical or answers that require typing in a word, phrase, etc. A professor in a math class may ask students to key in the solution to an equation, while a professor in a language class may ask students to translate a particular phrase.

In various embodiments, once a student has provided an answer to a survey or to some other exercise, the correct answer may appear on the student's screen. In some embodiments, the correct answer may appear within a predetermined period of time after the survey has initiated. Also, explanations of one or more answers may also be shown.

In various embodiments, other forms of media, communications, etc., may be transmitted to students and/or caused to appear for students during a lecture. These may include short videos, videos, animations, graphs, images, simulations, tables, text, depictions of science experiments, etc. These may be designed to augment the material being taught in the lecture. In various embodiments, a professor may receive notice when one or more students has finished viewing, perusing, interacting with, etc., with an item of supplementary material.

### Attendance

In various embodiments, student attendance may be taken. Attendance may be taken automatically based on which students are logged in, based on which students are currently viewing a live stream or broadcast of a class, based on which students have answered a survey question, or based on any other means. In some embodiments, a survey question explicitly just asks student to respond. E.g., “Are you here?”. The answer may serve as a means of taking attendance. In some embodiments, attendance may be taken multiple times during a class.

In some embodiments, a students may be asked to indicate their attendance by pressing a button, clicking a mouse, touching a screen, pressing a key, or taking any other action The student user interface may relay the activity at the student device to the server, which may then track the student activity (which may be tied to the student's login session), in order to determine that the student is present. There may be some limited period of time during which a student must prove attendance. For example, a professor may say verbally, “You now have 1 minute to press the “I am here” button. The professor may activate an attendance initiation button. A timer might then start (e.g., for 1 minute). All signals from students received during the minute may then be tallied, and the students counted as an attendance.

In various embodiments, a student may be required to indicate attendance multiple times during a lecture. In some embodiments, each student in a class might be asked to indicate attendance at a different time. A student may be asked to indicate attendance at a random time during a class. In this way, for example, it may be more difficult for a friend to log in for a student and falsely claim that the student was viewing the lecture. The friend would not know when the student would be required to indicate attendance. For example, when a given student is logged in, a “confirm attendance” pop-up icon or other message may require the student to take some action (e.g., click a button) within some period of time. The pop-up may appear at different times for each student, so that students won't know general times during which they should cover for their friends.

In some embodiments, students may be required to submit biometrics, identification, or some other identifying information in order to verify attendance. In some embodiments, to indicate attendance (e.g., that a student is logged in and viewing a live lecture), the student may submit a photo, image, or the like. The photo may be taken by the web camera of the student's device, or by any other means. In some embodiments, the students may be required to submit a short video clip, e.g., taken by their computer's webcam. In some embodiments, students may be asked to speak a word, phrase, sequence of numbers, etc., for the video clip. The student may be asked by a pop-up on their user interface. The word, phrase, etc., may be randomly generated. The word, phrase, etc., may be unique to each student and/or unique to each class. In some embodiments, a student need only key in or type the word/phrase that he is asked to submit. In some embodiments, a student may enter a password, answer a secret question, or provide some other personal or secret information in order to prove attendance.

### Participation Via Mobile

In various embodiments, a student logged in or otherwise viewing or participating in a live lecture may have a differing experience depending on the device with which he is logged in. The experience may be different with a mobile phone, versus a slate computer, versus a laptop, versus a desktop, versus an e-reader. The experiences may also differ based on screen size, presence of a keyboard, presence of a touch screen, and or based on any other factor. In some embodiments, the user experience and/or user interface may differ depending on the model of the user device, the manufacturer of the user device (e.g., Samsung versus Apple), the operating system on the user device (e.g., iOS versus Android), and/or based on any other factor. In some embodiments, experience may depend on bandwidth.

In various embodiments, a user device (e.g., a mobile device) may provide only audio from a live lecture, and may not show video (e.g., video of the professor lecturing). This may save on bandwidth in an environment whereby the user device may have limited bandwidth, bandwidth may be expensive, etc.

In various embodiments, a user device (e.g., mobile device) may show only closed captioning and/or a transcript (e.g., a live, computer generated transcript; e.g., a live human generated transcript). In various embodiments a user device may show only video.

Thus, for example, if one student is viewing a live lecture from a personal computer, the student may see a video, may hear audio, and may see note from other students. However, another student attuned to the same lecture via a mobile device may hear only audio of the lecture.

In various embodiments, a student may have the ability to toggle among two or more different viewing/participation modes on his mobile device. In some embodiments, a student may toggle among two or more of: (a) viewing a video of a professor; (b) viewing a live stream of a professor; (c) viewing a slide presentation; (d) viewing a video of another student; (e) viewing a video of another student; (f) viewing a live stream of another student; (g) listening to audio; (h) viewing a video of a slide presentation; (i) viewing closed captioning; (j) viewing a transcript. Various embodiments may include the possibility of other modes as well.

To toggle between two different viewing/participation modes, a student may click a button, swipe a touch screen, touch an area of a touchscreen, move his device, tilt his device, or perform any other action and/or combination of actions.

By allowing a student to engage with just a single viewing/participation mode at a time, real estate on the screen of a user device may be conserved, in some embodiments. For example, the screen of a mobile device may be too small to allow easy viewing of both video and a transcript. Accordingly, by allowing a student to toggle between one or the other, the student can use the entire screen to view only one thing (e.g., video; e.g., transcript).

### Participation Via Buttons

In some embodiments, a student device may serve as a streamlined survey participation device. The device may be configured (e.g., while running a user application, e.g., while showing the user interface) to allow the student to easily answer surveys. In various embodiments, a user device has a small number of buttons displayed. There may be 1 button; 2 buttons; 3 buttons; 4 buttons; or 5 buttons in different embodiments. (In some embodiments, more buttons are contemplated.) The buttons may appear on a touch screen, in which case, a student need only touch the buttons.

In various embodiments, a student may use the buttons to answer questions, indicate attendance, or otherwise participate in class, such as in a live class. Buttons may be labeled (e.g., “A”, “B”, “C”, etc.; e.g., “1”, “2”, “3”, etc.). A professor may ask a question in class, and/or a questions might otherwise be communicated to a student. The student may then have the opportunity to press or activate a button on his user device. The button may correspond to a possible answer to the question asked in class. The answer may then be transmitted back to the server. A student's answers, and/or aggregate answers provided by the class, may then become visible to the professor and/or to other students.

### AV Check

In various embodiments, it may be desirable and/or advantageous for a professor to check that a class is being properly recorded. Various embodiments may allow a professor to check that one of more of the following is occurring: video of the class is being recorded; audio of the class is being recorded; video of a slide presentation is being recorded; the output of a laptop is being recorded (e.g., the video out; e.g., audio out); the output of any device is being recorded; and any other video, audio, or other datastream is being recorded. In some embodiments, the professor's user interface may show an icon corresponding to each item that is being checked for proper functioning or operation. For example, there may be an icon for a microphone, for a video camera, for an overhead projector, for a slide projector, for a laptop feed, etc. The icon may take on different colors to represent different statuses. For example, the color “red” may indicate that something is not happening (e.g., no audio is being picked up from the microphone; e.g., no video is being received from a camera, e.g., no feeds are being received from student devices; e.g., no feed is being received from a slide projector). A color green may indicate that a particular item is functioning properly.

In various embodiments, an administrator, student, or other party may be able to check (e.g., via a user interface) the functionality of one or more system components (e.g., the functioning of a camera, etc.)

In various embodiments, a professor or other party may check an actual output from an item, feed, etc. The output may be a full output or some form of compressed or attenuated output. With respect to a camera, a professor (or other party) may be able to see a video stream with small dimensions (e.g., 160×90), with small frame rates, as still frames, with high compression etc. It may not be important that the video show detail so much as the fact the camera is working. With respect to audio, a professor (or other party) may view a volume level of an input at a microphone, a waveform, or any other indicator or characteristic. With respect to a feed form a laptop, slide projector, etc., a professor may be able to view individual frames, a stream with compressed dimensions, etc. Various embodiments contemplate other means by which a professor (or other party) may verify that audio-visual equipment is functioning properly.

In various embodiments, a class may involve participation from remote students, e.g., via live video chat, WebRTC, etc. A professor (or other party) may be able to check that students can properly log in, that video (and/or audio) from a student's (or students') device(s) are being received properly, that text chat is being received properly, etc. A system according to various embodiments may test for any one or more of these and may cause an indicator to appear for a professor (or other party). In this way, for example, a professor may verify before classes start that students are able to connect via video chat, or other desired means.

Various embodiments contemplate that connectivity, functionality, proper operation of various equipment (e.g., Audio Visual equipment), and/or any other functionality may be checked at any suitable time, be it prior to a lecture, during a lecture, and/or after a lecture.

A system according to various embodiments may check audio quality. Checking of audio quality may including checking of noise levels, background noise, volume, presence of echoes or reverberations, signal to noise ratios, room impulse responses, and/or any other metrics of audio quality. In some embodiments, a system may record a sample of audio and feed it through a computer transcription algorithm. The transcription algorithm may return a score that details its confidence level at transcribing the audio into text. Various embodiments contemplate that any suitable score or metric may be used to grade audio on its comprehensibility, quality, and/or other characteristic. Based on the confidence level (or other metric) a professor (or other user) may be provided with a corresponding indicator. E.g., a microphone icon on a user interface may be shown in yellow if there is audio, but of poor quality. If there is audio of good quality, the microphone icon may appear green, while if there is no audio, the microphone may appear in red. The criteria for what color of microphone to use may be based on a whether or not a confidence score (or other metric) has crossed a particular threshold (e.g., 0.8).

### Start/Stop Recording

In various embodiments, a user interface (e.g., for a professor; e.g., for an administrator) may include button(s) or other control(s) to start or stop a recording. In various embodiments, a professor or other user may have a remote control, mobile device, or other device usable to start or stop recordings. Upon a user activating a control, a capture device (e.g., device 2108) may start or stop recording any one or more of: a video stream; an audio stream; a stream from a slide projector; a stream from a laptop; a stream from an overhead projector; and/or any other stream, feed, etc.

In various embodiments, the ability to control starting and stopping a recording may allow a professor to stop recording if a class has ended early, stop recording if a student comes up to talk about a personal matter, continue a recording if a class is going longer than planned, stop a recording if there is no lecture (e.g., if there is a test to be given during class), and/or start or stop a recording for any other reason. A user's instructions to start or stop may thereby, in some embodiments, override pre-scheduled recording times.

In various embodiments, only certain users have permission to direct the starting or stopping of recordings. A user may be validated via the device the user is using (e.g., if the device is a pre-approved device associated with the user), by the entry of a user password, via biometric, or via any other means.

Automatic Detection of when to Stop Recording

A system according to various embodiments may automatically detect when to start or stop recording. One criterion to stop recording is if there is a change in speaker. For example, if one party (presumably a professor) has been speaking for some period of time, and then another person begins to speak, then recording may be stopped automatically. For example, it may be presumed that a student has come up to the professor to ask a personal question, and so the question should not be recorded. In some embodiments, recording may be stopped if there are more than a predetermined number of changes in speakers. Presumably, for example, class has ended and students are chattering and/or speaking to the professor one-on-one.

In various embodiments, criteria for starting or stopping recording automatically may include: change in volume, change in background noise, change in speaker, absence of speech, absence of a speaker, absence of a speaker following the presence of speech from that speaker for a predetermined period of time, change in lighting, appearance of light, disappearance of light (e.g., classroom lights have been turned off), activation of slide projector, cessation of signal from slide projector, presence of a person in an image or video (e.g., presence of a professor in a video), presence of writing on a board, motion in a video, absence of motion in an video, cessation of motion in a video, and/or any other criteria.

### Dynamic Bandwidth Optimization

In various embodiments, users may face bandwidth constraints. Downloading high resolution videos of lectures, for example, may strain available Internet connections for some users. Such users may face interruptions while attempting to watch video (or interact with other types of data).

In various embodiments, two or more versions of a video may be available to a user. In various embodiments, two or more versions of an audio file, transcript file, video file, or any other type of data may be available to a user. In various embodiments, two or more version of a data stream may be available to a user. In various embodiments, where two or more versions of a file are available to a user, there may be a difference between the two in terms of file size. In various embodiments, there may be a difference between the two in terms of file size, download time, bitrate, frame rate, resolution, sample rate, streaming rate, compression rate, download size, download bandwidth required, and/or in terms of any other metric.

A user may have the opportunity to select between two or more files. A user may have the opportunity to select between two or more data streams. For example, on a user interface, there may be displayed a first button labeled “480p video”, a second button labeled “720p video”, and a third button labeled “1080p video”. The user may select one of the options. Thereupon, the user may view a file, stream, etc., of the chosen characteristic.

The user's choice may effect the bandwidth required for viewing. As such, a user with a high-bandwidth connection to the Internet (or other network) may choose a larger file, higher resolution file, etc., while a user with a relatively low-bandwidth connection may choose a smaller file, smaller resolution file, etc.

In various embodiments, the user device, the server, and/or some other device may automatically determine a connection speed, bandwidth, or the like, to a user device. Based on this determination, a version of a file or data stream may be chosen automatically, and/or recommended for a user. For example, if the server detects a low bandwidth connection, the server can stream a low-bitrate video stream to the user, while if the server detects a high bandwidth connection, the server can stream a high-bitrate video stream to the user.

In various embodiments, a connection may be periodically, continuously, a-periodically, randomly, occasionally, or otherwise polled. The polling may check for bandwidth, connection speed, etc. For example, a “ping” command may be used to check connection speed. The polling may be done by a user device, by the server, or by any other system, device, etc. Based on the results of the polling a file, data stream, or other set of data may be switched. For example, if a user with a mobile device moves from a geographic area with a high connection speed to a geographic area with a low connection speed, then the server may switch a streaming video of a lecture from a high-bitrate version to a low-bitrate version.

In various embodiments, based on a user's connection speed, bandwidth, or other circumstance, it may be determined whether or not to send a file at all. For example, a bandwidth may be determined, following which it may be determined whether to transmit: (1) a video stream with an audio stream; or (2) an audio stream only with no video. In some embodiments, a determination may be made as to whether or not to send a video, whether or not to send a particular video (e.g., a video of a professor; e.g., a video stream from a professor's laptop; e.g., a video stream from an overhead projector) whether or not to send an audio file or stream, and/or whether or not to send a transcript.

In some embodiments, a file or stream may be selected for transmission to a user based on whether or not there is “action” going on in the file or stream.

In various embodiments, a file or stream may be selected for transmission to a user based the content of the file or stream. A video may be selected if there is motion. A video may be selected if there is any one or more of: (1) a particular image that appears in the video; (2) a human face that appears in the video; (3) writing that appears in the video (e.g., written words); (4) a whiteboard or blackboard that appears in the video; (5) an object that is in focus that appears in the video; and/or any other characteristic. An audio file may be selected if there is any one or more of: (a) sound; (b) sound within a given frequency range; (c) sound above a certain volume; (d) detectable human voice; and/or any other characteristic.

For example, a video in a classroom may show a whiteboard. If there is nothing on the whiteboard (e.g., the Professor is just lecturing and not writing), then there may be no need to transmit a video of the whiteboard. However, if the professor begins writing on the whiteboard, then the server (or some other device) may detect an image of written words in the video, and may then cause the video stream to be transmitted to a user. In various embodiments, an entire video file need not be transmitted to a user. Rather, only excerpts of the video deemed relevant may be transmitted to the user.

In various embodiments, which file, stream, etc., is transmitted to a user may be periodically switched. The switching may occur so as to select the file, stream, etc., deemed most relevant. For example, if a professor is writing on a whiteboard, then a video of the whiteboard may be transmitted to a user. However, if a professor switches to using an overhead projector connected to his laptop, then the output of his laptop may be transmitted to a user instead of a video of the whiteboard.

### Selection of Stream Based on What a User is Watching

In various embodiments, a file, stream, etc., may be selected based on the one to which the user is currently paying attention. In various embodiments, if a user is only paying attention to a first video, it may be advantageous not to transmit the second video at all. Bandwidth may thereby be saved, and the user may achieve better viewing performance for the video to which he actually is paying attention.

The server, user device, or any other device may determine a video, file, stream, etc. to which a user is paying attention in any of the following manners: (1) the video is open on the user's screen; (2) the video is enlarged on the user's screen; (3) the video is maximized on the user's screen; (4) the video is open on a user's screen, and another video is minimized on the user's screen; (5) the video is in a larger viewing window than the viewing window of another video; (6) the audio for the video is on; (7) the audio for the video is being played at above a threshold level; (8) the audio for the video is being played at a level higher than the audio for another video; (9) the video is at the forefront on the screen; (10) the video is at a particular location on the screen (e.g., in the middle); (11) the user's eyes are looking at the video (e.g., as determined based on a webcam or other camera associated with the user device); (12) the user indicates that he is paying attention to the video (e.g., by pressing a button, clicking on the video, etc.).

When a the server, user device, etc., has determined the video, audio, file, stream to which a user is paying attention, the server may take any one or more of the following actions: (1) increase the quality of the video, stream, etc. (e.g., by increasing the resolution; e.g., by increasing the frame rate; e.g., by increasing the bit rate; e.g., by using a less lossy compression algorithm, etc.); (2) cease transmitting other streams; (3) reduce the quality of other streams (e.g., by reducing bitrate, resolution, frame rate and/or etc.); and/or may take any other action.

### Human Based Selection of Streams

In various embodiments, a file or stream may be selected for transmission to a user based on a decision by a human being (e.g., based on a decision of a teaching assistant monitoring a lecture; e.g., based on the decision of a student, etc.). The viewer making the decision may monitor two or more files, videos, audio streams, etc., and may periodically choose which should or should not be transmitted to viewing users. The viewer making the decision may rank order files and/or data streams and may allow end users to determine which ones to view (e.g., select only the top ranking data stream; e.g., select the top 2 ranking data streams, etc.)

In various embodiments, the choice of which file type, data stream, resolution, etc. to send to a user may be made based on various criteria. The criteria may have an order of priority. In some embodiments, one criterion includes reducing the amount of pauses or interruptions that a user experiences while watching a video (e.g., while the video is buffering locally at the user device). In some embodiments, a criterion includes ensuring that a video is high-enough resolution that certain features are visible in the video (e.g., that writing on a blackboard is visible in the video). In some embodiments, a criterion includes ensuring that a user receives up-to-date information, e.g., for a live lecture. Criteria may be chosen by a user in some embodiments (e.g., via a selection on a user interface). Criteria may be chosen by the server (or by some other device), in some embodiments.

### Crowd Sourced Streaming

In various embodiments, a first data stream may be selected from among several candidate data streams for transmission to a first user based on the data streams that have been transmitted to other users. In various embodiments, a first data stream may be selected from among several candidate data streams for transmission to a first user based on the data streams that have been chosen by other users.

Statistics may be gathered on how many users have viewed a high resolution video version of a video versus how many have viewed a low resolution version of the same video. The version of the video that has been viewed more may be selected for transmission to the first user. In various embodiments, one advantage of selecting a data stream based on the actions of other users is that the behavior of other users may provide insight into the value of one data stream versus another. For example, if a video just shows a professor lecturing, then a low-resolution version of the video may be sufficient, and may be reflected in the viewing habits of most users. However, if a video shows a professor writing on the board in small print, then a high-resolution video may be required for viewing the whiteboard, and thus the majority of users may have selected the high-resolution video for viewing.

Various statistics may be gathered from users, in various embodiments. These may include: (1) the file or stream viewed by user(s); (2) the amount of time that a file or stream was viewed by users; (3) the connection speed (or bandwidth) of user(s); (4) whether a user switched from viewing one stream to another; (5)

Any of the above or other statistics may be used in determining which file, stream, etc. should be sent to a given user. For example, if a majority of users with a similar connection speed as the given user have viewed a particular version of a video, then the same version of the video may be recommended and/or selected for the given user.

### Google Glass

Various embodiments may include a wearable device. Various embodiments may include a wearable display. Various embodiments may include a wearable microphone. Various embodiments may include a wearable camera. In various embodiments one or more of: a display, microphone, and camera may be worn in the form of glasses. In various embodiments, one of the “lenses” of the worn glasses may include or act as a display. A wearer need then only look to the proper portion of a lense, or the lenses to see an output. (In various embodiments, there may be no lense, but rather a display near where a lense in glasses typically resides). The device may include a transmitter and/or a receiver, such as a wireless transceiver. The device may be operable to capture video (e.g., continuous video). The captured video may correspond to the direction in which the wearer is looking. In various embodiments the wearable device may be a Google Glass™ device or similar such device. In various embodiments, a wearable device may be worn by a professor, e.g., a professor teaching a class.

In various embodiments, a camera on the device may be used as a video feed, stream, etc. This may be transmitted to user devices. The stream may provide a close-up view of a whiteboard or blackboard for example, and may thereby provide better visibility than a camera situated in the rear of a classroom, for example. In various embodiments, a feed may be used from the wearable camera only when the device (which may include the camera) is in a certain orientation (e.g., is pointing towards the whiteboard). In various embodiments, orientation may be determined using motion sensors, position sensors (e.g., GPS), accelerometers, etc. Such sensors may be built into the wearable device. In some embodiments, orientation may be determined based on characteristics of the video feed (or other inputs) received by the wearable device. For example, if a large expanse of white is detected in the video feed, then it may be inferred that the professor is facing the whiteboard and thus that the video feed should be transmitted on to student viewers and/or should be recorded for later viewing.

In various embodiments, a microphone attached to the wearable device may receive audio. Such audio may include audio spoken by the professor. Such audio may be of good quality as it the wearable device may be proximate to the speaker, and less proximate to sources of background noise. The audio may be transmitted to a capture device (or other device), and/or may otherwise be recorded.

In various embodiments, student questions may be displayed for a professor on the display of the wearable device. The questions may be received from the server (which may in turn receive the questions from various user devices) or from some other device. The professor may then have the opportunity to answer questions without pausing to go to his laptop, or otherwise break his routine to view questions. In some embodiments, questions that are displayed for a professor may be color coded. For example, questions coming from South America may appear in one color, while questions coming from Europe may appear in another color. Various embodiments contemplate other information which may be communicated via color (e.g., age of asker, demographic of asker, pre-vetting by other students, etc. Various embodiments contemplate other means by which information may be conveyed to a professor (e.g., via font size, e.g., via font type, etc.)

A professor may view various other metrics associated with a class on his wearable device (or in any other location). The professor may view how many students are currently logged in, the breakdown by demographics of how many students are logged in, the number of questions that have been submitted, the number of notes that have been taken, and/or any other statistics. A professor may conduct surveys during class. The professor may see the results of his surveys appear on his wearable display.

In various embodiments, as described herein, questions and/or comments may be vetted, pre-selected, voted upon, or otherwise filtered prior to reaching a professor. Only questions meeting predetermined criteria may be presented on the display of the professor's wearable device, in some embodiments. In some embodiments, questions may be color coded (or otherwise coded) based on the number of votes received, the approval of other students, etc. A professor may then have a ready means for selecting a question based on its color coding, in various embodiments.

Playing Back a Lecture with Student Notes

In various embodiments, a student can play back a lecture, and/or peruse a lecture component, and at the same time may see student notes in association with the lecture. In some embodiments, the student sees his/her own notes. In some embodiments, the student may see the notes of other students.

In various embodiments, a transcript of a lecture is created. Student notes are then inserted into the transcript at the appropriate time corresponding to when the notes were taken. For example, if a student has taken a note 30 minutes into watching a lecture, then the note may appear within the transcript at the 30 minute mark.

In various embodiments, student notes that appear within a transcript may appear in a different font, font color, background color, font weighting, grayscale, or in some other distinguishing format from the rest of the transcript. In some embodiments, only a portion of a given note may appear within a transcript (e.g., only a heading or only the first few words of the note). A student viewing the transcript may click on the note, click on a drop-down arrow associated with the note, or otherwise provide an input in order to cause the full note to appear.

In various embodiments, a student (or other use) may select one or more filters when viewing a transcript with notes inserted. Some filters may be used to eliminate other parts of the transcript and show only the notes. Other filters may eliminate the notes, but not the transcript, in various embodiments.

In various embodiments, notes occur within the textual flow of a transcript. In various embodiments, notes may be displayed to the side of a transcript. For example, a transcript is displayed as one column of text, while notes appear displayed in an adjacent column of text. As will be appreciated, various embodiments contemplate other variations through which notes may be displayed in conjunction with a transcript.

In various embodiments, notes may be displayed in conjunction with a video. As a student plays a video, and the video reaches the time when the note was taken, the note may appear on screen (e.g., under the video; e.g., overlaid on the video; e.g., to the side of the video). In various embodiments, all of a student's notes for a given lecture may be displayed on screen as the student plays back the lecture. When a video or audio gets to the appropriate point in the lecture, then the corresponding note may be highlighted or otherwise marked.

In various embodiments, notes may be displayed in conjunction with audio. As the student reaches an appropriate point in the audio, the corresponding note may be displayed.

Various embodiments have described how notes may be taken by students during a live lecture. In various embodiments, a student may take notes while playing back a recording of a lecture. The notes may be given timestamps corresponding to the time into the recording of the lecture when the notes were taken. E.g., a note taken one hour into the lecture may be given a timestamp of one hour. In some embodiments, a timestamp may represent the time at which the corresponding portion of the lecture was recorded. For example, if a student takes a note during a portion of a recorded lecture, where the recording happened at 4:30 pm, then the timestamp given to the note may be 4:30 pm, even if the time at which the note was actually taken was some other time.

### Combining Student Notes

In various embodiments, the notes of two or more students may be combined. The notes may appear within a single document, within a single interface, as a single continuous line of text, or in some other unified or coherent format. In various embodiments, the notes may be ordered by time at which the notes were taken. In various embodiments, the notes may be ordered by timestamp.

When student notes are combined, students may benefit from the combined efforts of their peers. A first student may fill in the gaps of a second student, and so on. When student notes are combined, notes originating from a first student may be distinguished from notes originating from a second student. For example, the notes of each student may be in a different font color, or may be highlighted in a different color.

In various embodiments, there may be a large number of students in a class. Accordingly, combining the notes of all students may be unwieldy, may lead to duplication of information, etc. In some embodiments, notes of students within a particular group may be combined. For example, a group may correspond to a study group, a group of students who learn from a particular Teach Assistant, a group of students who take class during a particular schedule (e.g., evening schedule; e.g., day schedule), a group of students formed by the student themselves, an algorithmically generated group of students (e.g., a group of students with last names ending in A-F), a randomly generated group of students, and/or any other group of students.

In various embodiments, the notes of multiple students may appear in a transcript.

### WebRTC

In various embodiments, Web Real Time Communications (WebRTC) may be used to allow students to communicate with each other, to allow students and professors to communicate, and/or to allow any two or more parties to communicate. User interfaces may be based inside of browsers (e.g., inside the Chrome Browser). A student may view a feed from professor via WebRTC. In some embodiments, a student may be selected by a professor and/or may otherwise be initiated into a two-way conversation with the professor. The student device may capture a feed of the student (e.g., video; e.g., audio; e.g.; video and audio) and may transmit the feed to the professor via WebRTC. WebRTC may also be used to allow third parties (e.g., students not directly involved in a two-way conversation) to view streams of actual conversation participants.

Various embodiments contemplate other technologies and/or protocols that may be used for communication between and/or among students, professors and/or other parties.

### Tagging

In various embodiments, a student may enter a comment, question, discussion, or other item to be associated with a lecture, class, or other presentation. For example, the student can enter a discussion comment within the text flow of a transcript. Other students, users, professors, etc., may, in turn, respond to the discussion and may type in their own comments, questions, discussions, etc.

In various embodiments, when a student enters an item (e.g., discussion), then the student may also have the ability to enter a tag, meta-tag, descriptor, or the like. The student may enter the tag in a separate text box or other area (e.g., in the student user interface). The tag may then be visible to other users. The tag may serve the purpose of providing a subject, index, summary, or other form of information about the main comment. Other users may have the opportunity to view the tag and to thereby determine whether or not they would like to review the rest of the item (e.g., discussion).

In various embodiments, tags may be searchable. For example, a user may type in a search term, and the server may then search through tags associated with items (e.g., discussions) to determine if there are any matching items. The user may then determine if he would like to investigate any of the matching items further.

In various embodiments, tags may enable generation of metrics, summary statistics, and the like. For example, one metric may describe the number of comments with the tag of “planet”. Another metric might describe the number of comments with the tag of “hydrogen bond”. Such metrics, statistics, etc., may allow a professor, user, administrator, student, etc., to determine various things, such as which topics are of greatest interest to students, which topics are being most discussed by students, which topics are giving students the most trouble, which concepts are being missed by students, etc.

In various embodiments, it may be advantageous for students to use a common set of tags. For example, rather than two students using two tags which are synonyms (but different words) it may be advantageous that they use the same words. This may allow for aggregation of similar concepts into summary statistics. In various embodiments, a user device (or the server, or some other device) may suggest tags to a student. The server may analyze an item that the student has typed (or is typing) and look for common words between the student's item and one or more other items. If common words are found, then the user device (or the server, etc.) may suggest a tag to the student that has been used in other comments, discussions etc. A suggestion may be made if there are more than a predetermined number of words in common, if there is higher than a predetermined percentage of words in common, or if any other criteria is met. A suggestion to use a similar tag may be used, in various embodiments, if a student is entering a first comment at a point in a lecture that is near to (or identical to) a point in a lecture at which a second comment was entered. In such case, a suggestion may be made to use a tag from the second comment also with the first comment. In various embodiments, if a first comment is a reply to a second comment, then a tag used in the second comment may be suggested in the first. In various embodiments, if a first comment is in the same discussion thread as a second comment, then a tag from the second comment may be suggested for the first. In various embodiments, if a second comment was entered by the same person entering a first comment, then a tag from the second comment may be suggested for the first comment.

In some embodiments, suggested tags may be presented to users in the form of a drop down menu. The drop down menu may include one or more tags that have been used previously (e.g., for other comments). The drop down menu may include one or more words that are used in the present comment. As will be appreciated, other means of presenting potential tags to a user are also contemplated.

A user may select tags from among possibilities that have been suggested, e.g., by clicking one tag from a drop-down menu.

In various embodiments, if a user enters a first tag, a second tag may be suggested to the user if the second tag is a synonym or has similar meaning to that of the first tag. In various embodiments, the second tag may be suggested if it has already been used in another comment. Determination of synonyms may occur via an electronic thesaurus, for example.

### Recorded Lecture as a Prerequisite

In various embodiments, a recorded class is used as a screen and/or pre-requisite for a student. For example, a student, or prospective student may be required to view all or a portion of a recorded class. In some embodiments, a student may be required to view all or a portion of a live class. Various metrics may be captured relating to the student. These may include viewing time, which lectures were viewed, which portions of the lecture were viewed, number of comments, number of comments initiated, number of times a lecture was viewed, and/or any other metrics. The student may be given quizzes or other assignments related to the lectures or to the lecture materials and/or to materials associated with the lectures (e.g., supplementary articles posted along with the lectures). Based on a student's performance, the student may be granted access to a more advanced class, to a major, to a degree program, to a department, to a research position, and/or to any other suitable position. In various embodiments, based on a student's performance, the student may be granted admission into a college or university, or not. In various embodiments, where a recorded class or lecture is used to pre-screen a student, a school may ensure that a student has the qualifications and/or desire to meet certain academic standards.

### Study Group Forming

A system according to various embodiments may create student groups or other groups of students. The groups may be created automatically. The groups may be created based on certain characteristics of the students. Characteristics may include age, demographics, geographic location, prior coursework experience (e.g., taking of prerequisites), prior academic performance, and/or any other characteristics. In some embodiments, groups may be formed based on a student's class schedule (e.g., which section the student is in, whether the student is taking the class the morning or evening, etc.) In some embodiments, groups may be formed based on student statuses as full-time or part time students. In some embodiments, groups may be formed based on whether a student is studying in a brick-and-mortar class, or whether the student is learning remotely.

In some embodiments, a group may be formed in such a way as to include both a student or students that physically attend class (e.g., on campus) and a student or students who are taking class remotely (e.g., via distance learning). It may be presumed that the on-campus students are more motivated and less likely to drop out, and that these students may encourage the remote students to stick with the class and not drop out.

Various embodiments may provide a calendar or other feature by which students may schedule study group sessions. The feature may send out invites, may provide links to a chat room or other virtual or real study room, may provide links to supplementary content, and/or may provide other help, services, etc.

In various embodiments, study group members may sharing notes. These may include notes taken during a live lecture, or other notes. The administration/instructors don't have access to these, in some embodiments.

### Measure of Student Sociability

A student's sociability may include a measure of the student's tendency to interact with other students and/or other people. The metric may be, for example, a number of discussions created per day, a number of comments created per day (or per other unit of time), a number of times the student sent a message to another student per unit of time, and/or some other measure, and/or some combination of the aforementioned and other measures. In various embodiments, class groups can be created based on student.

Sociability. In some embodiments, students may be grouped with other students of a similar level of sociability. In some embodiments, students may be grouped with students of differing degrees of sociability. This may allow, for example, a highly sociable student to encourage a less sociable student to make more comments.

A student sociability may be established from his interactions with the system, and/or from external data. In some embodiments, a student's sociability may be determined or estimated based on the student's activities on a social network, such as on Facebook™ For example, the number of comments left by the student for others, the number of comments others have left for the student, the number of friends a student has, and/or any other data may be used to generate a measure of sociability for a student.

In various embodiments, a student's sociability may be tracked over time. Negative changes observed in a student's sociability may trigger responsive action. For example, a professor, teaching assistant, administrator, parent, or other party may be alerted if a student's sociability decreases. The alerted party may then step in to talk to the student, see if anything is wrong, see if the student needs help, etc.

Student Help with Classes

In various embodiments, there may be a ways of getting students to lend their labor to help with a course. These students may be drawn from among current or prior students of the course. In various embodiments, certain course students may become tutors or TA's. These can be chosen or recruited based on their grades, their participation, or their ratings.

In various embodiments, tutors and TA's can have reviews, ratings, etc. given to them. In various embodiments, there may be an online market place for tutors and TA's. I.e., they can list their services for e.g., $15/hour. A system according to various embodiments can provide an on-line study room, collaboration room, etc., to facilitate private interaction between student and TA.

In various embodiments, there may be a qualification process by which a student becomes a tutor or TA. Some students might come from among the brick and mortar class. Others might come from the purely online class. A qualification process may include achieving a certain academic performance (e.g., grades in a prior class, e.g., grades on a quiz or test, e.g., grades in a first half of the class). A qualification process may include achieving favorable votes or ratings from other students. A qualification process may include initiating a certain number of discussions, answering a certain number of other students' questions, posting supplementary content, doing original research, etc.

In various embodiments, teaching assistants (TA's) may go through a qualification process. The process may allow them to grade papers, tutor other students, post supplementary content, or even spin off their own classes.

### Bookmarking

Various embodiments include a mobile application. The mobile application may be used by a user, for example, if the user device is a mobile device (e.g., a smartphone). In various embodiments, with a mobile application, a student or other user is listening to a lecture, and wants to insert an idea, but may be “on the go” and may not have time to type it up. So, in various embodiments, the user may just touch a button on the mobile client, which just places a bookmark at that point in the lecture. Then, later the user can get back to that point in the lecture, and listen to it, at which point the process of listening will most probably trigger the same thought in the user's mind again.

The user may then type up the note, and the system can make sure that the student types it in context. In other words, the note may appear in association with the point in time of the lecture at which the student thought about the note.

### Load Balancing

Recorded lectures may be of significant size (e.g., in terms of bytes). When a student views a lecture, the student may therefore use significant bandwidth. There is often a charge for bandwidth use. Therefore, where a significant number of classes are being viewed, and/or where a significant number of students are involved, the aggregate bandwidth costs may become high. Various embodiments contemplate improved mechanisms of storing content in order to reduce bandwidth costs, and/or in order to reduce other costs that may be associated with students viewing a lecture and/or in order to reduce other costs.

In various embodiments, one or more lectures is stored locally (e.g., on a campus server; e.g., on a campus storage device; e.g., near to a campus). In various embodiments, one or more lectures is stored remotely (e.g., at a remote data center; e.g., within cloud storage). In various embodiments, lectures that are stored locally may incur lower bandwidth costs than lectures that are stored remotely. For example, when a student downloads a lecture from a storage device that is on compass, minimal bandwidth costs may be incurred as compared to the costs when a lecture is stored remotely.

A system according to various embodiments, determines a first set of lectures that should be stored locally, and a second set of lectures that should be stored remotely, based on what combination of lectures stored locally and remotely would yield favorable cost reductions (e.g., in terms of bandwidth costs incurred by students viewing the lectures). A system according to various embodiments may allocate lectures to local and remote storage based on: a determined likelihood that each will be viewed (i.e., a lecture that has a higher relative likelihood of being viewed may be allocated to local storage); a determined number of times that each will be viewed (e.g., a lecture that is predicted to be viewed relatively more times will be allocated to local storage); a determined percentage of the lecture that will be viewed by each student (e.g., lectures for which it is predicted that students will view a large portion of the lecture may be allocated to local storage, whereas lectures for which it is predicted that students will view only small snippets may be allocated to remote storage); a determined number of students enrolled in the class for which the lecture was given (e.g., a lecture may be allocated to local storage if there are many students enrolled in the corresponding class, because presumably a large number of students will therefore wish to view the lecture); a determined number of students who live on campus; a determined number of students enrolled in a course who live on campus (e.g., a course where a high number of its students live on campus, such as a freshman course, may be stored in a storage device on campus, whereas with a course with many off-campus enrollees there may be no benefit from local storage of the lecture since the lecture will have to be downloaded through the public Inter; and/or based on any other factor.

In various embodiments, a lecture may be allocated locally or remotely based on: how recently the lecture was given (e.g., lectures that have been given recently may have a higher likelihood of being viewed); when the next test is in that class (e.g., a lecture in a class that has a test coming up might have a higher likelihood of being viewed because students will want to study for the test); and/or based on any other factor.

In various embodiments, a lecture may be allocated locally or remotely based on how many other students have already viewed the lecture. For example, if the lecture has already been viewed more than a predetermined number of times, it may be presumed that the lecture is popular or is important for students to view, and so it may be presumed that the lecture will be viewed a large number of times in the future.

The following are embodiments, not claims:

Z. A device comprising:
a memory;
a processor that is caused to execute instructions stored in the memory to:
   determine a first lecture that has been recorded;
   determine a first expected bandwidth utilization for the first lecture;
   determine whether the first expected bandwidth utilization exceeds a predetermined threshold;
   issue, based on the determination that the first expected bandwidth exceeds the predetermined threshold, first instructions for the first lecture to be stored on a first storage device;
   determine a second lecture that has been recorded;
   determine a second expected bandwidth utilization for the second lecture;
   determine whether the second expected bandwidth utilization exceeds a predetermined threshold; and
   issue, based on the determination that the second expected bandwidth does not exceed the predetermined threshold, second instructions for the second lecture to be stored on a second storage device.
      Z.1 The device of embodiment Z in which, in determining the first expected bandwidth utilization, the processor is caused to:
determine a first date at which the first lecture was given;
determine a second date that is the present date; and
determine a length of the lecture;
determine a number of students that are enrolled in a class for which the lecture was given.
   Z.1.1 The device of embodiment Z.1 in which, in determining the first expected bandwidth utilization, the processor is further caused to:
determine a time remaining by adding a predetermined number of days to the first date, and subtracting the second date from the result;
multiply the time remaining, the number of students, the length of the lecture, and a predetermined constant.

In some embodiments all lectures since the last quiz are stored locally. In some embodiments, when a quiz is coming up in a class, all the lectures from that class get stored locally.

### Cross Linking of Transcripts

In various embodiments, there may be common themes or subject matter that reoccur across many lectures. It may be useful for a student who is reviewing one lecture to quickly jump to another lecture, e.g., where the other lecture may provide more clarification on a given topic, etc.

In various embodiments, a portion of a transcript may serve as a link to another lecture. The link may act like a hyperlink, for example. A student who clicks (or touches or otherwise activates) a given portion of a transcript may be redirected to another lecture. The user may be redirected to the beginning of the lecture in some embodiments. The user may be directed to a portion in the middle of the lecture in some embodiments, e.g., to a portion that is most similar to the first lecture.

In various embodiments, links between lectures may be added automatically. The server (or other device) may run an algorithm to determine commonalities in words, topics, subject matter, etc, between two lectures. If the algorithm detects commonalities, it may automatically generate a link between the lectures.

In some embodiments, links may be generated between two portions of a lecture. For example, a link may take the user from a first part of a lecture to a second part of a lecture. In some embodiments, a link may be generated when there is some explicit reference in one lecture to another lecture. For example, if the professor says, “As we learned in Lecture 2 . . . ”, then the algorithm may recognize that a link can be added to take the user from the current lecture to Lecture 2.

In various embodiments, students, professors, and/or other uses can automatically add links to other lectures. For example, a student can highlight a portion of a transcript, and then select a “link to” button, and then indicate another lecture, another lecture plus a time within the other lecture, etc.

Various embodiments allow links to occur from other than a transcript. For example, a link may be associated with a portion of a video. A user may click on a portion of the video and may link to another lecture.

Applicants claim:

1. A device comprising:
a memory;
a processor that is caused to execute instructions stored in the memory to:
receive an audio recording of a lecture;
determine a transcript of the lecture based on the audio recording;
determine a first location within the transcript of a predetermined first phrase;
modify the transcript based on the first phrase; and
direct the modified transcript to be presented to a first user.

2. The device of claim 1 in which, in modifying the transcript, the processor is caused to remove a portion of the transcript.

3. The device of claim 1 in which the processor is further caused to:
modify the audio recording based on the first phrase; and
direct the modified audio to be presented to the first user.

4. The device of claim 3 in which, in modifying the audio recording, the processor is caused to remove a portion of the audio recording.

5. The device of claim 1 in which the processor is further caused to:
determine a second location within the transcript of a predetermined second phrase; and
direct a media item to be associated with the second location, in which, in directing the modified transcript to be presented to the first user, the processor is caused to direct that the media item appear to the first user when the first user reaches the second location within the transcript.

6. The device of claim 1 in which, in modifying the transcript, the processor is caused to tag a portion of the transcript for presentation in bold font.

7. The device of claim 1 in which, in modifying the transcript, the processor is caused to create a blank space within the transcript at the location of the first phrase.

8. The device of claim 7, in which the processor is further caused to:
transmit a reminder to a second user to provide an input; and
receive from the second user a set of symbols,
in which, in modifying the transcript, the processor is caused to insert the set of symbols within the transcript.

9. The device of claim 1 in which the processor is further caused to determine a second location within the transcript of a predetermined second phrase, and in which, in modifying the transcript, the processor is caused to tag a portion of the transcript between the first phrase and the second phrase for presentation in bold font.

10. The device of claim 9 in which the first phrase is “the question is” and the second phrase is “so that is the question”.

11. A device comprising:
a memory;
a processor that is caused to execute instructions stored in the memory to:
receive an audio recording of a lecture;
receive a first video that shows a presenter delivering the lecture;
receive a second video of supplementary content presented by the presenter during the lecture;
determine a transcript of the lecture based on the audio recording;
determine a first location within the transcript of a predetermined first phrase;
determine a time into the lecture, in which the time is determined based on when the first phrase occurred within the lecture;
separate the audio recording into a first audio portion that occurred before the time, and a second audio portion that occurred after the time;
separate the first video into a first video portion that occurred before the time, and a second video portion that occurred after the time;
separate the second video of supplementary content into a third video portion that occurred before the time, and a fourth video portion that occurred after the time;
separate the transcript into a first transcript portion that includes speech that occurred before the time, and a second transcript portion that includes speech that occurred after the time;
associate the first audio portion, the first video portion, the third video portion, and the first transcript portion into a first segment of the lecture;
associate a first heading with the first segment;
associate the second audio portion, the second video portion, the fourth video portion, and the second transcript portion into a second segment of the lecture;
associate a second heading with the second segment;
receive a selection of the first heading from a first user;
receive a selection of the second heading from a second user;
cause only the first segment of the lecture to be presented to the first user; and
cause only the second segment of the lecture to be presented to the second user.

12. The device of claim 11 in which the first phrase is “next topic”.

13. The device of claim 11 in which the processor is further caused to determine a point within the second video in which there is a change in an image presented, in which, in determining the time into the lecture, the processor is caused to determine the time based on the point within the second video and based on when the first phrase occurred within the lecture.

14. The device of claim 11 in which the processor is further caused to:
cause the transcript to be presented to a third user;
receive a comment from the third user; and
receive an indication of a second location within the transcript with which the comment is associated, in which, in determining the time into the lecture, the processor is caused to determine the time based on the point within the second video and based on the indication of the second location.

15. The device of claim 11 in which the processor is further caused to:
cause the audio recording to be presented to a third user; and
receive an indication of a second location within the audio recording at which the third user stopped listening to the audio recording, in which, in determining the time into the lecture, the processor is caused to determine the time based on the point within the second video and based on the indication of the second location.

16. The device of claim 11 in which the processor is further caused to determine a second location within the audio at which there is a change in volume, in which, in determining the time into the lecture, the processor is caused to determine the time based on the point within the second video and based on the indication of the second location.
